(19) United States
(12) Patent Application Publication
(10) Pub. No.: US 2011/0104521 A1
(43) Pub. Date: May 5, 2011

(54) BATTERY SYSTEM AND ELECTRIC VEHICLE INCLUDING THE SAME

(75) Inventors: Keiji KISHIMOTO, Hirakata City (JP); Yoshitomo NISHIHARA, OsakaCity (JP); Kazumi OHKURA, Nara City (JP); Hiroya MURAO, Hirakata City (JP)

(73) Assignee: SANYO ELECTRIC CO., LTD., Moriguchi City (JP)

(21) Appl. No.: 12/914,383

(22) Filed: Oct. 28, 2010

(30) Foreign Application Priority Data
Oct. 30, 2009 (JP) 2009-251145
Oct. 26, 2010 (JP) 2010-239220

(51) Int. Cl. H01M 2/00

(52) U.S. Cl. 429/7

(57) ABSTRACT

In a casing, battery blocks are positioned so that a distance between a printed circuit board attached to an end surface of each of the battery blocks and an end surface opposed to the printed circuit board is greater than a distance between the end surface of the battery block, to which no printed circuit board is attached, and an end surface of the casing, which is opposed to the end surface of the battery block.

### FIELD OF THE INVENTION

The present invention relates to a battery system and an electric vehicle including the same.

### DESCRIPTION OF THE BACKGROUND ART

Battery systems including one or a plurality of chargeable and dischargeable battery modules are used as driving sources of movable objects such as electric automobiles. Such a battery module includes a plurality of batteries (battery cells) connected in series, for example. Users of the movable objects including the battery system need to know the remaining amount of the capacity (charged capacity) of the batteries composing the battery module. When the battery module is charged/discharged, each of the batteries composing the battery module is prevented from being overcharged and overdischarged. Therefore, a voltage of the battery module is to be detected.

JP 8-162171A discusses a battery pack including a plurality of battery modules. Voltage measurement units are respectively connected to the plurality of battery modules in the battery pack. Each of the voltage measurement units includes a voltage detection circuit, to detect voltages at both ends of each of the battery modules.

The voltage detection circuit in the voltage measurement unit connected to the battery pack generates heat when it operates. When a battery system including the battery pack and, the voltage measurement unit is configured, therefore, the temperature of the battery system rises. Therefore, an output of the battery system is limited. The battery system deteriorates, and the life thereof decreases. As a result, the performance and the reliability of the battery system decrease. On the other hand, when a great space is provided between the battery pack and the voltage measurement unit, to dissipate heat, space saving is prevented.

### BRIEF SUMMARY OF THE INVENTION

An object of the present invention is to provide a battery system in which space saving can be implemented and a rise in temperature is suppressed, and an electric vehicle including the same.

(1) According to an aspect of the present invention, a battery system includes one or a plurality of battery blocks each including a plurality of battery cells, a circuit board corresponding to at least one of the one or plurality of battery blocks and including a voltage detection circuit that detects a voltage between terminals of each of the battery cells in the corresponding battery block, and a casing that houses the one or plurality of battery blocks and the circuit board, in which a plurality of first opposite surfaces opposed to the one or plurality of battery blocks are formed within the casing, the one or plurality of battery blocks each have a plurality of second opposite surfaces respectively opposed to the plurality of first opposite surfaces, the circuit board is attached to the second opposite surface of the corresponding battery block, and a distance between the circuit board and the first opposite surface opposed to the circuit board is greater than a distance between the second opposite surface to which no circuit board is attached and the first opposite surface opposed to the second opposite surface.

In the battery system, within the casing, a gap is formed between the circuit board and the first opposite surface opposed to the circuit board, and a gap is formed between the second opposite surface to which no circuit board is attached and the first opposite surface opposed to the second opposite surface. An air passage for dissipating heat is ensured by the gaps.

The distance between the circuit board and the first opposite surface opposed to the circuit board is greater than the distance between the second opposite surface to which no circuit board is attached and the first opposite surface opposed to the second opposite surface. Thus, a sufficient air passage is ensured along one surface of the circuit board. Therefore, the voltage detection circuit that generates heat can be sufficiently cooled by the flow of air, so that the battery system can be inhibited from rising in temperature. The distance between the second opposite surface to which no circuit board is attached and the first opposite surface opposed to the second opposite surface is smaller than the distance between the circuit board and the first opposite surface opposed to the circuit board. Therefore, a minimum air passage required for the voltage detection circuit to dissipate heat can be efficiently ensured while inhibiting the casing from increasing in size. These results enable space saving to be implemented, and can inhibit the battery system from rising in temperature.

(2) A predetermined gap may be provided between the circuit board and the second opposite surface to which the circuit board is attached. In this case, not only the air passage along one surface of the circuit board but also an air passage along the other surface of the circuit board can be ensured. This enables the voltage detection circuit to efficiently dissipate heat.

(3) The circuit board may include an equalization circuit that equalizes the voltages between terminals of the plurality of battery cells in the corresponding battery block. In this case, the equalization circuit, together with the voltage detection circuit, can be sufficiently cooled by a common air passage. Therefore, the voltage detection circuit and the equalization circuit can be efficiently inhibited from rising in temperature.

(4) An electric vehicle includes the above-mentioned battery system, a motor driven by electric power from the battery system, and a drive wheel that rotates by a torque generated by the motor.

In the electric vehicle, the motor is driven by the electric power from the battery system. The drive wheel rotates by the torque generated by the motor so that the electric vehicle moves. In this case, in the above-mentioned battery system, space saving can be implemented, and a rise in temperature can be suppressed. Therefore, the electric vehicle can be inhibited from increasing in size while the performance and the reliability thereof can be increased.

(5) According to another aspect of the present invention, a battery system includes three or more battery blocks each including a plurality of battery cells, and the three or more battery blocks arranged adjacent to one another at a distance, and a circuit board corresponding to at least one of the battery blocks and, including a voltage detection circuit that detects a voltage between terminals of each of the battery cells in the corresponding battery block, in which the two battery blocks adjacent to each other respectively have opposite surfaces opposed to each other, the circuit board is attached to the opposite surface of the corresponding battery block, and a distance between the circuit board and the opposite surface opposed to the circuit board is greater than a distance between the opposite surfaces to which no circuit board is attached.

In the battery system, a gap is formed between the circuit board and the opposite surface opposed to the circuit board while a gap is formed between the opposite surfaces to which no circuit board is attached. An air passage for dissipating heat is ensured by the gaps.

The distance between the circuit board and the opposite surface opposed to the circuit board is greater than the distance between the opposite surfaces to which no circuit board is attached. Thus, a sufficient air passage is ensured along one surface of the circuit board. Therefore, the voltage detection circuit that generates heat can be sufficiently cooled by the flow of air, so that the battery system can be inhibited from rising in temperature. The distance between the opposite surfaces to which no circuit board is attached is smaller than the distance between the circuit board and the opposite surface opposed to the circuit board. Therefore, a minimum air passage required for the voltage detection circuit to dissipate heat can be efficiently ensured while implementing space saving of an arrangement region of the plurality of battery blocks. These results enable space saving to be implemented, and can inhibit the battery system from rising in temperature.

(6) A predetermined gap may be provided between the circuit board and the opposite surface to which the circuit board is attached. In this case, not only the air passage along one surface of the circuit board but also an air passage along the other surface of the circuit board can be ensured. This enables the voltage detection circuit to efficiently dissipate heat.

(7) The circuit board may include an equalization circuit that equalizes the voltages between terminals of the plurality of battery cells in the corresponding battery block. In this case, the equalization circuit, together with the voltage detection circuit, can be sufficiently cooled by a common air passage. Therefore, the voltage detection circuit and the equalization circuit can be efficiently inhibited from rising in temperature.

(8) An electric vehicle includes the above-mentioned battery system, a motor driven by electric power from the battery system, and a drive wheel that rotates by a torque generated by the motor.

In the electric vehicle, the motor is driven by the electric power from the battery system. The drive wheel rotates by the torque generated by the motor so that the electric vehicle moves. In this case, in the above-mentioned battery system, space saving can be implemented, and a rise in temperature can be suppressed. Therefore, the electric vehicle can be inhibited from increasing in size while the performance and the reliability thereof can be increased.

(9) According to still another aspect of the present invention, a battery system includes three or more battery blocks each including a plurality of battery cells and spaced apart from and adjacent to one another, and a plurality of circuit boards corresponding to at least two of the plurality of battery blocks and each including a voltage detection circuit that detect a voltage between terminals of each of the battery cells in the corresponding battery block, in which the two battery blocks adjacent to each other respectively have opposite surfaces opposed to each other, at least two of the plurality of circuit boards are respectively attached to the opposite surfaces of the corresponding battery blocks so as to be opposed to each other, and no circuit board is attached to the at least two other opposite surfaces opposed to each other, and a distance between the at least two circuit boards is greater than a distance between the other opposite surfaces to which no circuit board is attached.

In the battery system, a gap is formed between the at least two circuit boards opposed to each other while a gap is formed between the at least two other opposite surfaces to which no circuit board is attached. Thus, an air passage for dissipating heat is ensured by the gaps.

The distance between the at least two circuit boards is greater than the distance between the at least two other opposite surfaces to which no circuit board is attached. Thus, a sufficient air passage is ensured along one surface of the circuit board. Therefore, the voltage detection circuit that generates heat can be sufficiently cooled by the flow of air, so that the battery system can be inhibited from rising in temperature. The distance between the at least two other opposite surfaces to which no circuit board is attached is smaller than the distance between the at least two circuit boards. A minimum air passage required for the voltage detection circuit to dissipate heat can be efficiently ensured while implementing space saving of an arrangement region of the plurality of battery blocks. These results enable space saving to be implemented, and can inhibit the battery system from rising in temperature.

(10) A predetermined gap may be provided between the circuit board and the opposite surface to which the circuit board is attached. In this, case, not only the air passage along one surface of the circuit board but also an air passage along the other surface of the circuit board can be ensured. This enables the voltage detection circuit to efficiently dissipate heat.

(11) The circuit board may include an equalization circuit that equalizes the voltages between terminals of the plurality, of battery cells in the corresponding battery block. In this case, the equalization circuit, together with the voltage detection circuit, can be sufficiently cooled by a common air passage. Therefore, the voltage detection circuit and the equalization circuit can be efficiently inhibited from rising in temperature.

(12) An electric vehicle includes the above-mentioned battery system, a motor driven by electric power from the battery system, and a drive wheel that rotates by a torque generated by the motor.

In the electric vehicle, the motor is driven by the electric power from the battery system. The drive wheel rotates by the torque generated by the motor so that the electric vehicle moves. In this case, in the above-mentioned battery system, space saving can be implemented, and a rise in temperature can be suppressed. Therefore, the electric vehicle can be inhibited from increasing in size while the performance and the reliability thereof can be increased.

(13) According to yet still another aspect of the present invention, a battery system includes a plurality of battery blocks each including a plurality of battery cells, and the plurality of battery blocks arranged adjacent to one another at a distance, a circuit board corresponding to at least one of the plurality of battery blocks and including a voltage detection circuit that detect a voltage between terminals of each of the battery cells in the corresponding battery block, and a casing that houses the plurality of battery blocks and the circuit board, in which a plurality of first opposite surfaces respectively opposed to the plurality of battery blocks are formed within the casing, the plurality of battery blocks have a plurality of second opposite surfaces respectively opposed to the plurality of first opposite surfaces, the two battery blocks adjacent to each other respectively have third opposite surfaces opposed to each other, the circuit board is attached to the third opposite surface of the corresponding battery block, and a distance between the circuit board and the third opposite surface opposed to the circuit board is greater than a distance between the second opposite surface to which no circuit board is attached and the first opposite surface opposed to the second opposite surface.

In the battery system, within the casing, a gap is formed between the circuit board and the third opposite surface opposed to the circuit board while a gap is formed between the second opposite surface to which no circuit board is attached and the first opposite surface opposed to the second opposite surface. An air passage for dissipating heat is ensured by the gaps.

The distance between the circuit board and the third opposite surface opposed to the circuit board is greater than the distance between the second opposite surface to which no circuit board is attached and the first opposite surface opposed to the second opposite surface. Thus, a sufficient air passage is ensured along one surface of the circuit board. Therefore, the voltage detection circuit that generates heat can be sufficiently cooled by the flow of air, so that the battery system can be inhibited from rising in temperature. The distance between the second opposite surface to which no circuit board is attached and the first opposite surface opposed to the circuit board is smaller than the distance between the circuit board and the third opposite surface opposed to the circuit board. Therefore, a minimum air passage required for the voltage detection circuit to dissipate heat can be efficiently ensured while inhibiting the casing from increasing in size. These results enable space saving to be implemented, and can inhibit the battery system from rising in temperature.

(14) A predetermined gap may be provided between the circuit board and the third opposite surface to which the circuit board is attached. In this case, not only the air passage along one surface of the circuit board but also an air passage along the other surface of the circuit board can be ensured. This enables the voltage detection circuit to efficiently dissipate heat.

(15) The circuit board may include an equalization circuit that equalizes the voltages between terminals of the plurality of battery cells in the corresponding battery block. In this case, the equalization circuit, together with the voltage detection circuit can be sufficiently cooled by a common air passage. Therefore, the voltage detection circuit and the equalization circuit can be efficiently inhibited from rising in temperature.

(16) An electric vehicle includes the above-mentioned battery system, a motor driven by electric power from the battery system, and a drive wheel that rotates by a torque generated by the motor.

In the electric vehicle, the motor is driven by the electric power from the battery system. The drive wheel rotates by the torque generated by the motor so that the electric vehicle moves. In this case, in the above-mentioned battery system, space saving can be implemented, and a rise in temperature can be suppressed. Therefore, the electric vehicle can be inhibited from increasing in size while the performance and the reliability thereof can be increased.

(17) According to a further aspect of the present invention, a battery system includes a plurality of battery blocks each including a plurality of battery cells, and the plurality of battery blocks arranged adjacent to one another at a distance, a circuit board corresponding to at least one of the plurality of battery blocks and including a voltage detection circuit that detect a voltage between terminals of each of the battery cells in the corresponding battery block, and a casing that houses the plurality of battery blocks and the circuit board, in which a plurality of first opposite surfaces respectively opposed to the plurality of battery blocks are formed within the casing, the plurality of battery blocks have a plurality of second opposite, surfaces respectively opposed to the plurality of first opposite surfaces, the two battery blocks adjacent to each other respectively have third opposite surfaces opposed to each other, the circuit board is attached to the second opposite surface of the corresponding battery block, and a distance between the circuit board and the first opposite surface opposed to the circuit board is greater than a distance between the third opposite surfaces to which no circuit board is attached.

In the battery system, within the casing, a gap is formed between the circuit board and the first opposite surface opposed to the circuit board while a gap is formed between the third opposite surfaces to which no circuit board is attached. An air passage for dissipating heat is ensured by the gaps.

The distance between the circuit board and the first opposite surface opposed to the circuit board is greater than the distance between the third opposite surfaces to which no circuit board is attached. Thus, a sufficient air passage is ensured along one surface of the circuit board. Therefore, the voltage detection circuit that generates heat can be sufficiently cooled by the flow of air, so that the battery system can be inhibited from rising in temperature. The distance between the third opposite surfaces to which no circuit board is attached is smaller than the distance between the circuit board and the first opposite surface opposed to the circuit board. Therefore, a minimum air passage required for the voltage detection circuit to dissipate heat can be efficiently ensured while inhibiting the casing from increasing in size. These results enable space saving to be implemented, and can inhibit the battery system from rising in temperature.

(18) A predetermined gap may be provided between the circuit board and the second opposite surface to which the circuit board is attached. In this case, not only the air passage along one surface of the circuit board but also an air passage along the other surface of the circuit board can be ensured. This enables the voltage detection circuit to efficiently dissipate heat.

(19) The circuit board may include an equalization circuit that equalizes the voltage between terminals of the plurality of battery cells in the corresponding battery block. In this case, the equalization circuit, together with the voltage detection circuit, can be sufficiently cooled by a common air passage. Therefore, the voltage detection circuit and the equalization circuit can be efficiently inhibited from rising in temperature.

(20) An electric vehicle includes the above-mentioned battery system, a motor driven by electric power from the battery system, and a drive wheel that rotates by a torque generated by the motor.

In the electric vehicle, the motor is driven by the electric power from the battery system. The drive wheel rotates by the torque generated by the motor so that the electric vehicle moves. In this case, in the above-mentioned battery system, space saving can be implemented, and a rise in temperature can be suppressed. Therefore, the electric vehicle can be inhibited from increasing in size while the performance and the reliability thereof can be increased.

Other features, elements, characteristics, and advantages of the present invention will become more apparent from the following description of preferred embodiments of the present invention with reference to the attached drawings.

### BRIEF DESCRIPTION OF THE SEVERAL VIEWS OF THE DRAWINGS

FIG. 1 is a block diagram illustrating a configuration of a battery system according to a first embodiment.

FIG. 2 is a block diagram illustrating a configuration of a printed circuit board illustrated in FIG. 1.

FIG. 3 is an external perspective view of a battery module.

FIG. 4 is a plan view of the battery module.

FIG. 5 is an end view of the battery module.

FIG. 6 is a schematic view for explaining end surfaces of a battery block.

FIG. 7 (a) is an external perspective view of a bus bar for two electrodes, and FIG. 7 (b) is an external perspective view of a bus bar for one electrode.

FIG. 8 is an external perspective view illustrating a state where a plurality of bus bars and a plurality of PTC elements are attached to an FPC board.

FIG. 9 is a schematic plan view for explaining connection between bus bars and a detection circuit.

FIG. 10 is an enlarged plan view illustrating a voltage/current bus bar and an FPC board.

FIG. 11 is a schematic plan view illustrating a configuration example of a printed circuit board.

FIG. 12 is a schematic plan view illustrating a first arrangement example of a plurality of battery modules housed in the casing illustrated in FIG. 1 in the first embodiment.

FIG. 13 is a schematic plan view illustrating a second arrangement example of the plurality of battery modules housed in the casing illustrated in FIG. 1 in the first embodiment.

FIG. 14 illustrates a configuration example of a spacer illustrated in FIG. 13.

FIG. 15 illustrates another configuration example of the spacer illustrated in FIG. 13.

FIG. 16 is a schematic plan view illustrating a third arrangement example of the plurality of battery modules housed in the casing illustrated in FIG. 1 in the first embodiment.

FIG. 17 illustrates a configuration example of a spacer illustrated in FIG. 16.

FIG. 18 is a schematic plan view illustrating a fourth arrangement example of the plurality of battery modules housed in the casing illustrated in FIG. 1 in the first embodiment.

FIG. 19 is a schematic plan view illustrating a fifth arrangement example of the plurality of battery modules housed in the casing illustrated in FIG. 1 in the first embodiment.

FIG. 20 is a schematic plan view illustrating a sixth arrangement example of the plurality of battery modules housed in the casing illustrated in FIG. 1 in the first embodiment.

FIG. 21 is a block diagram illustrating a configuration example of a detection circuit used in the sixth arrangement example.

FIG. 22 is a schematic plan view illustrating the sixth arrangement example in the first embodiment when the spacer illustrated in FIG. 14 is used.

FIG. 23 is a schematic plan view illustrating the sixth arrangement example in the first embodiment when the spacer illustrated in FIG. 17 is used.

FIG. 24 is a schematic plan view illustrating a seventh arrangement example of the plurality of battery modules housed in the casing illustrated in FIG. 1 in the first embodiment.

FIG. 25 is a schematic plan view illustrating the seventh arrangement example in the first embodiment when the spacer illustrated in FIG. 14 is used.

FIG. 26 is a schematic plan view illustrating the seventh arrangement example in the first embodiment when the spacer illustrated in FIG. 17 is used.

FIG. 27 is a schematic plan view illustrating an eighth arrangement example of the plurality of battery modules housed in the casing illustrated in FIG. 1 in the first embodiment.

FIG. 28 is a schematic plan view illustrating a ninth arrangement example of the plurality of battery modules housed in the casing illustrated in FIG. 1 in the first embodiment.

FIG. 29 is a schematic plan view illustrating a tenth arrangement example of the plurality of battery modules housed in the casing illustrated in FIG. 1 in the first embodiment.

FIG. 30 is a schematic plan view illustrating an eleventh arrangement example of the plurality of battery modules housed in the casing illustrated in FIG. 1 in the first embodiment.

FIG. 31 is a schematic plan view illustrating a twelfth arrangement example of the plurality of battery modules housed in the casing illustrated in FIG. 1 in the first embodiment.

FIG. 32 is a schematic plan view illustrating a thirteenth arrangement example of one battery module housed in the casing illustrated in FIG. 1 in the first embodiment.

FIG. 33 is a block diagram illustrating another configuration example of a battery system according to the first embodiment.

FIG. 34 is a schematic plan view illustrating a fourteenth arrangement example of the plurality of battery modules housed in the casing illustrated in FIG. 33 in the first embodiment.

FIG. 35 is a schematic plan view for explaining a state of connection of power supply lines and communication lines in the fourteenth arrangement example illustrated in FIG. 34.

FIG. 36 is an external perspective view illustrating a battery module according to a second embodiment.

FIG. 37 illustrates one side surface of the battery module illustrated in FIG. 36.

FIG. 38 illustrates the other side surface of the battery module illustrated in FIG. 36.

FIG. 39 is a schematic plan view illustrating one configuration example of a printed circuit board in the second embodiment.

FIG. 40 is a side view illustrating a state where a printed circuit board is attached to a battery block illustrated in FIG. 36.

FIG. 41 is an external perspective view of a battery module housed in a module casing.

FIG. 42 is a schematic plan view illustrating a first arrangement example of a plurality of battery modules housed in the casing in the second embodiment.

FIG. 43 is a schematic plan view for explaining the flow of air when a cooling fan and an exhaust port are provided on one sidewall in the first arrangement example in the second embodiment.

FIG. 44 is a schematic plan view illustrating a second arrangement example of the plurality of battery modules housed in the casing in the second embodiment.

FIG. 45 is a schematic plan view for explaining a state of connection of power supply lines and communication lines in the second arrangement example illustrated in FIG. 44.

FIG. 46 is a schematic plan view illustrating a third arrangement example of the plurality of battery modules housed in the casing in the second embodiment.

FIG. 47 is a schematic plan view for explaining a state of connection of power supply lines and communication lines in the third arrangement example illustrated in FIG. 46.

FIG. 48 is a block diagram illustrating a configuration of an electric automobile including a battery system.

### DETAILED DESCRIPTION OF THE INVENTION

### [1] First Embodiment

A battery system according to a first embodiment will be described with reference to the drawings. The battery system according to the present embodiment is mounted on an electric vehicle (e.g., an electric automobile) using electric power as a driving source.

(1) Configuration of Battery System

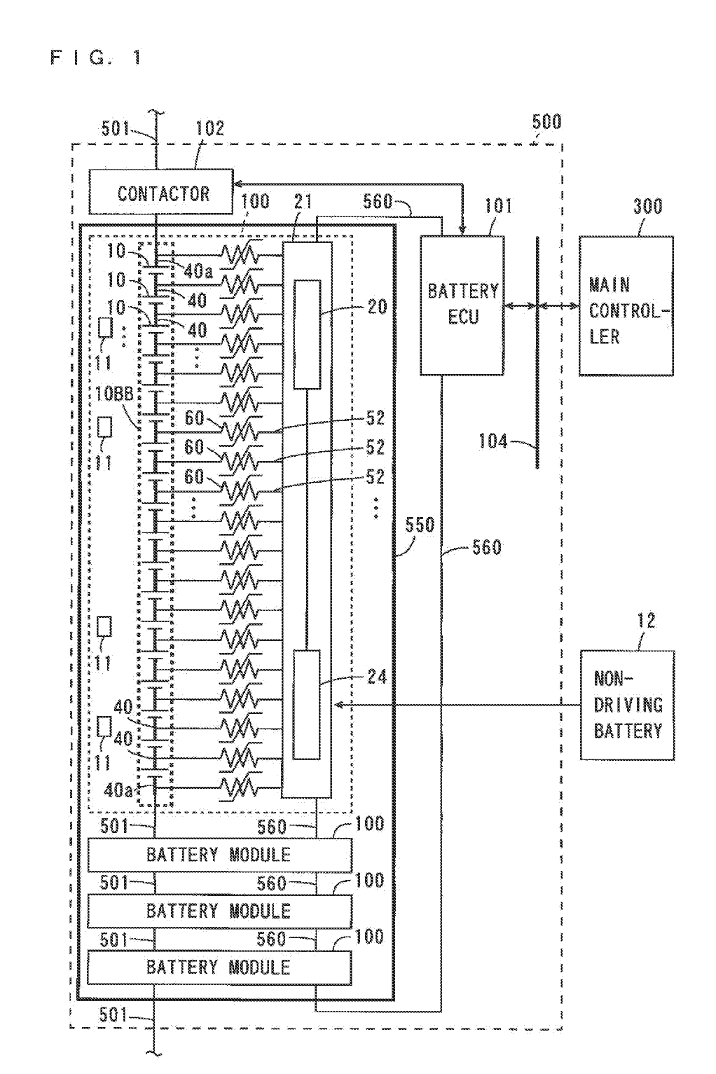

FIG. 1 is a block diagram illustrating a configuration of the battery system according to the first embodiment. As illustrated in FIG. 1, a battery system 500 includes a plurality of (four in this example) battery modules 100, a battery electronic control unit (ECU) 101, and a contactor 102, and is connected to a main controller 300 in an electric vehicle via a bus 104.

The battery system 500 includes a casing 550. The plurality of battery modules 100 are housed in the casing 550. Details will be described below.

The plurality of battery modules 100 in the battery system 500 are connected to one another via a power supply line 501. Each of the battery modules 100 includes a battery block 10BB, a plurality of (four in this example) thermistors 11, and a rigid printed circuit board (hereinafter abbreviated as a printed circuit board) 21. The battery block 10BB includes a plurality of (18 in this example) battery cells 10. In each of the battery modules 100, the plurality of battery cells 10 composing the battery block 10BB are integrally arranged adjacent to one another, and are connected in series via a plurality of bus bars 40. Each of the battery cells 10 is a secondary battery such as a lithium-ion battery or a nickel metal hydride battery.

The battery cells 10 arranged at both ends of the battery module 100 are connected to the power supply line 501 via bus bars 40a, respectively. Thus, all the battery cells 10 in the plurality of battery modules 100 are connected in series in the battery system 500. The power supply line 501 pulled out from the battery system 500 is connected to a load such as a motor of the electric vehicle. Details of the battery modules 100 will be described below.

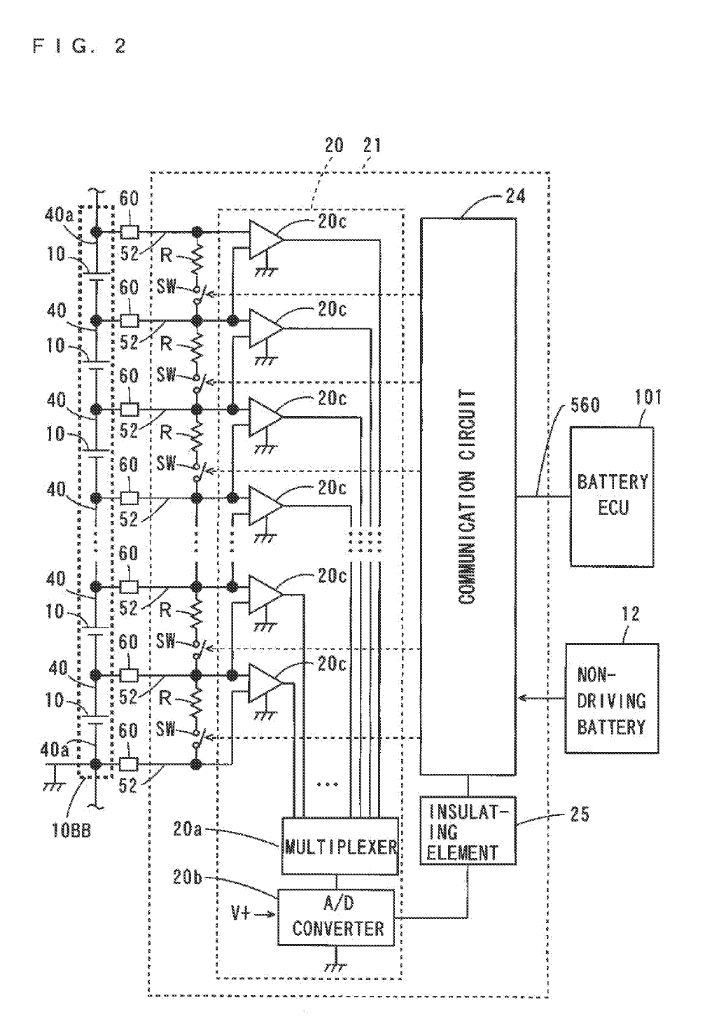

FIG. 2 is a block diagram illustrating a configuration of the printed circuit board 21 illustrated in FIG. 1. The printed circuit board 21 includes a detection circuit 20, a communication circuit 24, an insulating element 25, a plurality of resistors R, and a plurality of switching elements SW. The detection circuit 20 includes a multiplexer 20a, an analog-to-digital (A/D) converter 20b, and a plurality of differential amplifiers 20c. A configuration of the printed circuit board 21 will be described with reference to FIGS. 1 and 2.

The detection circuit 20 is composed of an application specific integrated circuit (ASIC), for example, and the plurality of battery cells 10 in the battery module 100 are used as power to the detection circuit 20. Each of the differential amplifiers 20c in the detection circuit 20 has two input terminals and an output terminal. Each of the differential amplifiers 20c differentially amplifies voltages input to the two input terminals, and outputs a voltage obtained by the amplification from the output terminal.

The two input terminals of each of the differential amplifiers 20c are electrically connected to two adjacent bus bars 40 and 40a via conductor lines 52 and positive temperature coefficient (PTC) elements 60. The PTC element 60 has such resistance temperature characteristics that its resistance value rapidly increases when its temperature exceeds a certain value. If a short occurs in the detection circuit 20 and the conductor line 52, for example, therefore, a current flowing through a passage in which the short occurs causes the resistance value of the PTC element 60 to increase if the temperature of the PTC element 60 rises. Accordingly, a large current is inhibited from flowing through a short-circuited passage including the PTC element 60.

The communication circuit 24 includes a central processing unit (CPU), a memory, and an interface circuit, for example, and has a communication function as well as a calculation function. A battery 12 in the electric vehicle is connected to the communication circuit 24. The battery 12 is used as power to the communication circuit 24 and is not used as an electric power source for driving the electronic vehicle. Hereinafter the battery 12 is referred to as a non-driving battery 12. In the present embodiment, the non-driving battery 12 is a lead-acid storage battery.

As illustrated in FIG. 1, the communication circuit 24 in each of the plurality of battery modules 100 and the battery ECU 101 are connected in series via a harness 660. Thus, the communication circuit 24 in each of the battery modules 100 can communicate with the other battery module 100 and the battery ECU 101.

A series circuit of the resistor R and the switching element SW is connected between the two adjacent bus bars 40, 40a. The battery ECU 101 controls ON and OFF of the switching element SW via the communication circuit 24. In a usual state, the switching element SW is turned off.

The detection circuit 20 and the communication circuit 24 are connected so as to enable communication while being electrically insulated from each other by the insulating element 25. Each of the differential amplifiers 20c differentially amplifies voltages of the two adjacent bus bars 40, 40a. An output voltage of each of the differential amplifiers 20c corresponds to a voltage between terminals of the corresponding battery cell 10. Voltages between terminals output from a plurality of differential amplifiers 20c are fed to the multiplexer 20a. The multiplexer 20a sequentially outputs the voltages between terminals fed from the plurality of differential amplifiers 20c to the A/D converter 20b. The A/D converter 20b converts the voltages between terminals output from the multiplexer 20a into digital values, and feeds the digital values to the communication circuit 24 via the insulating element 25.

In the present embodiment, in at least one of the plurality of battery modules 100, the detection circuit 20 detects a voltage between two positions of the one bus bar 40, and the communication circuit 24 calculates currents flowing through the plurality of battery cells 10 based on the voltage detected by the detection circuit 20 and a resistance between the two positions of the bus bar 40. Details of the calculation of the currents by the detection circuit 20 and the communication circuit 24 will be described below. The communication circuit 24 is connected to a plurality of thermistors 11 illustrated in FIG. 1. Thus, the communication circuit 24 acquires a temperature of the battery module 100 based on an output signal of the thermistor 11.

The communication circuit 24 in each of the battery modules 100 feeds the voltage between terminals of each of the battery cells 10, the currents flowing through the plurality of battery cells 10, and the temperature of the battery module 100 to the other battery module 100 or the battery ECU 101. The voltage between terminals, the currents, and the temperature are hereinafter referred to as cell information.

The battery ECU 101 calculates a charged capacity of each of the battery cells 10 based on the cell information given from the communication circuit 24 in each of the battery modules 100, for example, and controls charge/discharge of the battery module based on the charged capacity. The battery ECU 101 detects abnormality of each of the battery modules 100 based on the cell information given from the communication circuit in each of the battery modules 100. The abnormality of the battery module 100 includes overdischarge, overcharge or temperature abnormality of the battery cells 10, for example.

While the battery ECU 101 calculates the charged capacity of each of the battery cells 10 and detects the overdischarge, overcharge, and temperature abnormality, for example, of the battery cell 10 in the present embodiment, the present invention is not limited to this. The communication circuit 24 in each of the battery modules 100 may calculate the charged capacity of each of the battery cells 10 and detect the overdischarge, overcharge or temperature abnormality, for example, of the battery cell 10, and give results of the calculation and the detection to the battery ECU 101.

Returning to FIG. 1, the contactor 102 is inserted in the power supply line 501 connected to the battery module 100 at one end of the battery system 500. The battery ECU 101 turns off the contactor 102 when it detects the abnormality of the battery module 100. Since no current flows through each of the battery modules 100 when the abnormality occurs, the battery module 100 is prevented from abnormally generating heat.

The battery ECU 101 is connected to the main controller 300 via the bus 104. The charged capacity of each of the battery modules 100 (the charged capacity of the battery cell 10) is given from the battery ECU 101 to the main controller 300. The main controller 300 controls power of the electric vehicle (e.g., a rotational speed of the motor) based on the charged capacity. When the charged capacity of each of the battery modules 100 decreases, the main controller 300 controls a power generating system (not illustrated) connected to the power supply line 501, to charge each of the battery modules 100.

In the present embodiment, the power generating system is a motor connected to the power supply line 501, for example. In this case, the motor converts electric power supplied from the battery system 500 into mechanical power for driving a drive wheels (not illustrated) when the electric vehicle is accelerated. The motor generates regenerated electric power when the electric vehicle is decelerated. Each of the battery modules 100 is charged with the regenerated electric power.

(2) Details of Battery Module

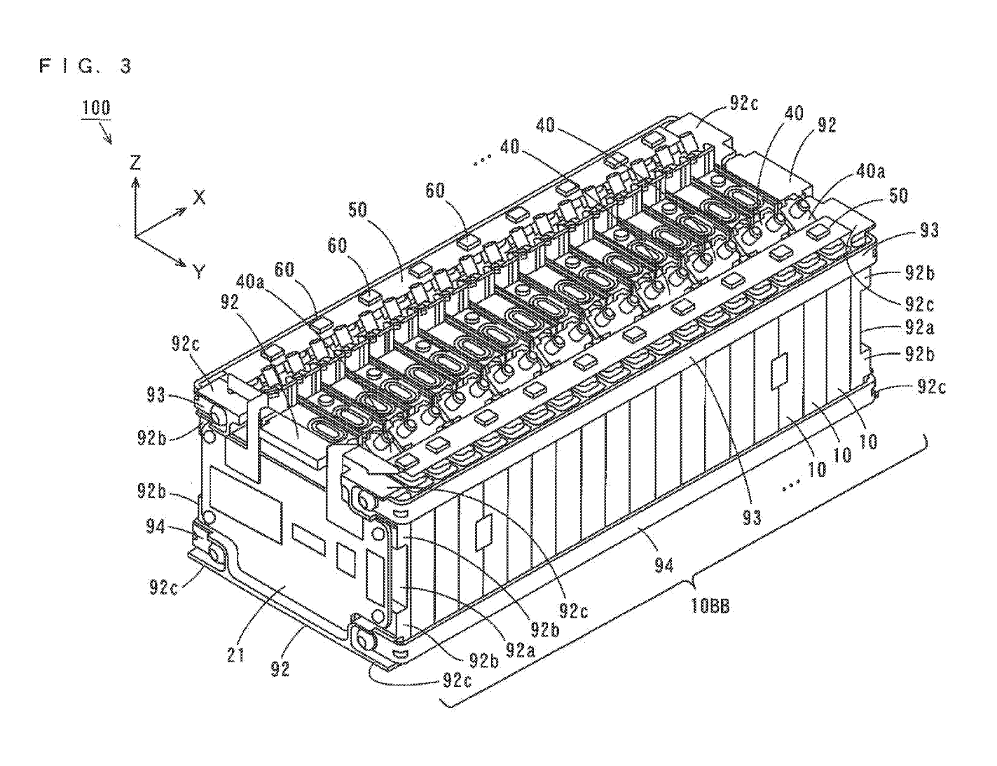

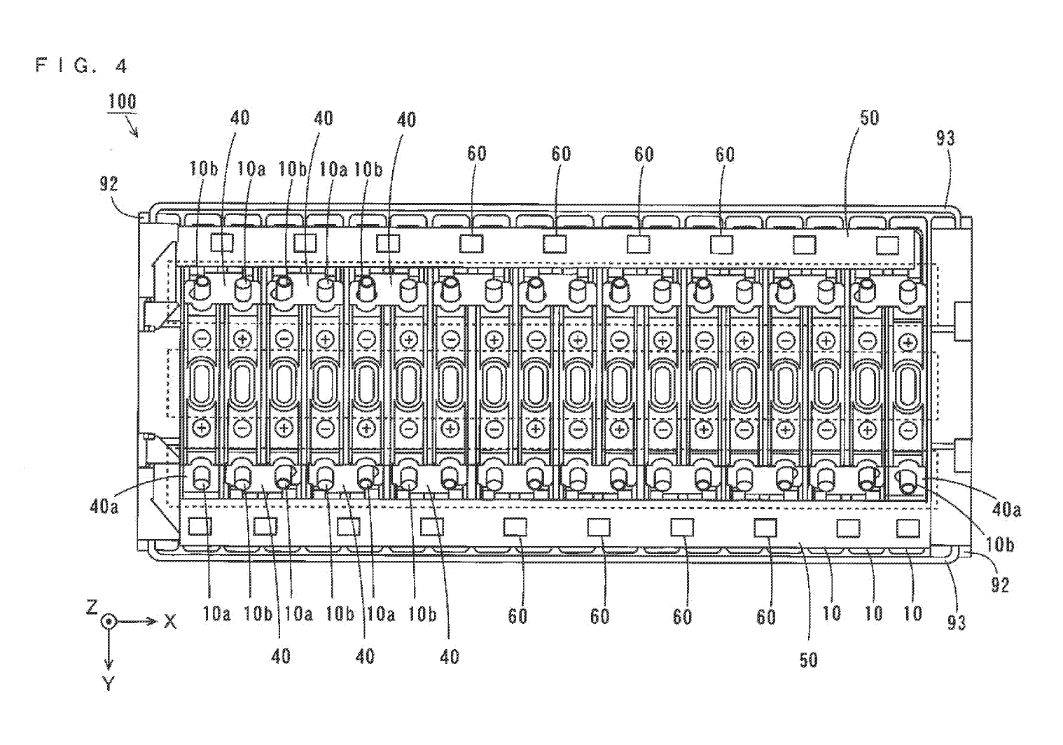

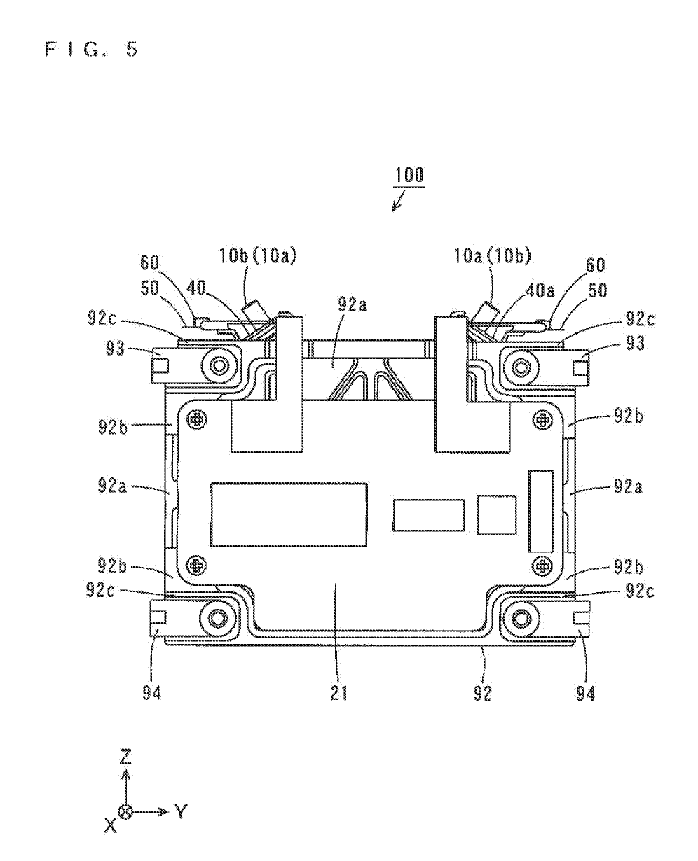

Details of the battery module 100 will be described. FIG. 3 is an external perspective view of the battery module 100, FIG. 4 is a plan view of the battery module 100, and FIG. 5 is an end view of the battery module 100. In FIGS. 3 to 5 and FIGS. 6, 8 to 10, 12, 13, 18, 18 to 20, 22 to 32, 34 to 38, 40, and 41 to 47, described below, three directions perpendicular to one another are defined as an X-direction, a Y-direction, and a Z-direction as indicated by arrows X, Y, Z. In this example, the X-direction and the Y-direction are, parallel to a horizontal plane, and the Z-direction is perpendicular to the horizontal plane.

As illustrated in FIGS. 3 to 5, the plurality of battery cells 10 each having a flat and substantially rectangular parallelepiped shape are stacked in the X-direction in the battery module 100. In the present embodiment, a separator made of resin (not illustrated) is arranged between the adjacent battery cells 10. The separator has a plate shape and has a cross section bent in a concavoconvex shape in a vertical direction, for example. The separator is arranged between the adjacent battery cells 10 so that a gap is formed between the adjacent battery cells 10. The gap formed by the separator functions as an air passage, described below.

In a state where the plurality of battery cells 10 are stacked in the X-direction, as described above, the plurality of battery cells 10 are integrally fixed by a pair of end surface frames 92, a pair of upper end frames 93, and a pair of lower end frames 94. The pair of end surface frames 92 has a substantially plate shape, and is arranged parallel to a Y-Z plane. The pair of upper end frames 93 and the pair of lower end frames 94 extend in the X-direction.

As illustrated in FIGS. 3 to 5, the pair of end surface frames 92 includes a flat portion 92a, four base plate attachment portions 92b, and four connection portions 92c. The connection portions 92c are provided at four corners of the flat portion 92a. The base plate attachment portions 92b are provided at the bottom of the upper connection portion 92c and the top of the lower connection portion 92c. Screw holes 92h are respectively formed in the four base plate attachment portions 92b.

The pair of upper end frames 93 is attached to the upper connection portion 92c in the pair of end surface frames 92 with the plurality of battery cells 10 arranged between the pair of end surface frames 92, and the pair of lower end frames 94 is mounted on the lower connection portion 92c in the pair of end surface frames 92. Thus, the plurality of battery cells 10 are integrally fixed while being stacked in the X-direction. In this manner, the plurality of battery cells 10, the pair of end surface frames 92 the pair of upper end frames 93, and the pair of lower end frames 94 constitute a battery block 10BB.

Through holes (not illustrated) are formed at four corners of the printed circuit board 21. The printed circuit board 21 is mounted on the base plate attachment, portion 92b in the one end surface frame 92 by a screw. The battery module 100 includes the battery block 10BB and the printed circuit board 21.

Each of the plurality of battery cells 10 has a plus electrode 10a on an upper surface portion at its end or the other end in the Y-direction, and has a minus electrode 10b on an upper surface portion on the opposite side. Each of the electrodes 10a and 10b is inclined to project upward (see FIG. 5). In the following description, the battery cell 10 adjacent to the end surface frame 92 to which no printed circuit board 21 is attached to the battery cell 10 adjacent to the end surface frame 92 to which the printed circuit board 21 is attached are referred to as first to eighteenth battery cells 10.

In the battery module 100, the battery cells 10 are arranged so that a positional relationship between the plus electrode 10a and the minus electrode 10b in the Y-direction of each of the battery cells 10 is opposite to that of the adjacent battery cell 10, as illustrated in FIG. 4. Thus, in the two adjacent battery cells 10, the plus electrode 10a of one of the battery cells 10 is in close proximity to the minus electrode 10b of the other battery cell 10, and the minus electrode 10b of the one battery cell 10 is in close proximity to the plus electrode 10a of the other battery cell 10. In this state, the bus bar 40 is attached to the two electrodes in close proximity to each other. This causes the plurality of battery cells 10 to be connected in series.

More specifically, the common bus bar 40 is attached to the plus electrode 10a of the first battery cell 10 and the minus electrode 10b of the second battery cell 10. The common bus bar 40 is attached to the plus electrode 10a of the second battery cell 10 and the minus electrode 10b of the third battery cell 10. Similarly, the common bus bar 40 is attached to, the plus electrode 10a of each of the odd numbered battery cells 10 and the minus electrode 10b of the even numbered battery cell 10 adjacent thereto. The common bus bar 40 is attached to the plus electrode 10a of each of the even numbered battery cells 10 and the minus electrode 10b of the odd numbered battery cell 10 adjacent thereto. The bus bar 40a for connecting the power supply line 501 (see FIG. 1) from the exterior is attached to each of the minus electrode 10b of the first battery cell 10 and the plus electrode 10a of the eighteenth battery cell 10.

A long flexible printed circuit board (hereinafter abbreviated as an FPC board) 50 extending in the X-direction is connected in common to the plurality of bus bars 40 at one end of the plurality of battery cells 10 in the Y-direction. Similarly, a long FPC board 50 extending in the X-direction is connected in common to the plurality of bus bars 40, 40a at the other end of the plurality of battery cells 10 in the Y-direction.

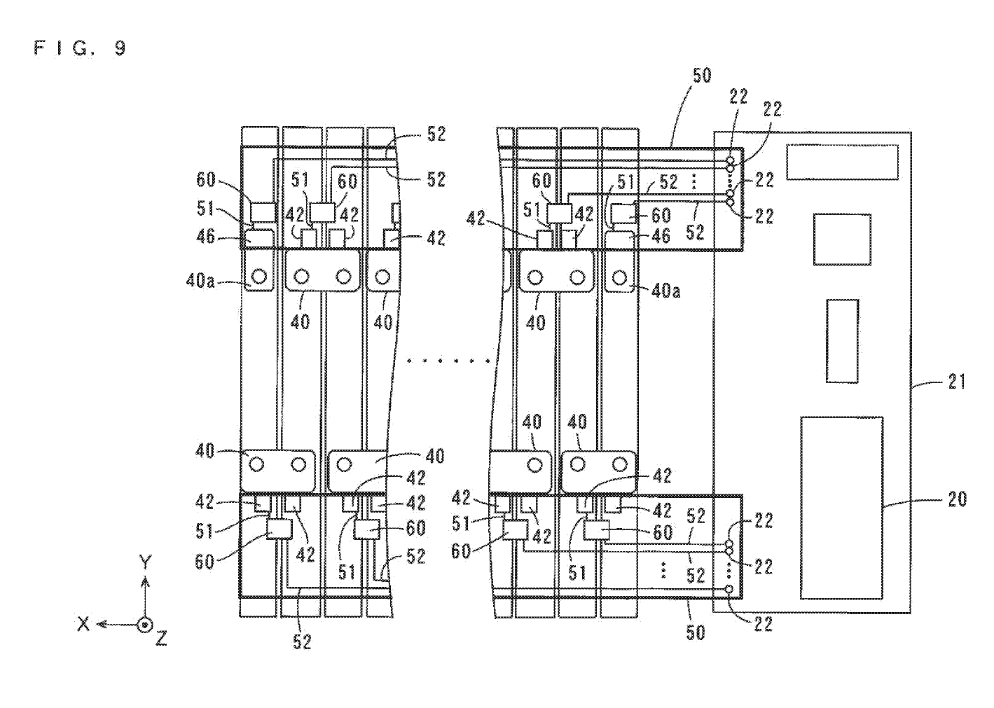

The FPC board 50 having bending characteristics and flexibility mainly includes a plurality of conductor lines 51, 52 (see FIG. 9, described below) formed on an insulating layer. Examples of a material for the insulating layer composing the FPC board 50 include polyimide, and examples of a material for the conductor lines 51, 52 (see FIG. 9, described below) include copper. The PTC elements 60 are arranged in close proximity to the bus bars 40, 40a, respectively, on the FPC board 50.

Each of the FPC boards 50 is connected to the printed circuit board 21, bent inward at a right angle and further bent downward at an upper end portion of the end surface frame 92 (the end surface frame 92 to which the printed circuit board 21 is attached).

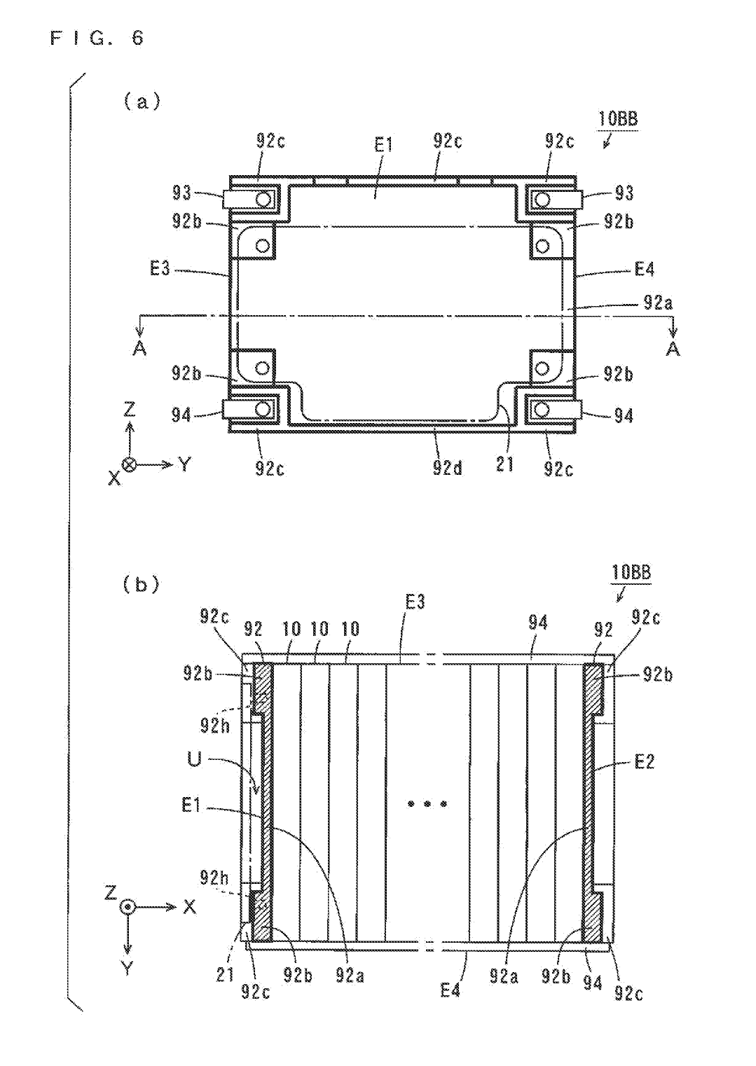

FIG. 6 is a schematic view for explaining an end surface of the battery block 10BB. FIG. 6 (a) is a schematic end view of the battery block 10BB, and FIG. 6 (b) is a schematic sectional view taken along a line A-A illustrated in FIG. 6 (a). In FIGS. 6 (a) and 6 (b), the pair of end surface frames 92 is indicated by a thick solid line, and the printed circuit board 21 attached to the one end surface frame 92 in the battery block 10BB is indicated by a one-dot and dash line.

As illustrated in FIGS. 6 (a) and 6 (b), the battery block 10BB has end surfaces E1 and E2, respectively, in the pair of end surface frames 92 as end surfaces at both ends in the X-direction (a direction in which the plurality of battery cells 10 are stacked). The battery block 10BB has end surfaces E3 and E4 as end surfaces at both ends in the Y-direction (a direction perpendicular to the direction in which the plurality of battery cells 10 are stacked).

In the present embodiment, a surface of the flat portion 92a of the one end surface frame 92, which is opposed to the printed circuit board 21, is the end surface E1 of the battery block 10BB, and an outer surface of the flat portion 92a of the other end surface frame 92 is the end surface E2 of the battery block 10BB. A surface formed by one side surface of the plurality of battery cells 10 is the end surface E3 of the battery block 10BB, and a surface formed by the other side surface of the plurality of battery cells 10 is the end surface E4 of the battery block 10BB.

The thickness in the X-direction of the connection portion 92c is greater than the thickness in the X-direction of the board attachment portion 92b, and the thickness in the X-direction of the board attachment portion 92b is greater than the thickness in the X-direction of the flat portion 92a Thus, a gap U (FIG. 6 (b)) is formed between the printed circuit board 21 and the flat portion 92a of the end surface frame 92 with the printed circuit board 21 attached to the end surface frame 92.

As described above, irregularities including the flat portion 92a, the board attachment portion 92b, and the connection portion 92c are formed on an outer surface of the pair of end surface frames 92. Respective regions having the maximum areas of a concave portion and a convex portion of the end surface frame 92 are respectively defined as the end surfaces E1 and E2 of the battery block 10BB. Therefore, surfaces of the flat portion 92a are the end surfaces E1 and E2, as described above, in the present embodiment. If the pair of end surface frames 92 does not exist, outer surfaces of the battery cell 10 positioned at both ends of the battery block 10BB are respectively the end surfaces E1 and E2.

(3) Configurations of Bus Bars and FPC Board

Details of configurations of the bus bars 40 and 40a and the FPC board 50 will be described below. The bus bar 40 for connecting the plus electrode 10a and the minus electrode 10b of the two adjacent battery cells 10 is referred to as a bus bar for two electrodes 40, and the bus bar 40a for connecting the plus electrode 10a or the minus electrode 10b of the one battery cell 10 and the power supply line 501 is referred to as a bus bar for one electrode 40a.

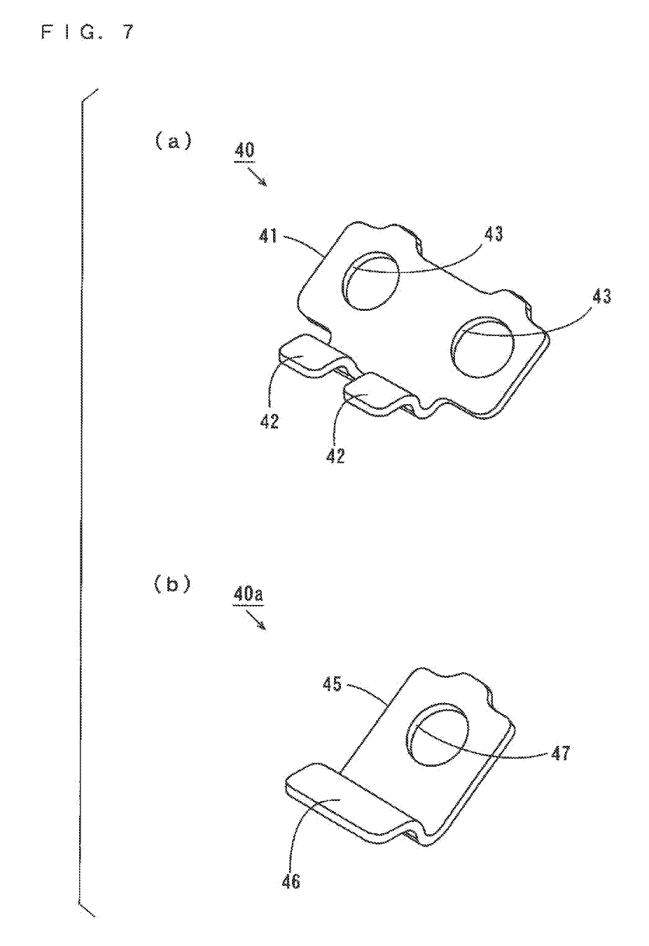

FIG. 7 (a) is an external perspective view of the bus bar for two electrodes 40, and FIG. 7 (b) is an external perspective view of the bus bar for one electrode 40a. As illustrated in FIG. 7 (a), the bus bar for two electrodes 40 includes a base portion 41 having a substantially rectangular shape and a pair of attachment portions 42 that is bent and extends toward its one surface side from one side of the base portion 41. A pair of electrode connection holes 43 is formed in the base portion 41. As illustrated in FIG. 7 (b), the bus bar for one electrode 40a includes a base portion 45 having a substantially square shape and an attachment portion 46 that is bent and extends toward its one surface side from one side of the base portion 45. An electrode connection hole 47 is formed in the base portion 45. In the present embodiment, the bus bars 40 and 40a are each composed of tough pitch copper having a nickel-plated surface, for example.

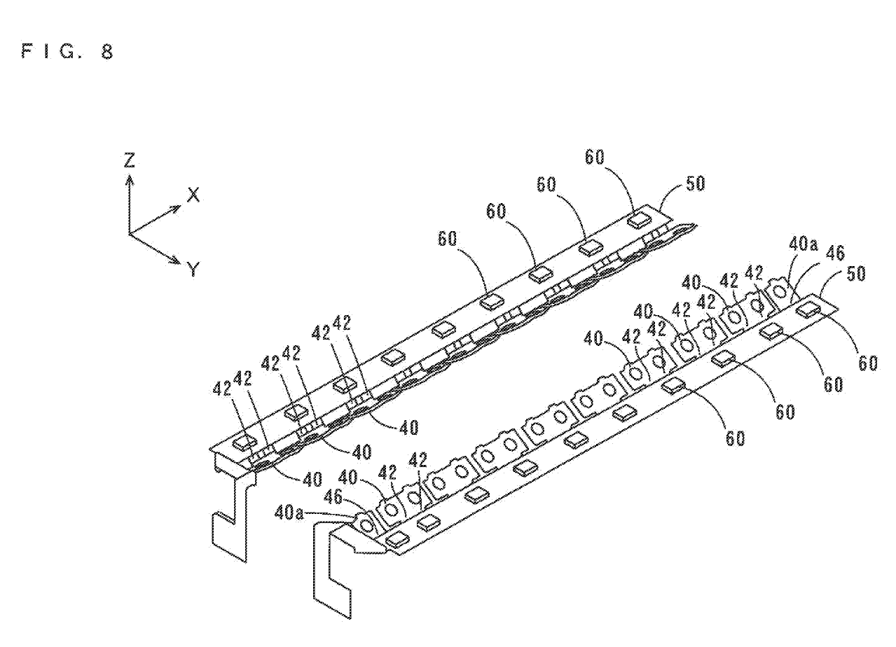

FIG. 8 is an external perspective view of the FPC boards 50 to which the plurality of bus bars 40, 40a and the plurality of PTC elements 60 are attached. As illustrated in FIG. 8, the attachment portions 42, 46 of the plurality of bus bars 40, 40a are attached to each of the two FPC boards 50 at predetermined spacing in the X-direction. The plurality of PTC elements 60 are attached to the two FPC boards 50 at the same spacing as the spacing between the plurality of bus bars 40, 40a.

The two FPC boards 50 having the plurality of bus bars 40, 40a and the plurality of PTC elements 60 attached thereto, as described above, are attached to the plurality of battery cells 10 that are integrally fixed by the end surface frames 92 (see FIG. 3), the upper end frames 93 (see FIG. 3), and the lower end frames 94 (see FIG. 3) when the battery module 100 is manufactured.

During the attachment the plus electrode 10a and the minus electrode 10b of the adjacent battery cells 10 are respectively fitted in the electrode connection holes 43 formed in each of the bus bars 40. A male thread is formed at each of the plus electrode 10a and the minus electrode 10b. With each of the bus bars 40 fitted in the plus electrode 10a and minus electrode 10b of the adjacent battery cells 10, nuts (not illustrated) are screwed into the male threads of the plus electrode 10a and the minus electrode 10b. Similarly, the plus electrode 10a of the eighteenth battery cell 10 and the minus electrode 10b of the first battery cells 10 are fitted in the electrode connection holes 47 formed in the bus bars 40a, respectively. With the bus bars 40a fitted with the plus electrode 10a and minus electrode 10b, respectively, the male threads of the plus electrode 10a and the minus electrode 10b are screwed in nuts (not illustrated). In this manner, the plurality of bus bars 40, 40a are attached to the plurality of battery cells 10 while the FPC boards 50 are held in a substantially horizontal attitude by the plurality of bus bars 40, 40a.

(4) Connection Between Bus Bars and Detection Circuit

Connection between the bus bars 40, 40a and the detection circuit 20 will be described below. FIG. 9 is a schematic plan view for explaining connection between the bus bars 40, 40a and the detection circuit 20.

As illustrated in FIG. 9, the FPC board 50 is provided with the plurality of conductor lines 51, 52 corresponding to the plurality of bus bars 40, 40a, respectively. Each of the conductor lines 51 extends parallel to the Y-direction between the attachment portion 42, 46 in the bus bar 40, 40a and the PTC element 60 arranged in the vicinity of the bus bar 40, 40a. Each of the conductor lines 52 extends parallel to the X-direction between the PTC element 80 and one end of the FPC board 50. One end of each of the conductor lines 51 is exposed to a lower surface of the FPC board 50. The one end of each of the conductor lines 51 exposed to the lower surface is electrically connected to the attachment portion 42, 46 in the bus bar 40, 40a by soldering or welding, for example. Thus, the FPC board 50 is fixed to each of the bus bars 40, 40a.

The other end of each of the conductor lines 51 and one end of each of the conductor lines 52 are exposed to an upper surface of the FPC board 50. A pair of terminals (not illustrated) of the PTC element 60 is connected to the other end of the corresponding conductor line 51 and one end of the corresponding conductor line 52 by soldering, for example. Each of the PTC elements 60 is preferably arranged in a region between both ends in the X-direction of the corresponding bus bar 40, 40a. When stress is applied to the FPC board 50, a region of the FPC board 50 between the adjacent bus bars 40, 40a is easily deflected. However, the region of the FPC board 50 between both the ends of each of the bus bars 40 and 40a is kept relatively flat because it is fixed to the bus bar. Therefore, each of the PTC elements 60 is arranged within the region of the FPC board 50 between both the ends of each of the bus bars 40 and 40a so that connection characteristics between the PTC element 60 and the corresponding conductor lines 51 and 52 are sufficiently ensured. The effect of the deflection of the FPC board 50 on each of the PTC elements 60 (e.g., a change in a resistance value of the PTC element 60) is suppressed.

The printed circuit board 21 includes a plurality of connection terminals 22 respectively corresponding to the plurality of conductor lines 52 in the FPC board 60. The plurality of connection terminals 52 and the detection circuit 20 are electrically connected to each other on the printed circuit board 21. The other ends of the conductor lines 52 in the FPC board 50 are connected to the corresponding connection terminals 22 by soldering or welding, for example. The printed circuit board 21 and the FPC board 50 may be connected by not only soldering or welding but also using connecters. In this manner, each of the bus bars 40 and 40a is electrically connected to the detection circuit 20 via the PTC element 60. Thus, the voltage between terminals of each of the battery cells 10 is detected.

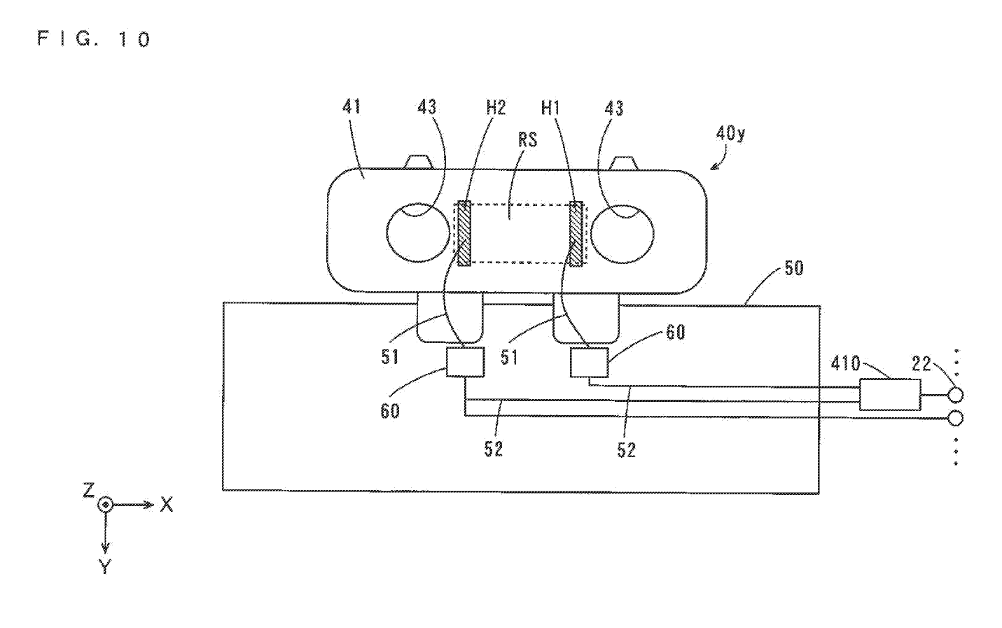

One of the plurality of bus bars 40 in at least one of the battery modules 100 is used as a shunt resistance for current detection. The bus bar 40 used as the shunt resistance is referred to as a voltage/current bus bar 40y. FIG. 10 is an enlarged plan view illustrating the voltage/current bus bar 40y and the FPC board 50. As illustrated in FIG. 10, the printed circuit board 21 further includes an amplification circuit 410.

Paired solder patterns H1 and H2 are formed parallel to each other at predetermined spacing on a base portion 41 in the voltage/current bus bar 40y. Between two electrode connection holes 43, the solder pattern H1 is arranged in the vicinity of one of the electrode connection holes 43, and the solder pattern H2 is arranged in the vicinity of the other electrode connection hole 43. A resistance formed between the solder patterns H1 and H2 in the voltage/current bus bar 40y is referred to as a shunt resistance RS for current detection.

The solder pattern H1 in the voltage/current bus bar 40y is connected to one input terminal of the amplification circuit 410 on the printed circuit board 21 via a conductor line 51, a PTC element 60, and a conductor line 52. Similarly, the solder pattern H2 in the voltage/current bus bar 40y is connected to the other input terminal of the amplification circuit 410 via a conductor line 51, a PTC element 60, and a conductor line 52. An output terminal of the amplification circuit 410 is connected to a connection terminal 22 via a conductor line. Thus, the detection circuit 20 detects a voltage between the solder patterns H1 and H2 based on an output voltage of the amplification circuit 410. A voltage detected by the detection circuit 20 is fed to the communication circuit 24.

In the present embodiment, a memory provided in the communication circuit 24 previously stores a value of the shunt resistance RS between the solder patterns H1 and H2 in the voltage/current bus bar 40y. The communication circuit 24 divides the voltage between the solder patterns H1 and H2 fed from the detection circuit 20 by the value of the shunt resistance RS stored in the memory, to calculate a value of a current flowing through the voltage/current bus bar 40y. In this manner, a value of a current flowing through the battery module 100 is detected.

(5) One Configuration Example of Printed Circuit Board

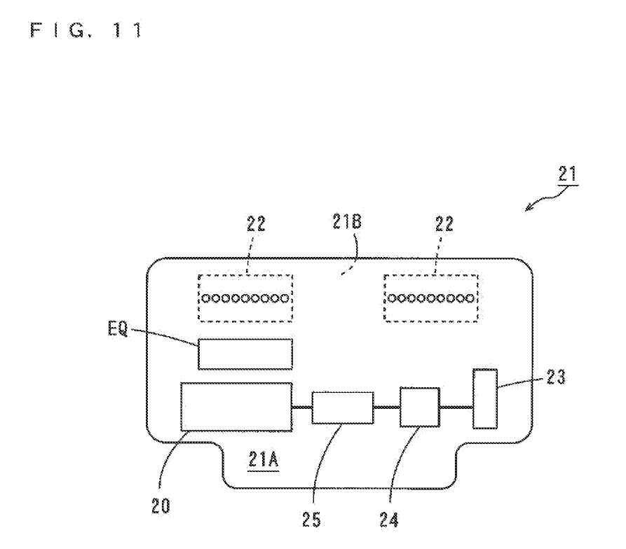

One configuration example of the printed circuit board 21 will be then described below. FIG. 11 is a schematic plan view illustrating one configuration example of the printed circuit board 21.

As illustrated in FIG. 11, the printed circuit board 21 has one surface 21A and the other surface 21B while having a substantially rectangular shape. The detection circuit 20, the communication circuit 24, and the insulating element 25 are mounted on the one surface 21A of the printed circuit board 21. A plurality of connection terminals 22 and a connector 23 are formed on the one surface 21A of the printed circuit board 21. Further, a plurality of equalization circuits EQ including the plurality of resistors R and the plurality of switching elements SW illustrated in FIG. 2 are mounted on the one surface 21A of the printed circuit board 21.

In the present embodiment, the printed circuit board 21 is provided in the battery block 10BB so that the other surface 21B is opposed to the one end surface E1 illustrated in FIG. 6. In this case, in the battery module 100, the one surface 21A of the printed circuit board 21 is positioned on the opposite side to the battery block 10BB. In the present example, the one surface 21A of the printed circuit board 21 refers tows a surface of a region excluding mounted components.

(6) First Arrangement Example in Casing in First Embodiment

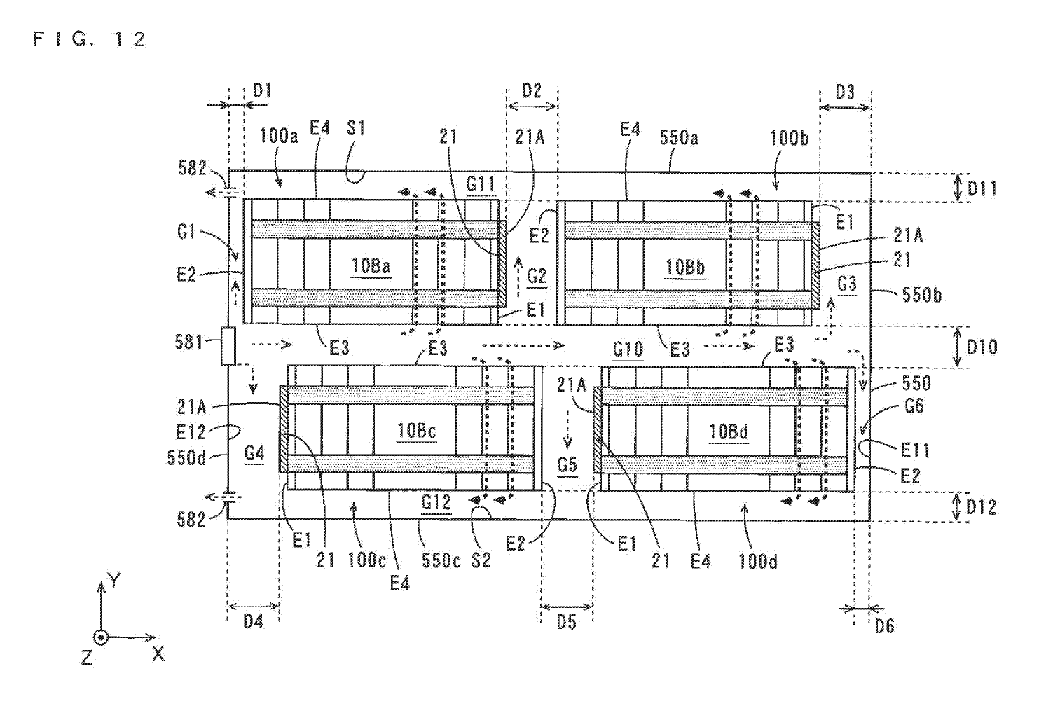

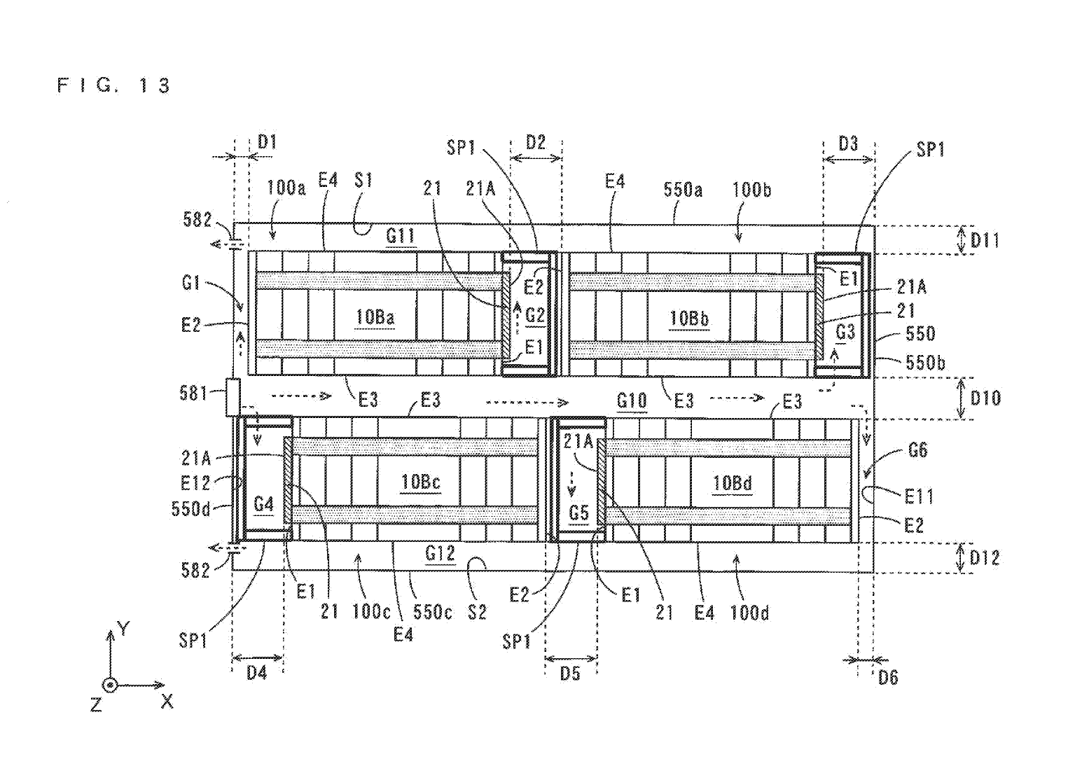

FIG. 12 is a schematic plan view illustrating a first arrangement example of the plurality of battery modules 100 housed in the casing 550 illustrated in FIG. 1 in a first embodiment. In FIG. 12 and FIGS. 13, 18, 18 to 20, 22 to 32, 34, 42 to 44, and 46, described below, illustration of the plurality of bus bars 40, 40a and the FPC board 50 in each of the battery modules 100, and the power supply line 501 illustrated in FIG. 1 for connecting the battery modules 100 is omitted, as needed.

In the following description, four battery modules 100 included in the battery system 500 are hereinafter referred to as battery modules 100a, 100b, 100c, and 100d, respectively. Battery blocks 10BB included in the battery modules 100a, 100b, 100c, and 100d are referred to as battery blocks 10Ba, 10Bb, 10Bc, and 10Bd, respectively.

As illustrated in FIG. 12, the casing 550 has sidewalls 550a, 550b, 550c, and 550d. The sidewalls 550a and 560c are parallel to each other, and the sidewalls 550b and 550d are parallel to each other and perpendicular to the sidewalls 550a and 550c.

In the present embodiment, the sidewall 550b has an end surface E11 on its inner side, and the sidewall 550d has an end surface E12 on its inner side. The end surface E11 of the sidewall 550b and the end surface E12 of the sidewall 550d are opposed to each other. The sidewall 550a has an end surface S1 on its inner side, and the sidewall 550c has an end surface S2 on its inner side. The end surface S1 of the sidewall 550a and the end surface S2 of the sidewall 550c are opposed to each other.

In the casing 550, the four battery modules 100a to 100d are arranged in two rows and two columns at spacings, described below. More specifically, the two battery modules 100a and 100b line up in the X-direction. The battery modules 100a and 100b are arranged so that end surfaces E1 of the battery blocks 10Ba and 10Bb are directed toward the sidewall 550b. A printed circuit board 21 is provided on each of the end surfaces E1 of the battery blocks 10Ba and 10Bb.

The other two battery modules 100c and 100d line up in the X-direction parallel to the battery modules 100a and 100b. The battery modules 100c and 100d are arranged so that end surfaces E1 of the battery blocks 10Bc and 10Bd are directed toward the sidewall 550d. A printed circuit board 21 is provided on each of the end surfaces E1 of the battery blocks 10Bc and 10Bd.

In this state, one surface 21A of the printed circuit board 21 provided in the battery block 108a and an end surface E2 of the battery block 10Bb, which is opposed to the one surface 21A, are spaced a distance D2 apart from each other. Thus, a gap G2 is formed between the one surface 21A of the printed circuit board 21 provided in the battery block 10Ba and the end surface E2 of the battery block 10Bb.

One surface 21A of the printed circuit board 21 provided in the battery block 10Bb and the end surface E11 of the casing 550, which is opposed to the one surface 21A, are spaced a distance D3 apart from each other. Thus, a gap G3 is formed between the one surface 21A of the printed circuit board 21 provided in the battery block 10Bb and the end surface E11 of the casing 550.

One surface 21A of the printed circuit board 21 provided in the battery block 10Bc and the end surface E12 of the casing 550, which is opposed to the one surface 21A, are spaced a distance D4 apart from each other. Thus, a gap G4 is formed between the one surface 21A of the printed circuit board 21 provided in the battery block 10Bc and the end surface E12 of the casing 550.

One surface 21A of the printed circuit board 21 provided in the battery block 10Bd and an end surface E2 of the battery block 10Bc, which is opposed to the one surface 21A, are spaced a distance D5 apart from each other. Thus, a gap G5 is formed between the one surface 21A of the printed circuit board 21 provided in the battery block 10Bd and the end surface E2 of the battery block 10Bc.

The end surface E12 of the casing 550 and an end surface E2 of the battery block 10Ba, which is opposed to the end surface E12, are spaced a distance D1 apart from each other. Thus, a gap G1 is formed between the end surface E12 of the casing 550 and the end surface E2 of the battery block 10Ba.

The end surface E11 of the casing 550 and an end surface E2 of the battery block 10Bd, which is opposed to the end surface E11, are spaced a distance D6 apart from each other. Thus, a gap G6 is formed between the end surface E11 of the casing 550 and the end surface E2 of the battery block 10Bd.

An end surface E3 of the battery block 10Ba, 10Bb and an opposed end surface E3 of the battery block 10Bc, 10Bd are spaced a distance D10 apart from each other. Thus, a gap G10 is formed between the battery block 10Ba, 10Bb and the battery block 10Bc, 10Bd.

The end surface S1 of the casing 550 and an end surface E4 of the battery block 10Ba, 10Bb, which is opposed to the end surface S1, are spaced a distance D11 apart from each other. Thus, a gap G11 is formed between the end surface S1 of the casing 550 and the battery block 10Ba, 10Bb.

The end surface S2 of the casing 550 and an end surface E4 of the battery block 10Bc, 10Bd, which is opposed to the end surface S2, are spaced a distance D12 apart from each other. Thus, a gap G12 is formed between the end surface S2 of the casing 550 and the battery block 10B, 10Bd. In this example, the battery blocks 10Ba to 10Bd are positioned so that the gaps G1 to G6 and G10 to G12 are formed in the casing 550.

A cooling fan 581 is provided at substantially the center of the sidewall 550d. Exhaust ports 582 are respectively formed in the vicinities of both ends of the sidewall 550d. The gaps G1 to G6 and G10 to G12 function as air passages (see arrows indicated by a dotted line in FIG. 12). When the cooling fan 581 operates, the flow of air is formed in the gaps G1 to G6 and G10 to G12.

In the battery system 500 in this example, the distance D3, D4 is greater than the distance D1, D6, D11, D12. More specifically, the distance D3, D4 between the one surface 21A of the printed circuit board 21 and the opposed end surface of the casing 550 is greater than the distance D1, D6, D11, D12 between the end surface of the battery block, to which no printed circuit board 21 is attached, and the opposed end surface of the casing 550. A sufficient air passage is thus ensured along the one surface 21A of the printed circuit board 21 in the gap G3, G4.

The distance D2, D5 is greater than the distance D10. More specifically, the distance D2, D5 between the one surface 21A of the printed circuit board 21 and the opposed end surface of the battery block, to which no printed circuit board 21 is attached, is greater than the distance D10 between the end surfaces of the battery blocks, to which no printed circuit board 21 is attached.

Furthermore, the distance D2, D5 is greater than the distance D1, D6, D11, D12. More specifically, the distance D2, D5 between the one surface 21A of the printed circuit board 21 and the opposed end surface of the battery block, to which no printed circuit board 21 is attached, is greater than the distance D1, D6, D11, D12 between the end surface of the battery block, to which no printed circuit board 21 is attached, and the opposed end surface of the casing 550. Thus, a sufficient air passage is ensured along the one surface 21A of the printed circuit board 21 in the gap G2. G5.

This enables the detection circuit 20 that generates heat to be sufficiently cooled by the flow of air, thereby enabling a rise in temperature of the battery system 500 to be suppressed. As a result, output limitation, deterioration, and reduction in life of the battery system 500 due to the rise in temperature can be suppressed.

Furthermore, the gap U (FIG. 6 (b)) is formed between the printed circuit board 21 and the flat portion 92a of the end surface frame 92, as described above. In an attachment portion of the printed circuit portion 21 in each of the battery blocks 10Ba to 10Bd. This enables not only an air passage along the one surface 21A of the printed circuit board 21 but also an air passage along the other surface 21B of the printed circuit board 21 to be ensured. Thus, the detection circuit 20 can more efficiently dissipate heat.

The distance D1, D6, D11, D12 between the end surface of the battery block, to which no printed circuit board 21 is attached, and the opposed end surface of the casing 550 is smaller than the distance D3, D4 between the one surface 21A of the printed circuit board 21 and the opposed end surface of the casing 550. The distance D10 between the end surfaces of the battery blocks, to which no printed circuit board 21 is attached, is smaller than the distance D2, D5 between the one surface 21A of the printed circuit board 21 and the opposed end surface of the battery block, to which no printed circuit board 21 is attached. The distance D1, D6, D11, D12 between the end surface of the battery block, to which no printed circuit board 21 is attached and the opposed end surface of the casing 550 is smaller than the distance D2, D5 between the one surface 21A of the printed circuit board 21 and the opposed end surface of the battery block, to which no printed circuit board 21 is attached. This enables a minimum air passage required for the detection circuit 20 to dissipate heat to be efficiently ensured without increasing the capacity of the casing 550. These results enable space saving to be implemented, and improve the performance and the reliability of the battery system 500.

In this example, at least one of the distances D2 to D5 between the one surface 21A of the printed circuit board 21 and the opposed end surface may be greater than at least one of the distances D1, D6, and D10 to D12 between the end surfaces to which no printed circuit board 21 is attached. In this case, a portion that satisfies this relationship exists in the casing 550, thereby making space saving as well as improvements in the performance and the reliability of the battery system 500 feasible. For example, the harness 560 and the power supply line 501 or another wiring in the battery system 500 may be arranged in the gap G11 formed in the X-direction within the casing 550. In this case, the width of the gap G11, i.e., the distance D11 need to be increased. Therefore, a gap formed between the end surfaces to which no printed circuit board 21 is attached may have to be designed to be great, as required.

Even in such a case, if at least one of the distances D2 and D5 is greater than any one of the distances D1, D6, D10, and D12 between the end surfaces to which no printed circuit board 21 is attached, other than the distance D11, a similar effect to the above-mentioned effect can be obtained. If the degree of freedom in design of the distance D1, D6 to which no printed circuit board 21 is attached is higher than the degree of freedom in design of the distance D10, D11, D12 between the end surfaces to which no printed circuit board 21 is attached for a reason not limited to arrangement of wiring, described above, at least one of the distances D2 and D5 may be greater than at least one of the distances D10. D11, and D12. Also in this case, a similar effect to the above-mentioned effect can be obtained.

The distances D2 to D5 are each preferably greater than the greatest one of the distances D1, D6, and D10 to D12. In this case, further space saving can be implemented while the performance and the reliability of the battery system 500 are further improved.

In the present embodiment, a separator (not illustrated) is arranged between the adjacent battery cells 10 (FIG. 3) so that a gap formed between the adjacent battery cells 10 functions as an air passage. When the cooling fan 581 operates, therefore, the flow of air is formed in the gap between the adjacent battery cells 10, as indicated by a thick dotted line illustrated in FIG. 12. Therefore, each of the battery cells 10 that generate heat can be cooled by the flow of air in the Y-direction so that the battery system 500 can be inhibited from rising in temperature.

(7) Second Arrangement Example in Casing in First Embodiment

FIG. 13 is a schematic plan view illustrating a second arrangement example of the plurality of battery modules 100 housed in the casing 550 illustrated in FIG. 1 in the first embodiment. The second arrangement example will be described white referring to differences from the first arrangement example.

As illustrated in FIG. 13, in this example, a spacer SP1 is fitted between an end surface E1 of a battery block 10Ba and an end surface E2 of a battery block 10Bb, and a spacer SP1 is fitted between an end surface E1 of the battery block 10Bb and an end surface E11 of the casing 550. A spacer SP1 is fitted between an end surface E12 of the casing 550 and an end surface E1 of a battery block 10Bc, and a spacer SP1 is fitted between an end surface E2 of the battery block 10Bc and an end surface E1 of a battery block 10Bd.

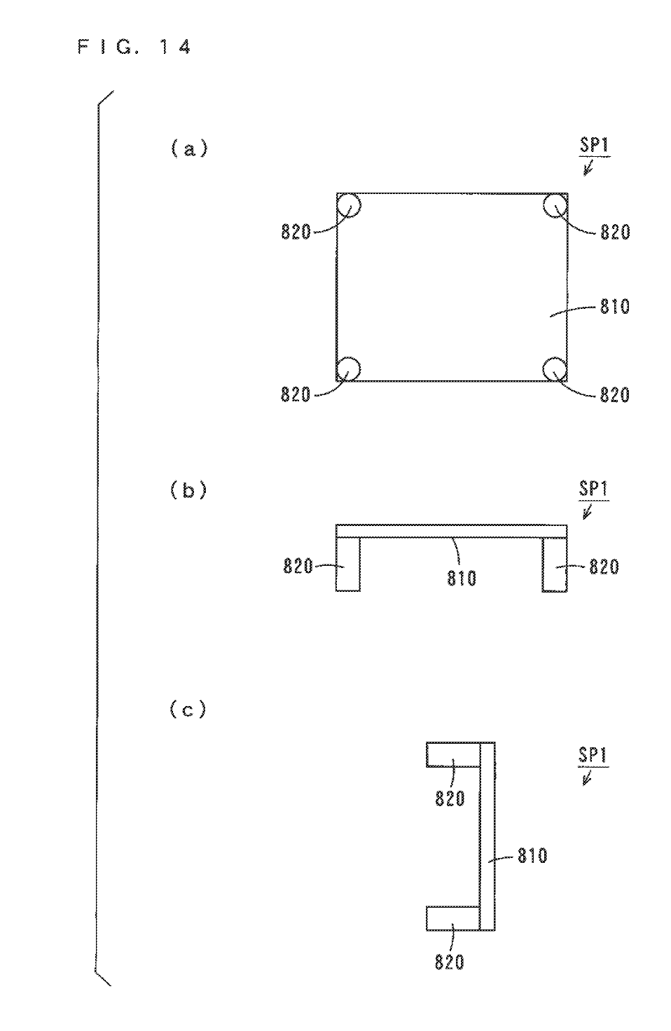

FIG. 14 illustrates one configuration example of the spacer SP1 illustrated in FIG. 13. FIG. 14 (a) is a front view of the spacer SP1, FIG. 14 (b) is a top view of the spacer SP1, and FIG. 14 (c) is a side view of the spacer SP1. As illustrated in FIGS. 14 (a) to 14 (c), the spacer SP1 includes a plate member 810 in a substantially rectangular shape and four supporting bars 820. The four supporting bars 820 are integrally provided so as to extend in a direction perpendicular to the plate member 810, respectively, at four corners of the plate member 810.

An external shape of the plate member 810 corresponds to an external shape of the above-mentioned end surface frame 92 (see FIGS. 3 and 5). Thus, in the casing 550, the plate member 810 can easily be fitted between the end surfaces of the plurality of battery blocks 10Ba to 10Bd and the casing 550, as described above.

In this example, the length of the supporting bar 820 in the spacer SP1 is determined so that the distance D3, D4 is greater than the distance D1, D6, D11, D12. The length of the supporting bar 820 in the spacer SP1 is determined so that the distance D2, D5 is greater than the distance D10. Further, the length of the supporting bar 820 in the spacer SP1 is determined so that the distance D2, D5 is greater than the distance D1, D8, D11, D12. This enables gaps G1 to G6, described above, to be formed without being positioned when the battery blocks 10Ba to 10Bd are housed in the casing 550. Therefore, the battery system 500 becomes easy to manufacture.

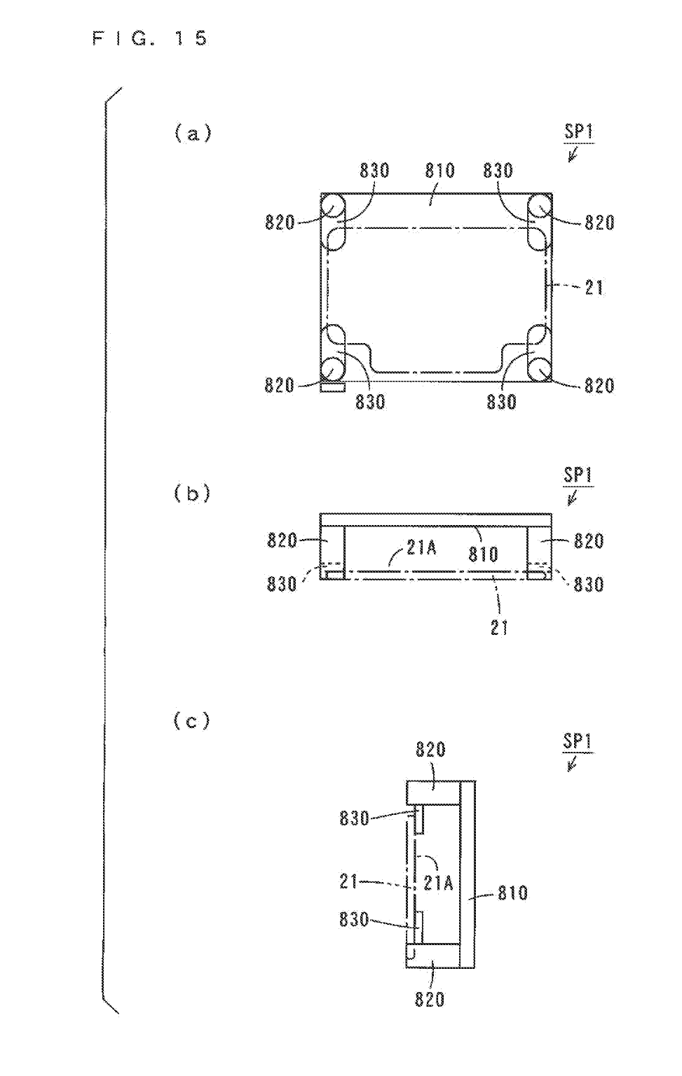

In this example, the spacer SP1 having the following configuration can also be used. FIG. 15 illustrates another configuration example of the spacer SP1 illustrated in FIG. 13. FIG. 15 (a) is a front view of the spacer SP1, FIG. 15 (b) is a top view of the spacer SP1, and FIG. 15 (c) is a side view of the spacer SP1.

As illustrated in FIGS. 15 (a) to 15 (c), board holding plates 830 are respectively provided so as to extend downward in the vicinities of front ends of the two supporting bars 820 attached to the top of the plate member 810. Board holding plates 830 are respectively provided so as to extend upward in the vicinities of front ends of the two supporting bars 820 attached to the bottom of the plate member 810. Screw holes (not illustrated) corresponding to through holes formed at four corners of the printed circuit board 21 are respectively formed at front ends of the board holding plates 830. This enables the printed circuit board 21 to be attached to the four board holding plates 830 with screws, as indicated by a one-dot and dash line illustrated in FIG. 15. In this case, the printed circuit board 21 is held at the front ends of the supporting bars 820.

The spacers SP1 to which the printed circuit boards 21 are attached are respectively fitted between the end surface E1 of the battery block 10Ba and the end surface E2 of the battery block 10Bb and between the end surface E1 of the battery block 10Bb and the end surface E11 of the casing 550. The spacers SP1 to which the printed circuit boards 21 are attached are respectively fitted between the end surface E1 of the battery block 10Bc and the end surface E12 of the casing 550 and between the end surface E1 of the battery block 10Bd and the end surface E2 of the battery block 10Bc.

Thus, the printed circuit board 21 is attached to the end surface E1 of each of the battery blocks 10Ba to 10Bd using the spacer SP1 illustrated in FIG. 15. Therefore, the printed circuit board 21 need not be attached to an end surface 92 of each of the battery blocks 10Ba to 10Bd.

(8) Third Arrangement Example in Casing in First Embodiment

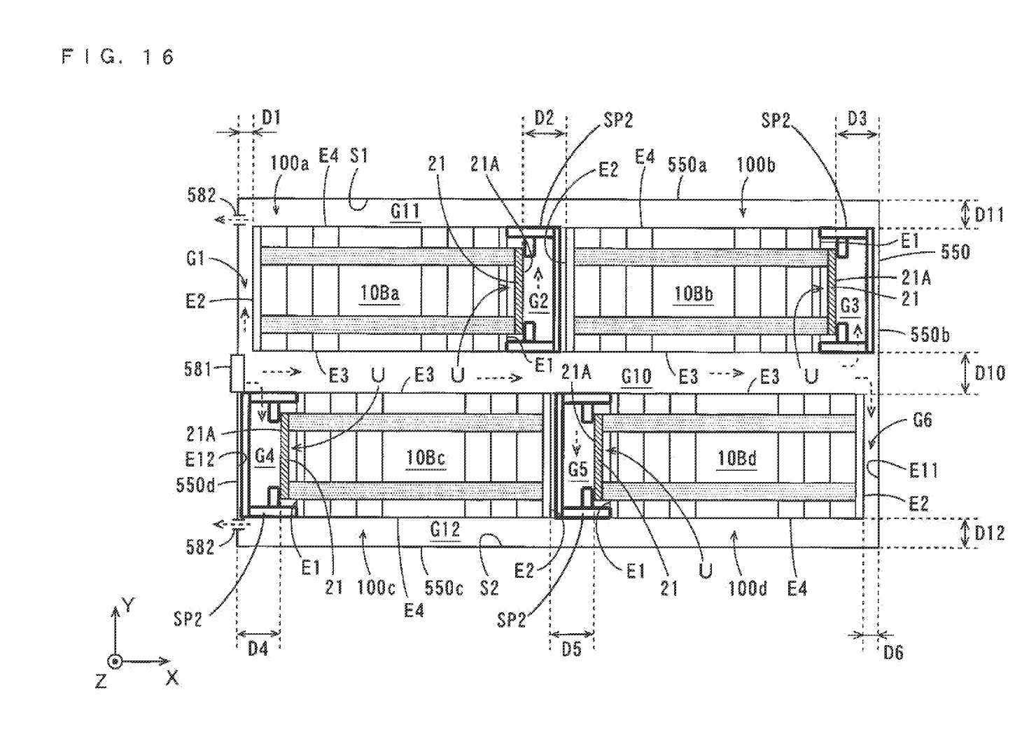

FIG. 16 is a schematic plan view illustrating a third arrangement example of the plurality of battery modules 100 housed in the casing 550 illustrated in FIG. 1 in the first embodiment. The third arrangement example will be described while referring to differences from the second arrangement example.

As illustrated in FIG. 16, in this example, a spacer SP2 is fitted between an end surface E1 of a battery block 10Ba and an end surface E2 of a battery block 10Bb, and a spacer SP2 is fitted between an end surface E1 of the battery block 10Bb and an end surface E11 of a casing 550. A spacer SP2 is fitted between an end surface E12 of the casing 550 and an end surface E1 of a battery block 10Bc, and a spacer SP2 is fitted between an end surface E2 of the battery block 10Bc and an end surface E1 of a battery block 10Bd.

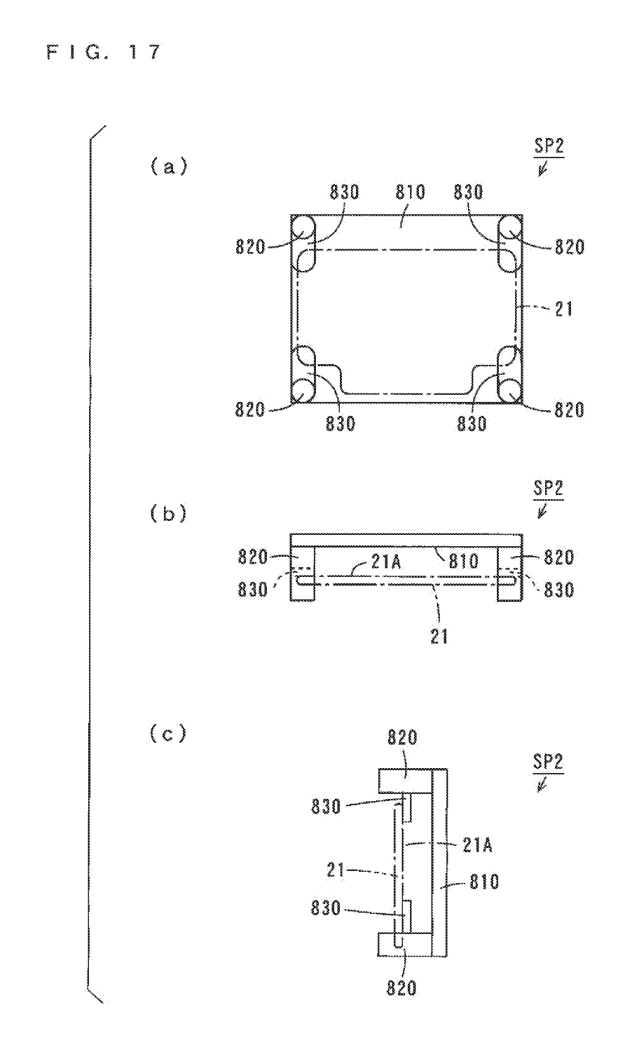

FIG. 17 illustrates one configuration example of the spacer SP2 illustrated in FIG. 16. FIG. 17 (a) is a front view of the spacer SP2, FIG. 17 (b) is a top view of the spacer SP2, and FIG. 17 (c) is a side view of the spacer SP2. As illustrated in FIGS. 17 (a) to 17 (c), a board holding plate 830 is attached to a substantially central portion of each of four supporting bars 820. When a printed circuit board 21 is attached to the board holding plates 830, as indicated by a one-dot and dash line illustrated in FIG. 17, therefore, the printed circuit board 21 is held in a substantially central portion of the supporting bar 820.

In this case, a gap U is reliably formed between the printed circuit board 21 and the end surface E1. This enables an air passage along one surface 21A of the printed circuit board 21 as well as an air passage along the other surface 21B of the printed circuit board 21 to be ensured. As a result, the detection circuit 20 can more efficiently dissipate heat.

As described above, in this example, the printed circuit board 21 is also attached to the end surface E1 of each of the battery blocks 10Ba to 10Bd using the spacer SP2. Therefore, the printed circuit board 21 need not be attached to an end surface frame 92 of each of the battery blocks 10Ba to 10Bd.

In this example, the length of the supporting bar 820 in the spacer SP2 and an attachment position of the board holding plate 830 are determined so that the distance D3, D4 is greater than the distance D1, D6, D11, D12. The length of the supporting bar 820 in the spacer SP2 and the attachment position of the board holding plate 830 are determined so that the distance D2, D5 is greater than the distance D10. Further, the length of the supporting bar 820 in the spacer SP2 and the attachment position of the board holding plate 830 are determined so that the distance D2, D5 is greater than the distance D1, D6, D11, D12. This enables the gaps G1 to G6 to be formed without being positioned when the battery blocks 10Ba to 10Bd are housed in the casing 550. Therefore, the battery system 500 becomes easy to manufacture.

(9) Fourth Arrangement Example in Casing in First Embodiment

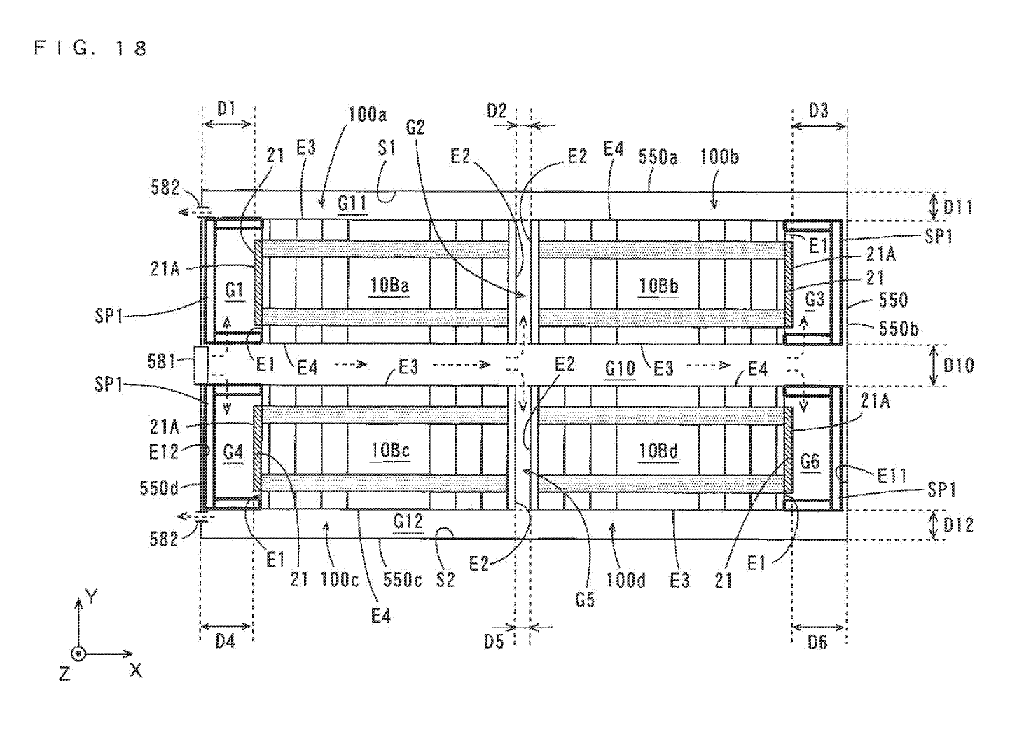

FIG. 18 is a schematic plan view illustrating a fourth arrangement example of the plurality of battery modules 100 housed in the casing 550 illustrated in FIG. 1 in the first embodiment. The fourth arrangement example will be described while referring to differences from the first arrangement example.

As illustrated in FIG. 18, in this example, an end surface E1 of a battery block 10Bb, 10Bd is directed toward a sidewall 550b of a casing 550. An end surface E1 of a battery block 10Ba, 10Bc is directed toward a sidewall 550d of the casing 550. Thus, end surfaces E2 of the battery blocks 10Ba and 10Bb provided with no printed circuit board 21 are opposed to each other, and end surfaces E2 of the battery blocks 10Bc and 10Bd provided with no printed circuit board are opposed to each other:

The spacer SP1 illustrated in FIG. 14 is fitted between an end surface E12 of the casing 550 and the end surface E1 of the battery block 10Ba, and the spacer SP1 illustrated in FIG. 14 is fitted between the end surface E1 of the battery block 10Bb and an end surface E11 of the casing 550. The spacer SP1 illustrated in FIG. 14 is fitted between the end surface E12 of the casing 550 and the end surface E1 of the battery block 10Bc, and the spacer SP1 illustrated in FIG. 14 is fitted between the end surface E1 of the battery block 10Bd and the end surface E11 of the casing 550. In this state, one surface 21A of a printed circuit board 21 provided in the battery block 10Ba and the end surface E12 of the casing 550, which is opposed to the one surface 21A, are spaced a distance D1 apart from each other. Thus, a gap G1 is formed between the one surface 21A of the printed circuit board 21 provided in the battery block 10Ba and the end surface E12 of the casing 550.

One surface 21A of a printed circuit board 21 provided in the battery block 10Bb and the end surface E11 of the casing 550, which is opposed to the one surface 21A, are spaced a distance D3 apart from each other. Thus, a gap G3 is formed between the one surface 21A of the printed circuit board 21 provided in the battery block 10Bb and the end surface E11 of the casing 550.

One surface 21A of a printed circuit board 21 provided in the battery block 10Bc and the end surface E12 of the casing 550, which is opposed to the one surface 21A, are spaced a distance D4 apart from each other. Thus, a gap G4 is formed between the one surface 21A of the printed circuit board 21 provided in the battery block 10Bc and the end surface E12 of the casing 550.

One surface 21A of a printed circuit board 21 provided in, the battery block 10Bd and the end surface E11 of the casing 550, which is opposed to the one surface 21A, are spaced a distance D6 apart from each other. Thus, a gap G6 is formed between the one surface 21A of the printed circuit board 21 provided in the battery block 10Bd and the end surface E11 of the casing 550.

The end surface E2 of the battery block 10Ba and the end surface E2 of the battery block 10Bb are spaced a distance D2 apart from each other. Thus, a gap G2 is formed between the end surface E2 of the battery block 10Ba and the end surface E2 of the battery block 10Bb. The end surface E2 of the battery block 10Bc and the end surface E2 of the battery block 10Bd are spaced a distance D5 apart from each other. Thus, a gap G5 is formed between the end surface E2 of the battery block 10Bc and the end surface E2 of the battery block 10Bd. In this example, the length of the supporting bar 820 in the spacer SP1 is determined so that the distance D1, D3, D4, D6 between the one end surface 21A of the printed circuit board 21 and the opposed end surface of the casing 550 is greater than the distance D11, D12 between the end surface of the battery block, to which no printed circuit board 21 is attached, and the opposed end surface of the casing 550.

The length of the supporting bar 820 in the spacer SP1 is determined so that the distance D1, D3, D4, D6 between the one surface 21A of the printed circuit board 21 and the opposed end surface of the casing 550 is greater than the distance D2, D5, D10 between the end surfaces of the battery blocks, to which no printed circuit board 21 is attached. Thus, a sufficient air passage is ensured along the one surface 21A of the printed circuit board 21 in the gap G1, G3, G4, G6. When the battery blocks 10Ba to 10Bd are housed in the casing 550, the gaps G1 to G6 can be formed without being positioned. Therefore, the battery system 500 becomes easy to manufacture.

Instead of using the spacer SP1 illustrated in FIG. 14, the battery blocks 10Ba to 10Bd may be positioned and housed in the casing 550 so that the distance D1, D3, D4, D6 is greater than the distance D11, D12. The battery blocks 10Ba to 10Bd may be positioned and housed in the casing 550 so that the distance D1, D3, D4, D6 is greater than the distance D2, D5, D10. Instead of using the spacer SP1 illustrated in FIG. 14, the spacers SP1 and SP2 illustrated in FIG. 15 or 17 may be used.

In this example, at least one of the distances D1, D3, D4, and D6 between the one surface 21A of the printed circuit board 21 and the opposed end surface may be greater than at least one of the distances D2, D5, and D10 to D12 between the end surfaces to which no printed circuit board 21 is attached. In this case, a portion satisfying this relationship exists in the casing 550, thereby making space saving as well as improvements in the performance and the reliability of the battery system 500 feasible.

The distances D1, D3, D4, and D6 are each preferably greater than the greatest one of the distances D2, D5, and 010 to D12. In this case, further space saving can be implemented while the performance and the reliability of the battery system 500 are further improved.

(10) Fifth Arrangement Example in Casing in First Embodiment

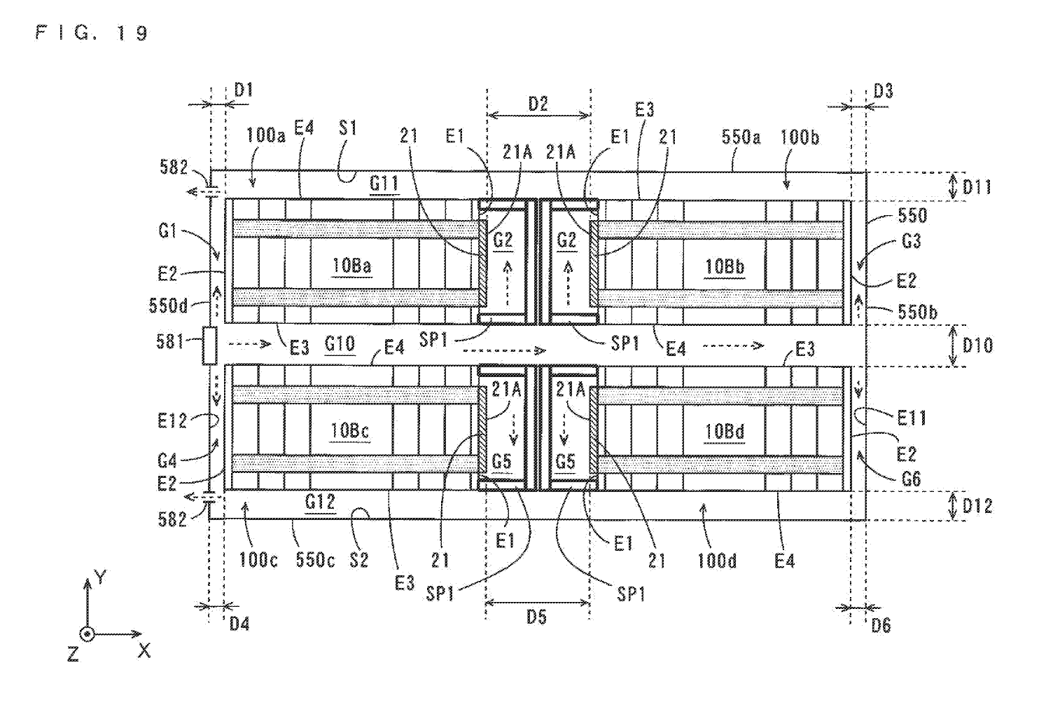

FIG. 19 is a schematic plan view illustrating a fifth arrangement example of the plurality of battery modules 100 housed in the casing 550 illustrated in FIG. 1 in the first embodiment. The fifth arrangement example will be described while referring to differences from the first arrangement example.

As illustrated in FIG. 19, in this example, an end surface E1 of a battery block 10Ba, 10Bc is directed toward a sidewall 550b of the casing 550. An end surface E1 of a battery block 10Bb, 10Bd is directed toward a sidewall 550d of the casing 550. Thus, the end surfaces E1 of the battery blocks 10Ba and 10Bb provided with printed circuit boards 21 are opposed to each other, and the end surfaces E1 of the battery blocks 10Bc and 10Bd provided with printed circuit boards 21 are opposed to each other.

The two spacers SP1 illustrated in FIG. 14 are fitted between the end surface E1 of the battery block 10Ba and the end surface E1 of the battery block 10Bb, and the two spacer SP1 illustrated in FIG. 14 are fitted between the end surface E1 of the battery block 10Bc and the end surface E1 of the battery block 10Bd. In this state, one surface 21A of the printed circuit board 21 provided in the battery block 10Ba and opposed one surface 21A of the printed circuit board 21 provided in the battery block 10Bb are spaced a distance D2 apart from each other. Thus, a gap G2 is formed between the one surface 21A of the printed circuit board 21 provided in the battery block 10Ba and the one surface 21A of the printed circuit board 21 provided in the battery block 10Bb.

One surface 21A of the printed circuit board 21 provided in the battery block 10Bc and opposed one surface 21A of the printed circuit board 21 provided in the battery block 10Bd are spaced a distance D5 apart from each other. Thus, a gap G5 is formed between the one surface 21A of the printed circuit board 21 provided in the battery block 10Bc and the one surface 21A of the printed circuit board 21 provided in the battery block 10Bd.

An end surface E12 of the casing 550 and an end surface E2 of the battery block 10Ba, which is opposed to the end surface E12, are spaced a distance D1 apart from each other. Thus, a gap G1 is formed between the end surface E12 of the casing 550 and the end surface E2 of the battery block 10Ba.

An end surface E11 of the casing 550 and an end surface E2 of the battery block 10Bb, which is opposed to the end surface E11, are spaced a distance D3 apart from each other. Thus, a gap G3 is formed between the end surface E11 of the casing 550 and the end surface E2 of the battery block 10Bb.

The end surface E12 of the casing 550 and an end surface E2 of the battery block 108c, which is opposed to the end surface E12, are spaced a distance D4 apart from each other. Thus, a gap G4 is formed between the end surface E12 of the casing 550 and the end surface E2 of the battery block 10Bc.

The end surface E11 of the casing 550 and an end surface E2 of the battery block 10Bd, which is opposed to the end surface E11, are spaced a distance D6 apart from each other. Thus, a gap G6 is formed between the end surface E11 of the casing 550 and the end surface E2 of the battery block 10Bd.

In this example, the length of a supporting bar 820 in the spacer SP1 is determined so that the distance D2, D5 between the one surfaces 21A of the two printed circuit boards 21, which are opposed to each other, is greater than the distance D10 between a pair of end surfaces of the battery blocks, to which no printed circuit board 21 is attached. Thus, a sufficient air passage is ensured along the one surface 21A of the printed circuit board 21 in the gap G2, G5. When the battery blocks 10Ba to 10Bd are housed in the casing 550, the gaps G2 to G5 can be formed without being positioned. Therefore, the battery system 500 becomes easy to manufacture.

Instead of using the spacer SP1 illustrated in FIG. 14, the battery blocks 10Ba to 10Bd may be positioned and housed in the casing 550 so that the distance D2, D5 is greater than the distance D10. Instead of using the spacer SP1 illustrated in FIG. 14, the spacers SP1 and SP2 illustrated in FIG. 15 or 17 may be used.

In this example, at least one of the distances D2 and D5 between the one surfaces 21A of the two printed circuit boards 21 may be greater than the distance D10 between the end surfaces to which no printed circuit board 21 is attached. In this case, a portion satisfying this relationship exists in the casing 550, thereby making space saving as well as improvements in the performance and the reliability of the battery system 500 feasible.

Furthermore, the distances D2 and D5 are each preferably greater than the greatest one of the distances D1, D3, D4, D6, and D10 to D12. In this case, further space saving can be implemented while the performance and the reliability of the battery system 500 are further improved.

(11) Sixth Arrangement Example in Casing in First Embodiment

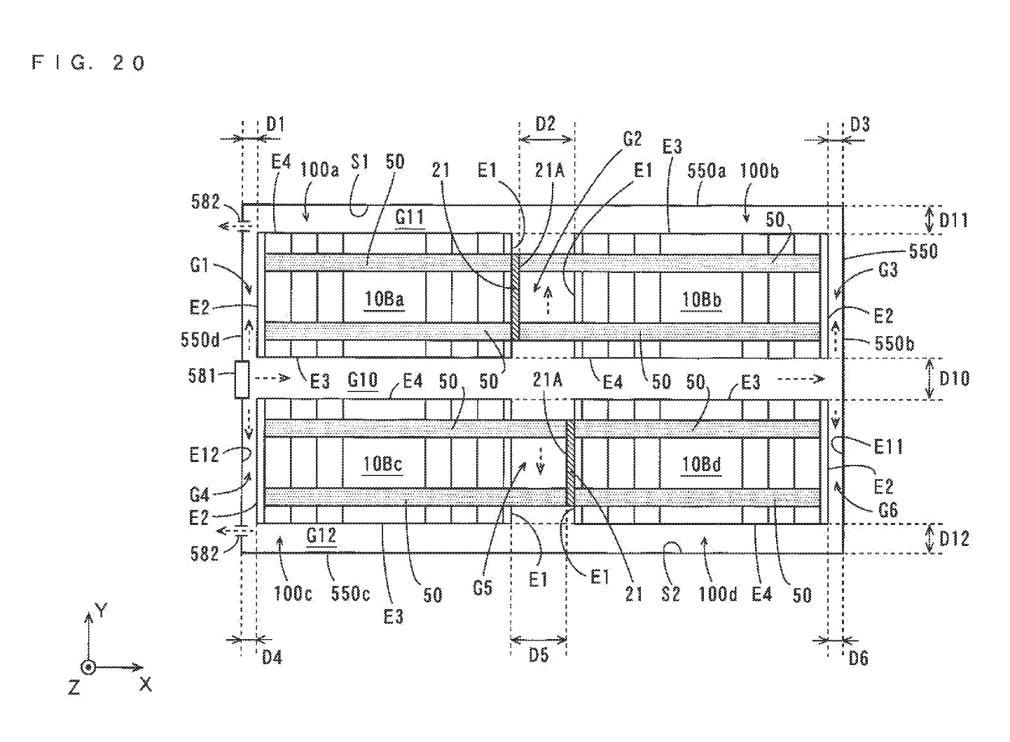

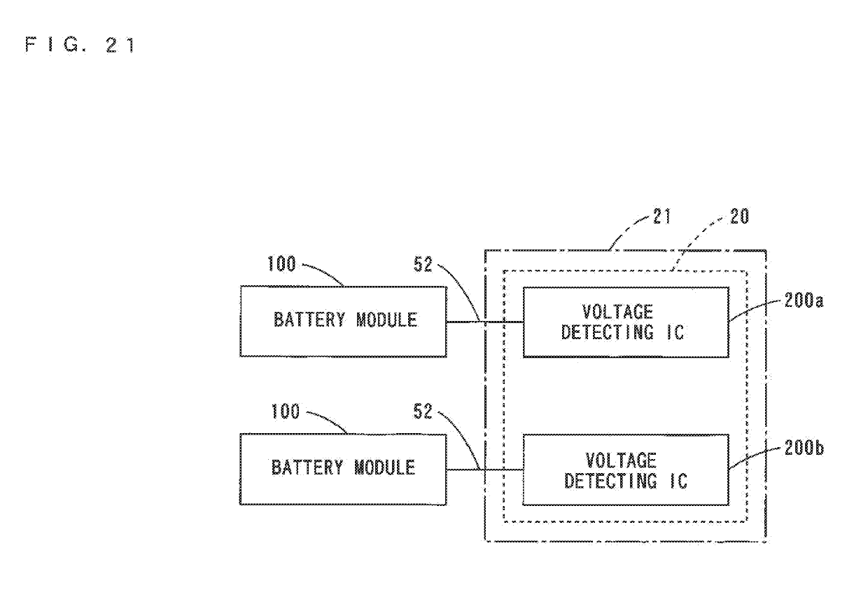

FIG. 20 is a schematic plan view illustrating a sixth arrangement example of the plurality of battery modules 100 housed in the casing 550 illustrated in FIG. 1 in the first embodiment. FIG. 21 is a block diagram illustrating a configuration example of a detection circuit 20 used in the sixth arrangement example. The sixth arrangement example will be described while referring to differences from the first arrangement example.

The detection circuit 20 illustrated in FIG. 21 will be first described. The detection circuit 20 illustrated in FIG. 21 includes first and second voltage detecting integrated circuits (ICs) 200a and 200b respectively corresponding to the two battery modules 100.

A plurality of bus bars 40 and 40a in one of the battery modules 100 (see FIG. 1) and the first voltage detecting IC 200a are connected to each, other via a plurality of conductor lines 52. A plurality of bus bars 40 and 40a in the other battery module 100 (see FIG. 1) and the second voltage detecting IC 200b are connected to each other via a plurality of conductor lines 62. Thus, a voltage between terminals of each of the battery cells 10 in the two battery modules 100 (see FIG. 1) is detected. By using the detection circuit 20 having the above-mentioned configuration, one printed circuit board 21 can be used in common between the two battery modules 100. In this example, the printed circuit board 21 is provided on the end surface E1 of either one of two battery blocks 10BB.

As illustrated in FIG. 20, in this example, an end surface E1 of a battery block 10Ba is directed toward a sidewall 550b of the casing 550, and an end surface E1 of a battery block 10Bb is directed toward a sidewall 550d of the casing 550. A printed circuit board 21 illustrated in FIG. 20 is provided on the end surface E1 of the battery block 10Ba, and no printed circuit board 21 is provided on the end surface E1 of the battery block 10Bb.

The printed circuit board 21 provided on the end surface E1 of the battery block 10Ba is used in common between the battery modules 100a and 100b. Therefore, FPC boards 50 respectively extending from the battery block 10Ba and the battery block 10Bb are connected to the printed circuit board 21. An end surface E1 of a battery block 10Bc is directed toward the sidewall 550b, and an end surface E1 of a battery block 10Bd is directed toward the sidewall 550d. A printed circuit board 21 illustrated in FIG. 20 is provided on the end surface E1 of the battery block 10Bd, and no printed circuit board 21 is provided on the end surface E1 of the battery block 10Bc.

The printed circuit board 21 provided on the end surface E1 of the battery block 10Bd is used in common between the battery modules 100c and 100d. Therefore, FPC boards 50 respectively extending from the battery block 10Bc and the battery block 10Bd are connected to the printed circuit board 21.

In this state, one surface 21A of the printed circuit board 21 provided in the battery block 10Ba and the end surface E1 of the battery block 10Bb, which is opposed to the one surface 21A, are spaced a distance D2 apart from each other. Thus, a gap G2 is formed between the one surface 21A of the printed circuit board 21 provided in the battery block 10Ba and the end surface E1 of the battery block 10Bb.

One surface 21A of the printed circuit board 21 provided in the battery block 10Bd and the end surface E1 of the battery block 10Bc, which is opposed to the one surface 21A, are spaced a distance D5 apart from each other. Thus, a gap G5 is formed between the one surface 21A of the printed circuit board 21 provided in the battery block 10Bd and the end surface E1 of the printed circuit board 10Bc.

An end surface E12 of the casing 550 and an end surface E2 of the battery block 10Ba, which is opposed to the end surface E12, are spaced a distance D1 apart from each other. Thus, a gap G1 is formed between the end surface E12 of the casing 550 and the end surface E2 of the battery block 10Ba.

An end surface E11 of the casing 550 and an end surface E2 of the battery block 10Bb, which is opposed to the end surface E11, are spaced a distance D3 apart from each other. Thus, a gap G3 is formed between the end surface E11 of the casing 550 and the end surface E2 of the battery block 10Bb.

The end surface E12 of the casing 550 and an end surface E2 of the battery block 10Bc, which is opposed to the end surface E12, are spaced a distance D4 apart from each other. Thus, a gap G4 is formed between the end surface E12 of the casing 550 and the end surface E2 of the battery block 10Bc.

The end surface E11 of the casing 550 and an end surface E2 of the battery block 10Bd, which is opposed to the end surface E11, are spaced a distance D6 apart from each other. Thus, a gap G6 is formed between the end surface E11 of the casing 550 and the end surface E2 of the battery block 10Bd.

In this example, the battery blocks 10Ba to 10Bd are positioned in the casing 550 so that the distance D2, D5 between the one surface 21A of the printed circuit board 21 and the opposed end surface of the battery block is greater than the distance D10 between the end surfaces of the battery blocks, to which no printed circuit board 21 is attached. The distance D2, D5 between the one surface 21A of the printed circuit board 21 and the opposed end surface of the battery block, to which no printed circuit board 21 is attached, is greater than the distance D1, D3, D4, D6, D11, D12 between the end surface of the battery block, to which no printed circuit board 21 is attached, and the opposed end surface of the casing 550. Thus, a sufficient air passage is ensured along the one surface 21A of the printed circuit board 21 in the gap G2, G5.

In this example, either one of the spaces SP1 and SP2 illustrated in FIGS. 14, 15 and 17 may be fitted between the end surface of the battery block provided with the printed circuit board 21 in the casing 550 and the opposed end surface of the battery block.

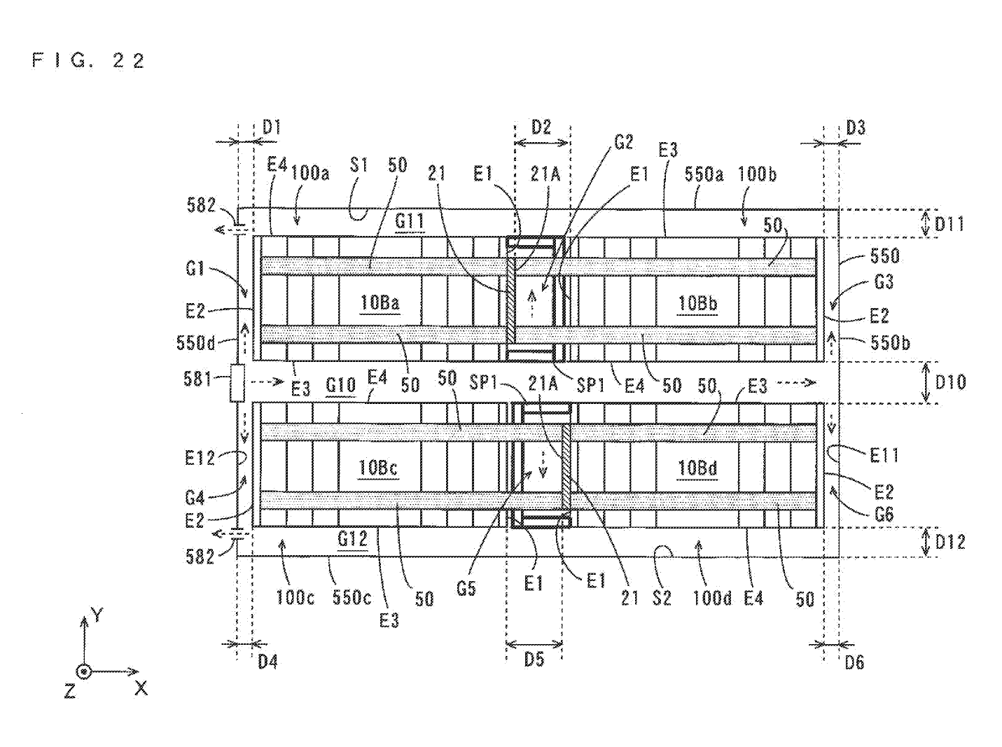

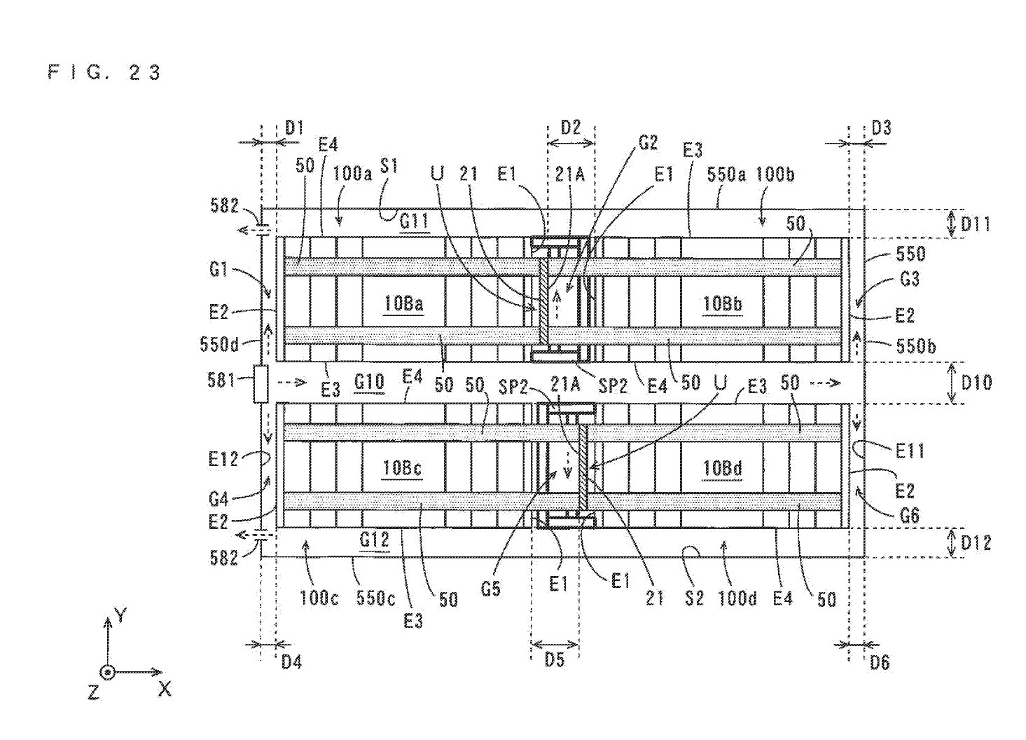

FIG. 22 is a schematic plan view illustrating a sixth arrangement example in the first embodiment when the spacer SP1 illustrated in FIG. 14 is used, and FIG. 23 is a schematic plan view illustrating a sixth arrangement example in the first embodiment when the spacer SP2 illustrated in FIG. 17 is used.

As illustrated in FIGS. 22 and 23, either one of the spacers SP1 and SP2 is provided between the end surface of the battery block provided with the printed circuit board and the opposed end surface of the battery block.

As illustrated in FIG. 22, when the spacer SP1 is used, the length of a supporting bar 820 in the spacer SP1 is determined so that the distance D2, D5 is greater than the distance D10. The length of the supporting bar 820 in the spacer SP1 is determined so that the distance D2, D5 is greater than the distance D1, D3, D4, D6, D11, D12. As illustrated in FIG. 23, when the spacer SP2 is used, the length of a supporting bar 820 in the spacer SP2 and an attachment position of a board holding plate 830 are determined so that the distance D2, D5 is greater than the distance D10. The length of the supporting bar 820 in the spacer SP2 and the attachment position of the board holding plate 830 are determined so that the distance D2, D5 is greater than the distance D1, D3, D4, D6, D11, D12. When the battery blocks 10Ba to 10Bd are housed in the casing 550, therefore, the gaps G1 to G6 can be formed without being positioned. Therefore, the battery system 500 becomes easy to manufacture.

When the spacer SP2 illustrated in FIG. 17 is used, the detection circuit 20 can more efficiently dissipate heat by a gap U formed between the printed circuit board 21 and an end surface E1, as illustrated in FIG. 23.

In this example, at least one of the distances D2 and D5 between the one surfaces 21A of the two printed circuit board 21 and the opposed end surfaces may be greater than at least one of the distances D1, D3, D4, D6, and D10 to D12 between the end surfaces to which no printed circuit board 21 is attached. In this case, a portion satisfying this relationship exists in the casing 550, thereby making space saving as well as improvements in the performance and the reliability of the battery system 500 feasible.

The distances D2 and D5 are each preferably greater than the greatest one of the distances D1, D3, D4, D6, and D10 to D12. In this case, further space saving can be implemented while the performance and the reliability of the battery system 500 are further improved.

(12) Seventh Arrangement Example in Casing in First Embodiment

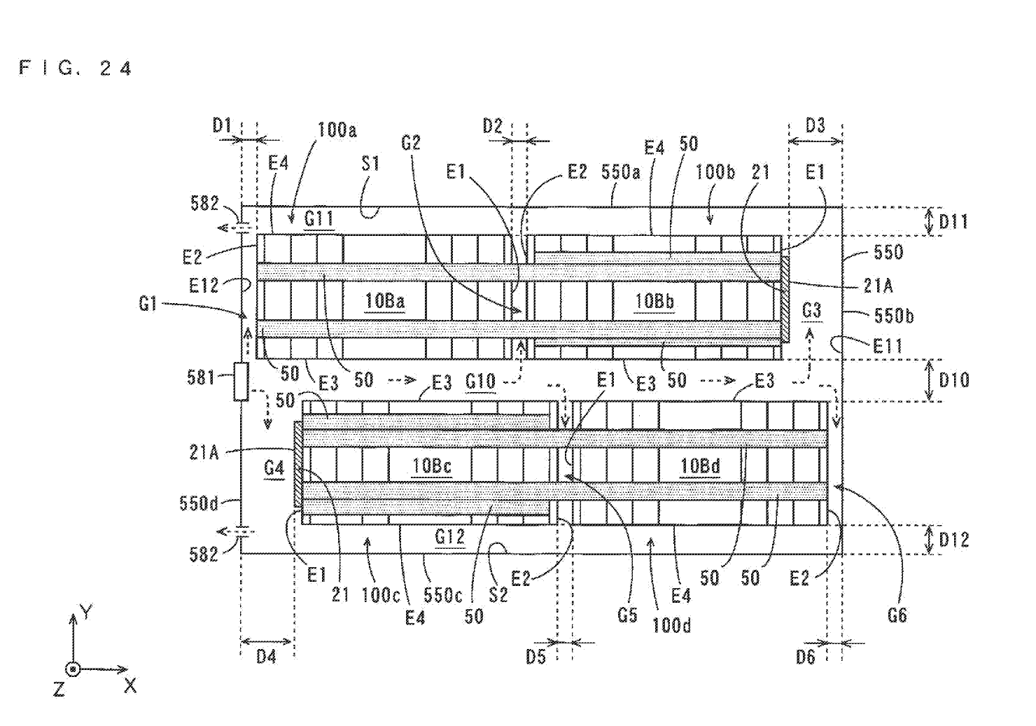

FIG. 24 is a schematic plan view illustrating a seventh arrangement example of the plurality of battery modules 100 housed in the casing 550 illustrated in FIG. 1 in the first embodiment. The seventh arrangement example will be described while referring to differences from the sixth arrangement example.

As illustrated in FIG. 24, in this example, an end surface E1 of a battery block 10Ba, 10Bb is directed toward a sidewall 550b of the casing 550. The printed circuit board 21 illustrated in FIG. 20 is provided on the end surface E1 of the battery block 10Bb, and no printed circuit board 21 is provided on the end surface E1 of the battery block 10Ba. The printed circuit board 21 provided on the end surface E1 of the battery block 10Bb is used in common between the battery modules 100a and 100b. Therefore, FPC boards 50 respectively extending from the battery block 10Ba and the battery block 10Bb are connected to the printed circuit board 21.

An end surface E1 of a battery block 10Bc, 10Bd is directed toward a sidewall 550d of the casing 550. The printed circuit board 21 illustrated in FIG. 20 is provided on the end surface E1 of the battery block 10Bc, and no printed circuit board 21 is provided on the end surface E1 of the battery block 10Bd. The printed circuit board 21 provided on the end surface E1 of the battery block 10Bc is used in common between the battery modules 100c and 100d. Therefore, FPC boards 50 respectively extending from the battery block 10Bc and the battery block 10Bd are connected to the printed circuit board 21.

In this state, one surface 21A of the printed circuit board 21 provided in the battery block 10Bb and an end surface E11 of the casing 550, which is opposed to the one surface 21A, are spaced a distance D3 apart from each other. Thus, a gap G3 is formed between the one surface 21A of the printed circuit board 21 provided in the battery block 10Bb and the end surface E11 of the casing 550.

One surface 21A of the printed circuit board 21 provided in the battery block 10Bc and an end surface E12 of the casing 550, which is opposed to the one surface 21A, are spaced a distance D4 apart from each other. Thus, a gap G4 is formed between the one surface 21A of the printed circuit board 21 provided in the battery block 10Bc and the end surface E12 of the casing 550.

The end surface E12 of the casing 550 and an end surface E2 of the battery block 10Ba, which is opposed to the end surface E12, are spaced a distance D1 apart from each other. Thus, a gap G1 is formed between the end surface E12 of the casing 550 and the end surface E2 of the battery block 10Ba.

The end surface E1 of the battery block 10Ba and an end surface E2 of the battery block 10Bb, which is opposed to the end surface E1, are spaced a distance D2 apart from each other. Thus, a gap G2 is formed between the end surface E1 of the battery block 10Ba and the end surface E2 of the battery block 10Bb.

An end surface E2 of the battery block 10Bc and the end surface E1 of the battery block 10Bd, which is opposed to the end surface E2, are spaced a distance D5 apart from each other. Thus, a gap G5 is formed between the end surface E2 of the battery block 10Bc and the end surface E1 of the battery block 10Bd.

An end surface E2 of the battery block 10Bd and the end surface E11 of the casing 550, which is opposed to the end surface E2, are spaced a distance D6 apart from each other. Thus, a gap G6 is formed between the end surface E2 of the battery block 10Bd and the end surface E11 of the casing 550.

In this example, the battery blocks 10Ba to 10Bd are positioned in the casing 550 so that the distance D3, D4 between the one surface 21A of the printed circuit board 21 and the opposed end surface of the casing 550 is greater than the distance D1, D6, D11, D12 between the end surface of the battery block, to which no printed circuit board 21 is attached, and the opposed end surface of the casing 550.

The battery blocks 10Ba to 10Bd are positioned in the casing 550 so that the distance D3, D4 between the one surface 21A of the printed circuit board 21 and the opposed end surface of the casing 550 is greater than the distance D2, D5, D10 between the end surfaces of the battery blocks, to which no printed circuit board 21 is attached.

Thus, a sufficient air passage is ensured along the one surface 21A of the printed circuit board 21 in the gap G3, G4.

In this example, either one of the spacers SP1 and SP2 illustrated in FIGS. 15 and 17 is also fitted between the end surface of the battery block provided with the printed circuit board 21 in the casing 550 and the opposed end surface of the casing 550.

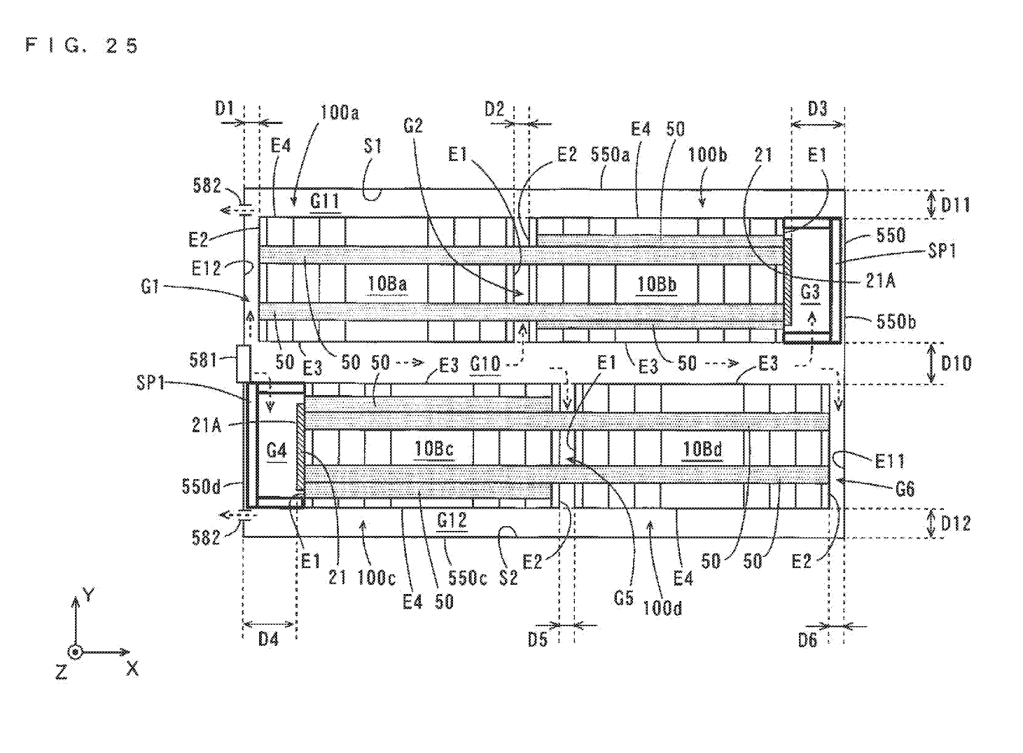

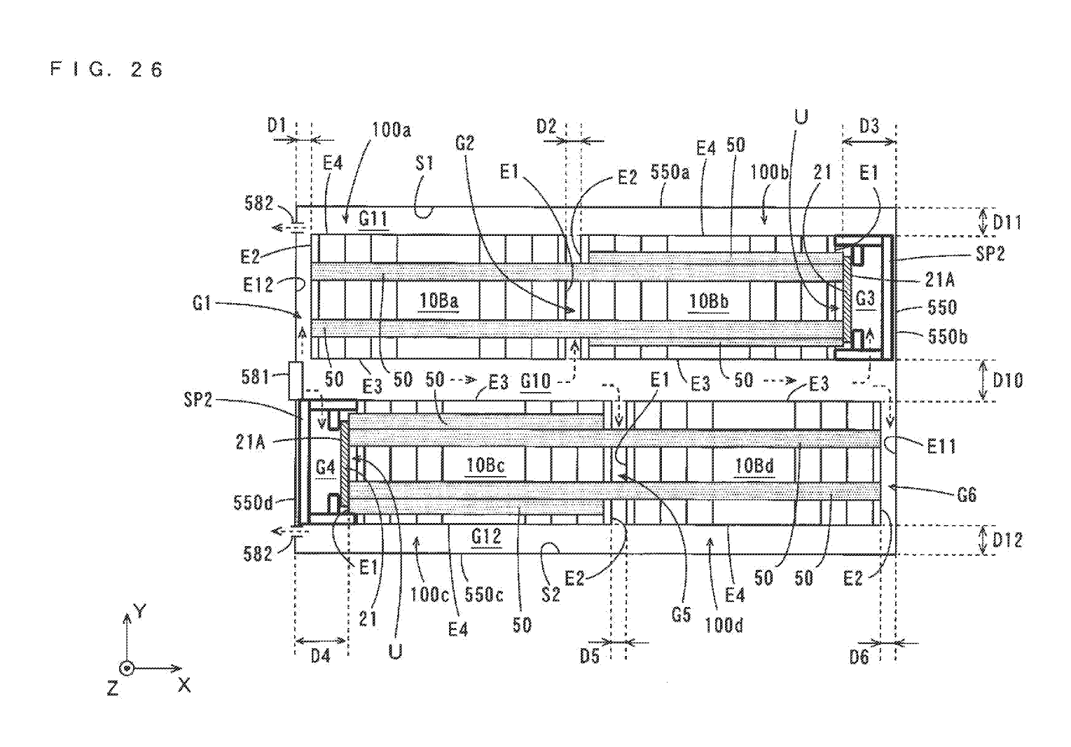

FIG. 25 is a schematic plan view illustrating a seventh arrangement example in the first embodiment when the spacer SP1 illustrated in FIG. 14 is used, and FIG. 26 is a schematic plan view illustrating a seventh arrangement example in the first embodiment when the spacer SP2 illustrated in FIG. 17 is used. As illustrated in FIGS. 25 and 26, either one of the spacers SP1 and SP2 is provided between the end surface of the battery block provided with the printed circuit board 21 and the opposed end surface of the casing 550. When the spacer SP1 is used, as illustrated in FIG. 25, the length of a supporting bar 820 in the spacer SP1 is determined so that the distance D3, D4 is greater than the distance D1, D6, D11, D12. The length of the supporting bar 820 in the spacer SP1 is determined so that the distance D3, D4 is greater than the distance D2, D5, D10.

As illustrated in FIG. 26, when the spacer SP2 is used, the length of a supporting bar 820 in the spacer SP2 and an attachment position of a board holding plate 830 are determined so that the distance D3, D4 is greater than the distance D1, D6, D11, D12. The length of the supporting bar 820 in the spacer SP2 and the attachment position of the board holding plate 830 are determined so that the distance D3, D4 is greater than the distance D2, D5, D10. When the battery blocks 10Ba to 10Bd are housed in the casing 550, therefore, the gaps G1 to G6 can be formed without being positioned. Therefore, the battery system 500 becomes easy to manufacture. When the spacer SP2 illustrated in FIG. 17 is used, the detection circuit 20 can more efficiently dissipate heat by a gap U formed between the printed circuit board 21 and the end surface E1, as illustrated in FIG. 26.

In this example, at least one of the distances D3 and D4 between the one surface 21A of the printed circuit board 21 and the opposed end surface may be greater than at least one of the distances D1, D2, D5, D6, and D10 to D12 between the end surfaces to which no printed circuit board 21 is attached. In this case, a portion satisfying this relationship exists in the casing 550, thereby making space saving as well as improvements in the performance and the reliability of the battery system 500 feasible.

The distances D3 and D4 are each preferably greater than the greatest one of the distances D1, D2, D5, D6, and D10 to D12. In this case, further space saving can be implemented while the performance and the reliability of the battery system 500 are further improved.

(13) Eighth Arrangement Example in Casing in First Embodiment

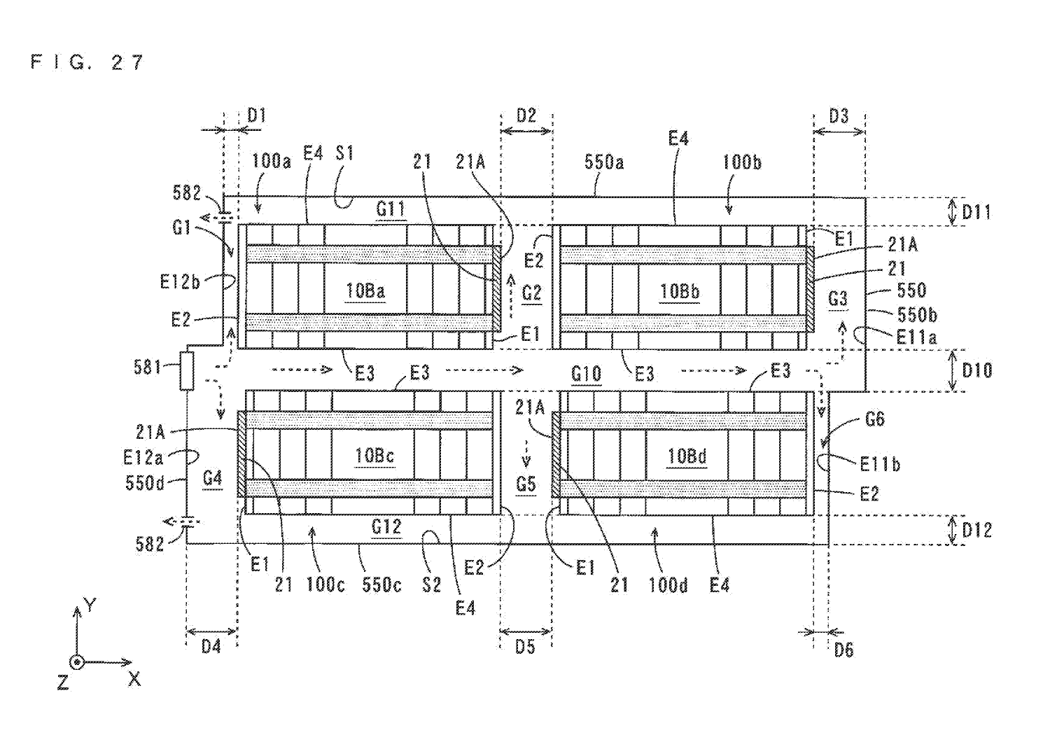

FIG. 27 is a schematic plan view illustrating an eighth arrangement example of the plurality of battery modules 100 housed in the casing 550 illustrated in FIG. 1 in the first embodiment. The eighth arrangement example will be described while referring to differences from the first arrangement example.

As illustrated in FIG. 27, in this example, the position of an end surface E2 of a battery block 10Ba and the position of one surface 21A of a printed circuit board 21 provided in a battery block 10Bc match each other in the X-direction. The position of one surface 21A of a printed circuit board 21 provided in the battery block 10Ba and the position of an end surface E2 of the battery block 10Bc match each other.

Furthermore, the position of an end surface E2 of a battery block 10Bb and the position of one surface 21A of a printed circuit board 21 provided in a battery block 10Bd match each other in the X-direction. The position of one surface 21A of the printed circuit board 21 provided in the battery block 10Bb and the position of an end surface E2 of the battery block 10Bd match each other.

A portion of a sidewall 550b of a casing 550, which is opposed to the one surface 21A of the printed circuit board 21 provided in the battery block 10Bb, is more greatly enlarged in the X-direction than the other portion. The sidewall 550b in this example includes an end surface Ella of the enlarged portion and an end surface E11b of the other portion that is not enlarged.

A portion of a sidewall 550d of the casing 550, which is opposed to the one surface 21A of the printed circuit board 21 provided in the battery block 10Bc, is more greatly enlarged in the X-direction than the other portion. The sidewall 550d in this example includes an end surface E12a of the enlarged portion and an end surface E12b of the other portion that is not enlarged.

In this state, the one surface 21A of the printed circuit board 21 provided in the battery block 10Ba and the end surface E2 of the battery block 10Bb, which is opposed to the one surface 21A, are spaced a distance D2 apart from each other. Thus, a gap G2 is formed between the one surface 21A of the printed circuit board 21 provided in the battery block 10Ba and the end surface E2 of the battery block 10Bb.

The one surface 21A of the printed circuit board 21 provided in the battery block 10Bb and the end surface E11a of the casing 550, which is opposed to the one surface 21A, are spaced a distance D3 apart from each other. Thus, a gap G3 is formed between the one surface 21A of the printed circuit board 21 in the battery block 10Bb and the end surface E11a of the casing 550.

The one surface 21A of the printed circuit board 21 provided in the battery block 10Bc and the end surface E12a of the casing 550, which is opposed to the one surface 21A, are spaced a distance D4 apart from each other. Thus, a gap G4 is formed between the one surface 21A of the printed circuit board 21 provided in the battery block 10Bc and the end surface E12a of the casing 550.

The one surface 21A of the printed circuit board 21 provided in the battery block 10Bd and the end surface E2 of the battery block 10Bc, which is opposed to the one surface 21A, are spaced a distance D5 apart from each other. Thus, a gap G5 is formed between the one surface 21A of the printed circuit board 21 provided in the battery block 10Bd and the end surface E2 of the printed circuit board 10Bc.

The end surface E12b of the casing 550 and the end surface E2 of the battery block 10Ba, which is opposed to the end surface E12b, are spaced a distance D1 apart from each other. Thus, a gap G1 is formed between the end surface E12b of the casing 550 and the end surface E2 of the battery block 10Ba.

The end surface E11b of the casing 550 and the end surface E2 of the battery block 10Bd, which is opposed to the end surface E11b, are spaced a distance D6 apart from each other. Thus, a gap G8 is formed between the end surface E11b of the casing 550 and the end surface E2 of the battery block 10Bd.

In this example, the distance D3, D4 is also greater than the distance D1, D6, D11, D12. More specifically, the distance D3, D4 between the one surface 21A of the printed circuit board 21 and the opposed end surface of the casing 550 is greater than the distance D1, D6, D11, D12 between the end surface of the battery block, to which no printed circuit board 21 is attached, and the opposed end surface of the casing 550. Thus, a sufficient air passage is ensured along the one surface 21A of the printed circuit board 21 in the gap G3, G4. The distance D2, D5 is greater than the distance D10. More specifically, the distance D2, D5 between the one surface 21A of the printed circuit board 21A and the opposed end surface of the battery block, to which no printed circuit board 21 is attached, is greater than the distance D1 between the end surfaces of the battery blocks, to which no printed circuit board 21 is attached. Further, the distance D2, D5 is greater than the distance D1, D6, D11, D12. More specifically, the distance D2, D5 between the one surface 21A of the printed circuit board 21 and the opposed end surface of the battery block, to which no printed circuit board 21 is attached, is greater than the distance D1, D6, D11, D12 between the end surface of the battery block, to which no printed circuit board 21 is attached, and the opposed end surface of the casing 550. Thus, a sufficient air passage is ensured along the one surface 21A of the printed circuit board 21 in the gap G2, G5.

A portion of the casing 550 is thus enlarged so that a sufficient air passage is ensured along the one surface 21A of the printed circuit board 21. A space occurring outside the casing 550 can be effectively made use of by a portion, which is not enlarged, of the casing 550.

(14) Ninth Arrangement Example in Casing in First Embodiment

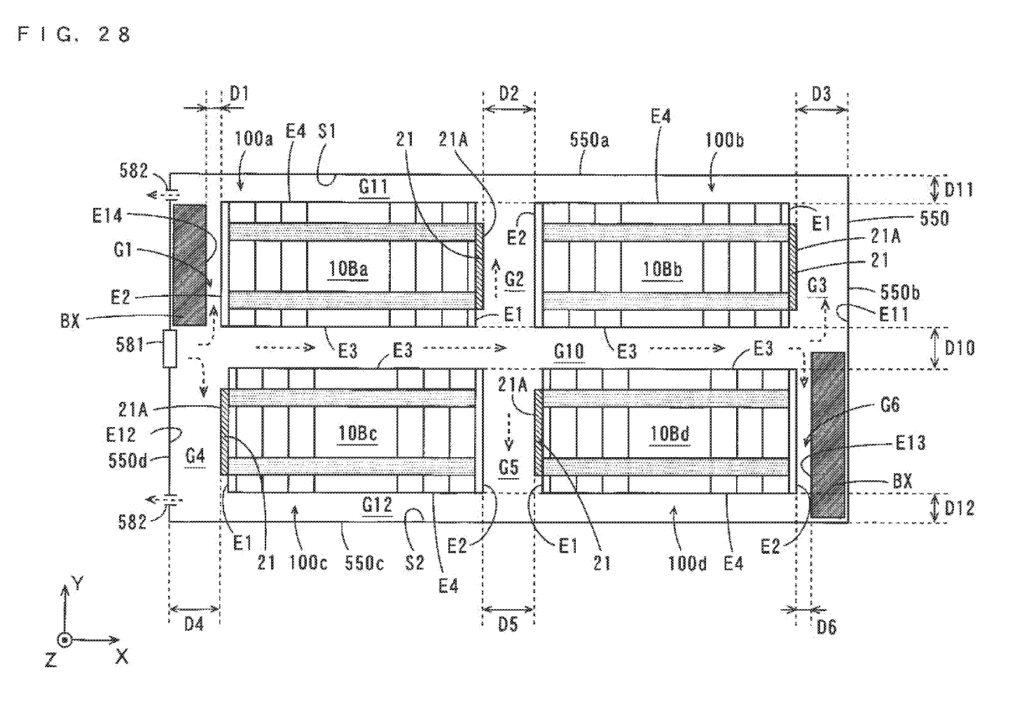

FIG. 28 is a schematic plan view illustrating a ninth arrangement example of the plurality of battery modules 100 housed in the casing 550 illustrated in FIG. 1 in the first embodiment. The ninth arrangement example will be described while referring to differences from the first arrangement example.

As illustrated in FIG. 28, in this example, the position of an end surface E2 of a battery block 10Ba and the position of one surface 21A of a printed circuit board 21 provided in a battery block 10Bc match each other in the X-direction. The position of one surface 21A of a printed circuit board 21 provided in the battery block 10Ba and the position of an end surface E2 of the battery block 10Bc match each other.

Furthermore, the position of an end surface E2 of a battery block 10Bb and the position of one surface 21A of a printed circuit board 21 provided in a battery block 10Bd match each other in the X-direction. The position of one surface 21A of a printed circuit board 21 provided in the battery block 10Bb and the position of an end surface E2 of the battery block 10Bd match each other.

A circuit board BX on which the battery ECU 101 illustrated in FIG. 1 or another electronic component (e.g., a connector) is mounted is provided in a part of an end surface E12 of a casing 550, which is opposed to the end surface E2 of the battery block 10Ba. In this example, one surface of the circuit board BX, which is opposed to the end surface E2 of the battery block 10Ba, is referred to as an opposite surface E14. A circuit board BX on which the battery ECU 101 illustrated in FIG. 1 or another electronic component (e.g., a connector) is mounted is provided in a part of the end surface E11 of the casing 550, which is opposed to the end surface E2 of the battery block 10Bd. In this example, one surface of the circuit board BX, which is opposed to the end surface E2 of the battery block 10Bd, is referred to as an opposite surface E13. In the present embodiment, one surface of the circuit board BX refers to a surface of a region excluding mounting components.

In this state, the one surface 21A of the printed circuit board 21 provided in the battery block 10Ba and the end surface E2 of the battery block 10Bb, which is opposed to the one surface 21A, are spaced a distance D2 apart from each other. Thus, a gap G2 is formed between the one surface 21A of the printed circuit board 21 provided in the battery block 10Ba and the end surface E2 of the battery block 10Bb.

The one surface 21A of the printed circuit board 21 provided in the battery block 10Bb and the end surface E11 of the casing 550, which is opposed to the one surface 21A, are spaced a distance D3 apart from each other. Thus, a gap G3 is formed between the one surface 21A of the printed circuit board 21 provided in the battery block 10Bb and the end surface E11 of the casing 550.

The one surface 21A of the printed circuit board 21 provided in the battery block 10Bc and the end surface E12 of the casing 550, which is opposed to the one surface 21A, are spaced a distance D4 apart from each other. Thus, a gap G4 is formed between the one surface 21A of the printed circuit board 21 provided in the battery block 10Bc and the end surface E12 of the casing 550.

The one surface 21A of the printed circuit board 21 provided in the battery block 10Bd and the end surface E2 of the battery block 10Bc, which is opposed to the one surface 21A, are spaced a distance D5 apart from each other. Thus, a gap G5 is formed between the one surface 21A of the printed circuit board 21 provided in the battery block 10Bd and the end surface E2 of the battery block 10Bc.

The opposite circuit E14 of the circuit board BX and the end surface E2 of the battery block 10Ba are spaced a distance D1 apart from each other. Thus, a gap G1 is formed between the opposite surface E14 of the circuit board BX and the end surface E2 of the battery block 10Ba.

The opposite surface E13 of the circuit board BX and the end surface E2 of the battery block 10Bd are spaced a distance D6 apart from each other. Thus, a gap G6 is formed between the opposite surface E13 of the circuit board BX and the end surface E2 of the battery block 10Bd.

In this example, the distance D3, D4 is also greater than the distance D1, D6, D11, D12. More specifically, the distance D3, D4 between the one surface 21A of the printed circuit board 21 and the opposed end surface of the casing 550 is greater than the distance D1, D6, 1311, D12 between the end surface of the battery block, to which no printed circuit board 21 is attached, and the opposed end surface of the casing 550 or the opposed opposite surface of the circuit board BX. Thus, a sufficient air passage is ensured along the one surface 21A of the printed circuit board 21 in the gap G3, G4.

The distance D2, D5 is greater than the distance D10. More specifically, the distance D2, D5 between the one surface 21A of the printed circuit board 21 and the opposed end surface of the battery block, to which no printed circuit board 21 is attached, is greater than the distance D10 between the end surfaces of the battery blocks, to which no printed circuit board 21 is attached. Further, the distance D2, D5 is greater than the distance D1, D6, D11, D12. More specifically, the distance D2, D5 between the one surface 21A of the printed circuit board 21 and the opposed end surface of the battery block, to which no printed circuit board 21 is attached, is greater than the distance D1, D6, D11, D12 between the end surface of the battery block, to which no printed circuit board 21 is attached, and the opposed end surface of the casing 550 or the opposed opposite surface of the circuit board BX. Thus, a sufficient air passage is ensured along the one surface 21A of the printed circuit board 21 in the gap G2, G5.

The circuit board BX on which the battery ECU 101 or the other electronic component is mounted is provided between the end surfaces to which no printed circuit board 21 is attached so that the plurality of battery modules 100a to 100d and the circuit board BX can be integrally housed in the casing 550. This enables a space to which the detection circuit 20 is not attached to be effectively made use of within the casing 550, thereby implementing space saving. The battery system 500 becomes easy to handle.

(15) Tenth Arrangement Example in Casing in First Embodiment

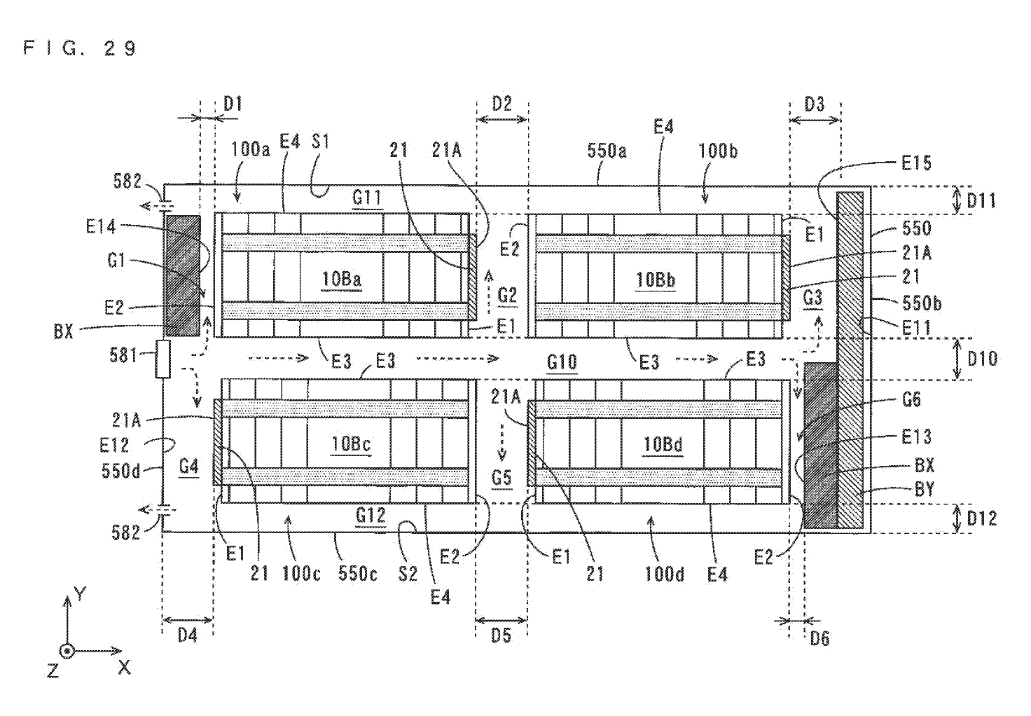

FIG. 29 is a schematic plan view illustrating a tenth arrangement example of the plurality of battery modules 100 housed in the casing 550 illustrated in FIG. 1 in the first embodiment. The tenth arrangement example will be described while referring to differences from the ninth arrangement example.

As illustrated in FIG. 29, in this example, a circuit board BY on which the battery ECU 101 illustrated in FIG. 1 is mounted is provided to cover an end surface E11 in a casing 550. Further, a circuit board BX on which an electronic component including a connector is mounted is provided in a part of the circuit board BY, which is opposed to an end surface E2 of a battery block 10Bd.

Also in this example, one surface of the circuit board BX, which is opposed to an end surface E2 of a battery block 10Ba, is referred to as an opposite surface E14, and one surface of the circuit board BX, which is opposed to the end surface E2 of the battery block 10Bd, is referred tows an opposite surface E13. Further, a portion of one surface of the circuit board BY which is opposed to one surface 21A of a printed circuit board 21 provided on an end surface E1 of a battery block 10Bb is referred to as an opposite surface E15. In the present embodiment, the one surface of the circuit board BY refers to a surface of a region excluding mounted components.

In this state, the one surface 21A of the printed circuit board 21 provided in the battery block 10Bb and the opposite surface E15 of the circuit board BY, which is opposed to the one surface 21A, are spaced a distance D3 apart from each other. Thus, a gap G3 is formed between the one surface 21A of the printed circuit board 21 provided in the battery block 10Bb and the opposite surface E15 of the circuit board BY. The opposite surface E13 of the circuit board BX and the end surface E2 of the battery block 10Bd are spaced a distance D6 apart from each other. Thus, a gap G6 is formed between the end surface E13 of the casing 550 and the end surface E2 of the battery block 10Bd.

In this example, the distance D3, D4 is also greater than the distance D1, D6, D11, D12. More specifically, the distance D3, D4 between the one surface 21A of the printed circuit board 21 and the opposed end surface of the casing 550 or the opposed opposite surface of the circuit board BY is greater than the distance D1, D6, D11, D12 between the end surface of the battery block, to which no printed circuit board 21 is attached, and the opposed end surface of the casing 550 or the opposed opposite surface of the circuit board BX, BY. Thus, a sufficient air passage is ensured along the one surface 21A of the printed circuit board 21 in the gap G3, G4.

The distance D2, D5 is greater than the distance D10. More specifically, the distance D2, D5 between the one surface 21A of the printed circuit board 21 and the opposed end surface of the battery block, to which no printed circuit board 21 is attached, is greater than the distance D10 between the end surfaces of the battery blocks, to which no printed circuit board 21 is attached.

Furthermore, the distance D2, D5 is greater than the distance D1, D6, D11, D12. More specifically, the distance D2, D5 between the one surface 21A of the printed circuit board 21 and the opposed end surface of the battery block, to which no printed circuit board 21 is attached, is greater than the distance D1, D6, D11, D12 between the end surface of the battery block, to which no printed circuit board 21 is attached, and the opposed end surface of the casing 550 or the opposed opposite surface of the circuit board BX. Thus, a sufficient air passage is ensured along the one surface 21A of the printed circuit board 21 in the gap G2, G5. Thus, the circuit board BX, BY on which the battery ECU 101 or the other electronic component is mounted is provided between the end surfaces to which no printed circuit board 21 is attached so that the plurality of battery modules 100a to 100d and the circuit boards BX and BY can be integrally housed in the casing 550. This enables a space to which the detection circuit 20 is not attached to be effectively made use of within the casing 550, thereby implementing miniaturization. The battery system 500 becomes easy to handle.

(16) Eleventh Arrangement Example in Casing in First Embodiment

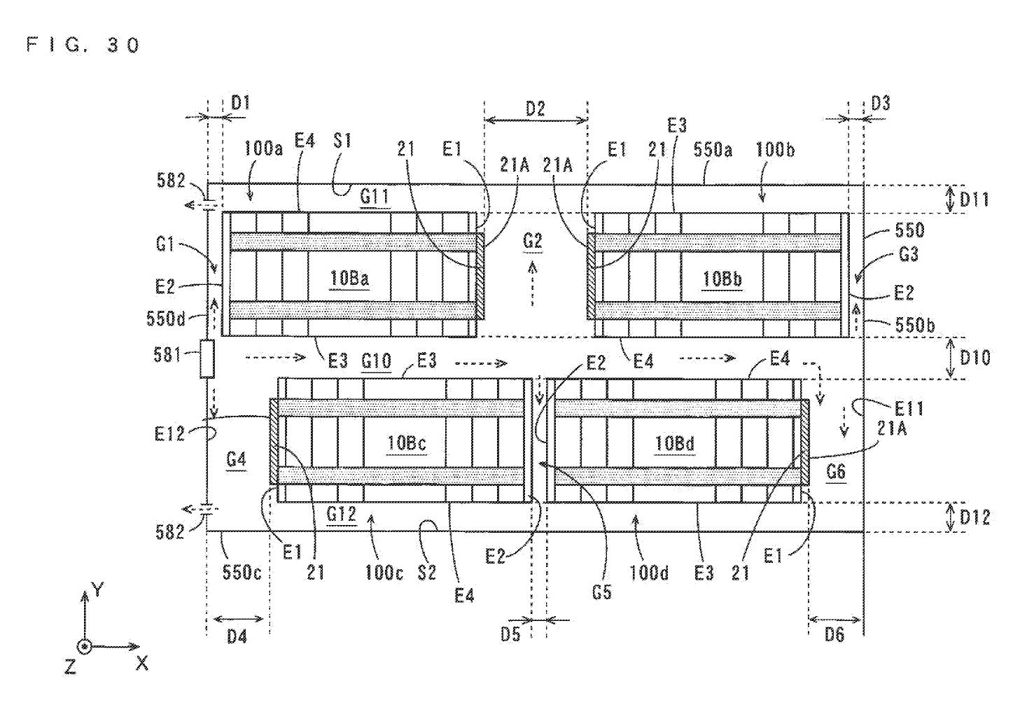

FIG. 30 is a schematic plan view illustrating an eleventh arrangement example of the plurality of battery modules 100 housed in the casing 550 illustrated in FIG. 1 in the first embodiment. The eleventh arrangement example will be described while referring to differences from the first arrangement example.

As illustrated in FIG. 30. In this example, an end surface E1 of a battery block 10Ba, 10Bd is directed toward a sidewall 550b of the casing 550. An end surface E1 of a battery block 10Bb, 108c is directed toward a sidewall 550d of the casing 550.

Thus, the end surfaces E1 of the battery blocks 10Ba and 10Bb provided with printed circuit boards 21 are opposed to each other, and the end surfaces E1 of the battery blocks 10Bc and 10Bd provided with printed circuit boards 21 are opposed to each other. In this state, one surface 21A of the printed circuit board 21 provided in the battery block 10Ba and opposed one surface 21A of the printed circuit board 21 provided in the battery block 10Bb are spaced a distance D2 apart from each other. Thus, a gap G2 is formed between the one surface 21A of the printed circuit board 21 provided in the battery block 10Ba and the one surface 21A of the printed circuit board 21 provided in the battery block 10Bb.

One surface 21A of the printed circuit board 21 provided in the battery block 10Bc and an end surface E12 of the casing 550, which is opposed to the one surface 21A, are spaced a distance D4 apart from each other. Thus, a gap G4 is formed between the one surface 21A of the printed circuit board 21 provided in the battery block 10Bc and the end surface E12 of the casing 550.

One surface 21A of a printed circuit board 21 provided in the battery block 10Bd and an end surface E11 of the casing 550, which is opposed to the one surface 21A, are spaced a distance D6 apart from each other. Thus, a gap G6 is formed between the one surface 21A of the printed circuit board 21 provided in the battery block 10Bd and the end surface E11 of the casing 550.

In this example, the battery blocks 10Ba to 10Bd are positioned in the casing 550 so that the distance D2 between the one surfaces 21A of the printed circuit boards 21, which are opposed to each other, is greater than the distance D5, D10 between a pair of end surfaces of the battery blocks, to which no printed circuit board 21 is attached. Thus, a sufficient air passage is ensured along the one surface 21A of the printed circuit board 21 in the gap G2.

In this example, the battery blocks 10Ba to 10Bd are positioned in the casing 550 so that the distance D4, D6 between the one surface 21A of the printed circuit board 21 and the opposed end surface of the casing 550 is greater than the distance D1, D3, D11, D12 between the end surface of the battery block, to which no printed circuit board 21 is attached, and the end surface of the casing 550. The battery blocks 10Ba to 10Bd are positioned in the casing 550 so that the distance D4, D6 between the one surfaces 21A of the printed circuit board 21 and the opposed end surfaces of the casing 550 is greater than the distance D5, D10 between the end surfaces of the battery blocks, to which no printed circuit board 21 is attached. Thus, a sufficient air passage is ensured along the one surface 21A of the printed circuit board 21 in the gap G4, G6.

In this example, at least one of the distance D2 between the one surfaces 21A of the two printed circuit boards 21 and the distances D4 and D6 between the one surfaces 21A of the printed circuit boards 21 and the opposed end surfaces of the casing 550 may be greater than at least one of the distances D1, D3, D5, and D10 to D12 between the end surfaces to which no printed circuit board 21 is attached. In this case, a portion satisfying this relationship exists in the casing 550, thereby making space saving as well as improvements in the performance and the reliability of the battery system 500 feasible.

The distances D2, D4, and D6 are each preferably greater than the greatest one of the distances D1, D3, D5, and D10 to D12. In this case, further space saving can be implemented while the performance and the reliability of the battery system 500 are further improved.

(17) Twelfth Arrangement Example in Casing in First Embodiment

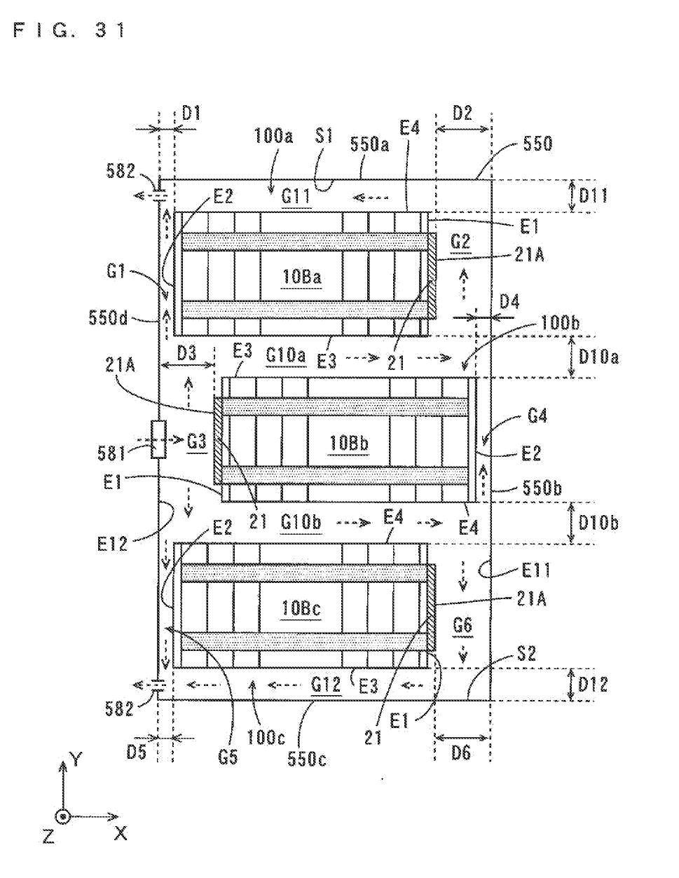

FIG. 31 is a schematic plan view illustrating a twelfth arrangement example of the plurality of battery modules 100 housed in the casing 550 illustrated in FIG. 1 in the first embodiment. The twelfth arrangement example will be described while referring to differences from the first arrangement example.

As illustrated in FIG. 31, in this example, three battery modules 100a, 100b, 100c line up in this order in the Y-direction. The battery modules 100a and 100c are arranged so that end surfaces E1 of battery blocks 10Ba and 10Bc are directed toward a sidewall 550b of a casing 550. A printed circuit board 21 is provided on each of the end surfaces E1 of the battery blocks 10Ba and 10Bc. The battery module 100b is arranged so that an end surfaces E1 of a battery block 10Bb is directed toward a sidewall 550d. A printed circuit board 21 is provided on the end surface E1 of the battery block 10Bb.

In this state, one surface 21A of the printed circuit board 21 provided in the battery block 10Ba and an end surface E11 of the casing 550, which is opposed to the one surface 21A, are spaced a distance D2 apart from each other. Thus, a gap G2 is formed between the one surface 21A of the printed circuit board 21 provided in the battery block 10Ba and the end surface E11 of the casing 550.

One surface 21A of the printed circuit board 21 provided in the battery block 10Bb and an end surface E12 of the casing 550, which is opposed to the one surface 21A, are spaced a distance D3 apart from each other. Thus, a gap G3 is formed between the one surface 21A of the printed circuit board 21 provided in the battery block 10Bb and the end surface E12 of the casing 550.

One surface 21A of the printed circuit board 21 provided in the battery block 10Bc and the end surface E11 of the casing 550, which is opposed to the one surface 21A, are spaced a distance D6 apart from each other. Thus, a gap G6 is formed between the one surface 21A of the printed circuit board 21 provided in the battery block 10Bc and the end surface E11 of the casing 550.

The end surface E12 of the casing 550 and an end surface E2 of the battery block 10Ba, which is opposed to the end surface E12, are spaced a distance D1 apart from each other. Thus, a gap G1 is formed between the end surface E12 of the casing 550 and the end surface E2 of the battery block 10Ba.

The end surface E11 of the casing 550 and an end surface E2 of the battery block 10Bb, which is opposed to the end surface E11, are spaced a distance D4 apart from each other. Thus, a gap G4 is formed between the end surface E11 of the casing 550 and the end surface E2 of the battery block 10Bb.

The end surface E12 of the casing 550 and an end surface E2 of the battery block 10Bc, which is opposed to the end surface E12, are spaced a distance D5 apart from each other. Thus, a gap G5 is formed between the end surface E12 of the casing 550 and the end surface E2 of the battery block 10Bc.

An end surface E3 of the battery block 10Ba and an opposed end surface E3 of the battery block 10Bb are spaced a distance D10a apart from each other. Thus, a gap G10a is formed between the end surface E3 of the battery block 10Ba and the end surface E3 of the battery block 10Bb.

An end surface E4 of the battery block 10Bb and an opposed end surface E4 of the battery block 10Bc are spaced a distance D10b apart from each other. Thus, a gap G10b is formed between the end surface E4 of the battery block 10Bb and the end surface E4 of the battery block 10Bc.

An end surface S1 of the casing 550 and an end surface E4 of the battery block 10Ba, which is opposed to the end surface S1, are spaced a distance D11 apart from each other. Thus, a gap G11 is formed between the end surface S1 of the casing 550 and the end surface E4 of the battery block 10Ba.

An end surface S2 of the casing 550 and an end surface E3 of the battery block 10Bc, which is opposed to the end surface S2, are spaced a distance D12 apart from each other. Thus, a gap G12 is formed between the end surface S2 of the casing 550 and the end surface E3 of the battery block 10Bc.

In this example, the battery blocks 10Ba to 10Bc are positioned in the casing 550 so that the gaps G1 to G6, G10a, G10b, G11, and G12 are formed. The distance D2, D3, D6 is greater than the distance D1, D4, D5, D11, D12. More specifically, the distance D2, D3, D6 between the one surface 21A of the printed circuit board 21 and the opposed end surface of the casing 550 is greater than the distance D1, D4, D5, D11, D12 between the end surface of the battery block, to which no printed circuit board 21 is attached, and the end surface of the casing 550. The distance D2, D3, D6 is greater than the distance D10a, D10b. More specifically, the distance D2, D3, D6 between the one surface 21A of the printed circuit board 21 and the opposed end surface of the casing 550 is greater than the distance D10a, D10b between the end surfaces of the battery blocks, to which no printed circuit board 21 is attached. Thus, a sufficient air passage is ensured along the one surface 21A of the printed circuit board 21 in the gap G2, G3, G6.

The distances D1, D4, D5, D11, D12 between the end surfaces to which no printed circuit board 21 is attached is smaller than the distance D2, D3, D6 between the one surface 21A of the printed circuit board 21 and the opposed end surface of the casing 550. Further, the distances D10a, D10b between the end surfaces to which no printed circuit board 21 is attached is smaller than the distance D2, D3, D6 between the one surface 21A of the printed circuit board 21 and the opposed end surface of the casing 550. Therefore, a minimum air passage required for the detection circuit 20 to dissipate heat can be efficiently ensured without increasing the capacity of the casing 550.

In this example, at least one of the distances D2, D3, and D6 between the one surfaces 21A of the printed circuit board 21 and the opposed end surfaces of the casing 550 is greater than at least one of the distances D1, D4, D5, D10a, D10b, D11, and D12 between the end surfaces to which no printed circuit board 21 is attached. In this case, a portion satisfying this relationship exists in the casing 550, thereby making space saving as well as improvements in the performance and the reliability of the battery system 500 feasible.

The distances D2, D3, and D6 are each preferably greater than the greatest one of the distances D1, D4, D5, D10a, D10b, D11, and D12. In this case, further space saving can be implemented while the performance and the reliability of the battery system 500 are further improved.

(18) Thirteenth Arrangement Example in Casing in First Embodiment

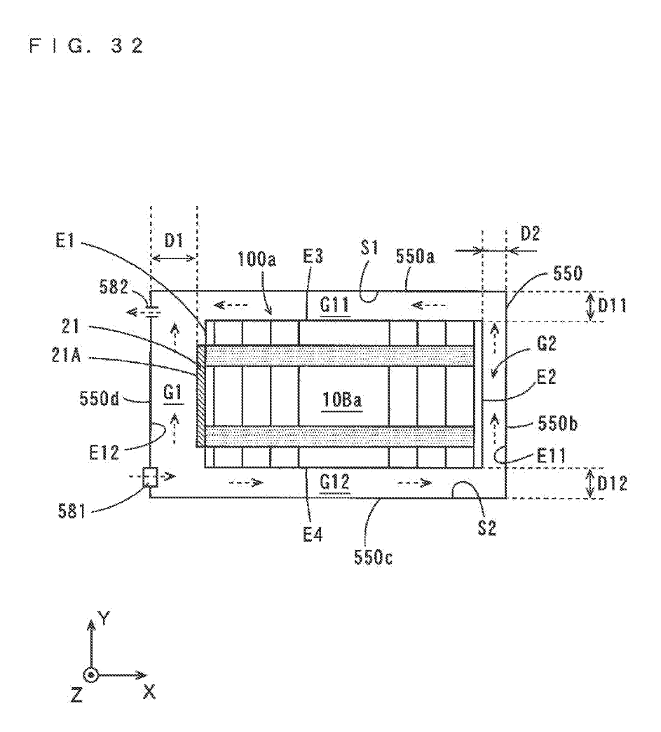

FIG. 32 is a schematic plan view illustrating a thirteenth arrangement example of one battery module 100 housed in the casing 550 illustrated in FIG. 1 in the first embodiment. The thirteenth arrangement example will be described while referring to differences from the first arrangement example.

As illustrated in FIG. 32, in this example, one battery module 100a is housed in a casing 550. The battery module 100a is arranged so that an end surface E1 of a battery block 10Ba is directed toward a sidewall 550d. A printed circuit board 21 is provided on the end surface E1 of the battery block 10Ba. In this state, one surface 21A of the printed circuit board 21 provided in the battery block 10Ba and an end surface E12 of the casing 550, which is opposed to the one surface 21A, are spaced a distance D1 apart from each other. Thus, a gap G1 is formed between the one surface 21A of the printed circuit board 21 provided in the battery block 10Ba and the end surface E12 of the casing 550.

An end surface E2 of the battery block 10Ba and an end surface E11 of the casing 550, which is opposed to the end surface E2, are spaced a distance D2 apart from each other. Thus, a gap G2 is formed between the end surface E2 of the battery block 10Ba and the end surface E11 of the casing 550.

An end surface E3 of the battery block 10Ba and an end surface S1 of the casing 550 are spaced a distance D11 apart from each other. Thus, a gap G11 is formed between the end surface E3 of the battery block 10Ba and the end surface S1 of the casing 550.

An end surface E4 of the battery block 10Ba and an end surface S2 of the casing 550 are spaced a distance D12 apart from each other. Thus, a gap G12 is formed between the end surface E4 of the battery block 10Ba and the end surface S2 of the casing 550.

In this example, the battery block 10Ba is positioned so that the gaps G1, G2, G11, and G12 are formed within the casing 550. The distance D1 between the one surface 21A of the printed circuit board 21 and the opposed end surface of the casing 550 is greater than the distance D2, D11, D12 between the end surface of the battery block, to which no printed circuit board 21 is attached, and the end surface of the casing 550. Thus, a sufficient air passage is ensured along the one surface 21A of the printed circuit board 21 in the gap G1. The distance D2 between the end surfaces to which no printed circuit board 21 is attached is smaller than the distance D1 between the end surfaces to which the printed circuit board 21 is attached. Therefore, a minimum air passage required for the detection circuit 20 to dissipate heat can be efficiently ensured without increasing the capacity of the casing 550. These results enable space saving to be implemented, and improve the performance and the reliability of the battery system 500.

In this example, the distance D1 between the one surface 21A of the printed circuit board 21 and the opposed end surface of the casing 550 may be greater than at least one of the distances D2, D11, and D12 between the end surfaces to which no printed circuit board 21 is attached. In this case, a portion satisfying this relationship exists in the casing 550, thereby making space saving as well as improvements in the performance and the reliability of the battery system 500 feasible. The distance D1 is preferably greater than the greatest one of the distances D2, D11, and D12. In this case, further space saving can be implemented while the performance and the reliability of the battery system 500 are further improved.

(19) Fourteenth Arrangement Example in Casing in First Embodiment

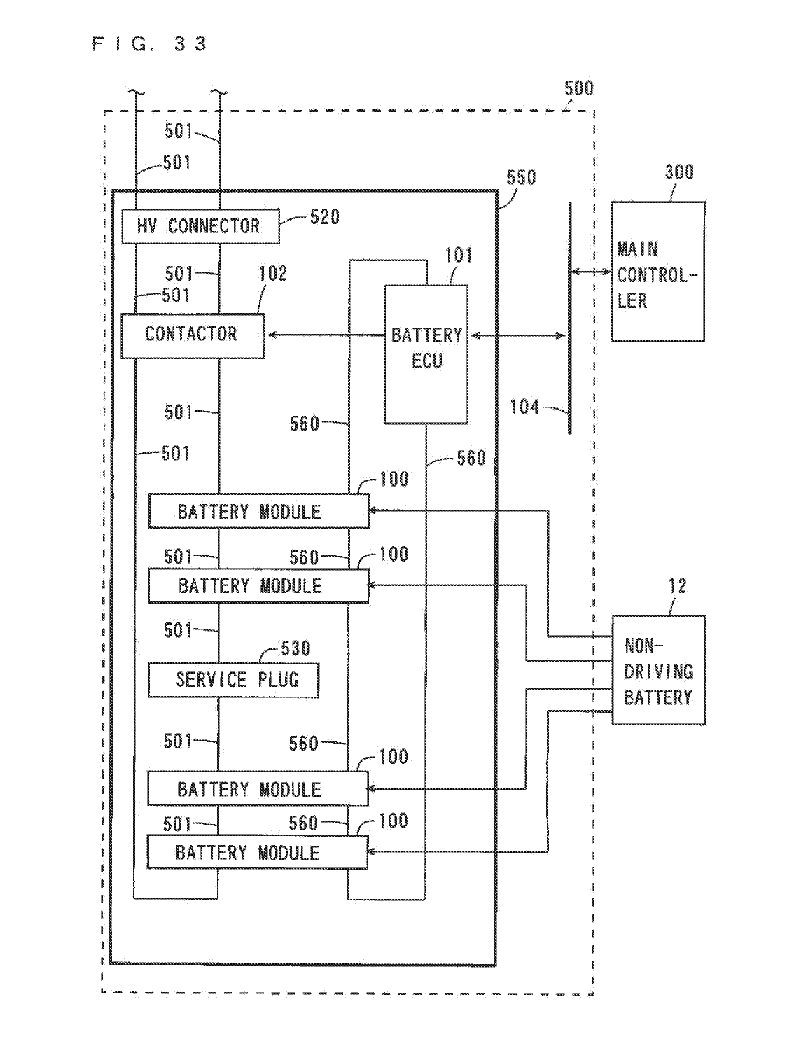

FIG. 33 is a block diagram illustrating another configuration example of the battery system according to the first embodiment. A battery system 500 illustrated in FIG. 33 further includes a high voltage (HV) connector 520 and a service plug 530 in addition to four battery modules 100 illustrated in FIG. 1, a battery ECU 101 illustrated in FIG. 1, and a contactor 102 illustrated in FIG. 1. The battery system 500 is also connected to a main controller 300 in an electric vehicle via a bus 104, similarly to the battery system 500 illustrated in FIG. 1.

As illustrated in FIG. 33, in this example; the ECU 101, the contactor 102, the HV connector 520, and the service plug 530, together with the plurality of battery modules 100, are housed in a casing 550.

In the battery system 500 illustrated in FIG. 33, the plurality of battery modules 100 are connected to one another via a power supply line 501. The power supply line 501 connected to a plus electrode 10a (FIG. 4) having the highest potential in the plurality of battery modules 100 and the power supply line 501 connected to a minus electrode 10b (FIG. 4) having the lowest potential in the plurality of battery modules 100 are connected to the HV connector 520 via the contactor 102. The HV connector 520 is connected to a load such as a motor in the electric vehicle via the power supply line 501.

The service plug 530 is inserted into the power supply line 501 connecting the two battery modules 100, which are not positioned at both ends, out of the four battery modules 100 connected in series. A non-driving battery 12 in the electric vehicle is connected to the communication circuits 24 (see FIG. 1) in the plurality of battery modules 12.

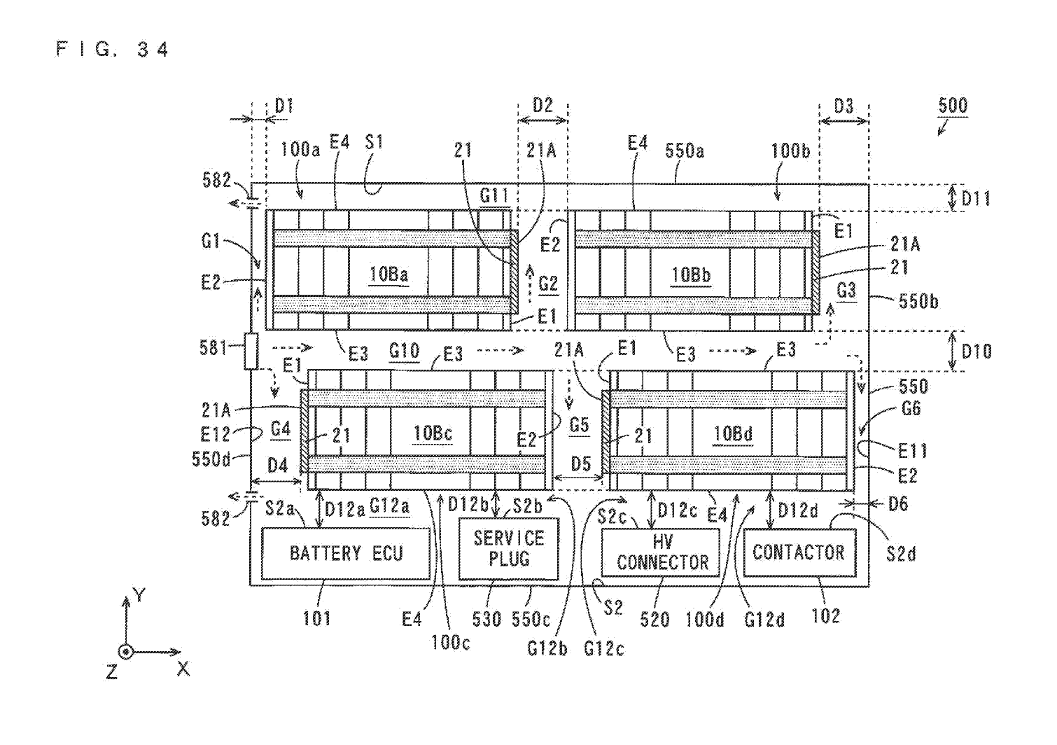

FIG. 34 is a schematic plan view illustrating a fourteenth arrangement example of the plurality of battery modules 100 housed in the casing 550 illustrated in FIG. 33 in the first embodiment. The fourteenth arrangement example will be described while referring to differences from the first arrangement example.

(19-a) Arrangement of Components

As described above, the battery ECU 101, the contactor 102, the HV connector 520, and the service plug 530, together with the plurality of battery modules 100, are housed in the casing 550.

In a region between a battery block 10Bc, 10Bd and a sidewall 550c in the Y-direction, the battery ECU 101, the service plug 530, the HV connector 520, and the contactor 102 line up in this order from a sidewall 550d to a sidewall 550b and are in close proximity to an end surface S2. The battery ECU 101 and the service plug 530 are positioned between the battery block 10Bc and the sidewall 550c, and the HV connector 520 and the contactor 102 are positioned between the battery block 10Bd and the sidewall 550c.

Consider four virtual planes that respectively contact the battery ECU 101, the service plug 530, the HV connector 520, and the contactor 102 and are parallel to an X-Z plane.

The virtual surface that contacts a closest portion of the battery ECU 101 to an end surface E4 of the battery block 10Bc is referred to as an opposite surface S2a, and the virtual surface that contacts a closest portion of the service plug 530 to the end surface E4 of the battery block 10Bc is referred to as an opposite surface S2b.

The virtual surface that contacts a closest portion of the HV connector 520 to an end surface E4 of the battery block 10Bd is referred to as an opposite surface S2c, and the virtual surface that contacts a closest portion of the contactor 102 to the end surface E4 of the battery block 10Bd is referred to as an opposite surface S2d.

In this case, in the casing 550, the opposite surface S2a of the battery ECU 101 and the end surface E4 of the battery block 10Bc are spaced a distance D12a apart from each other. Thus, a gap G12a is formed between the opposite surface S2a of the battery ECU 101 and the end surface E4 of the battery block 10Bc.

The opposite surface S2b of the service plug 530 and the end surface E4 of the battery block 10Bc are spaced a distance D12b apart from each other. Thus, a gap 312b is formed between the opposite surface S2b of the service plug 530 and the end surface E4 of the battery block 10Bc.

The opposite surface S2c of the HV connector 520 and the end surface E4 of the battery block 10Bd are spaced a distance D12c apart from each other. Thus, a gap G12c is formed between the opposite surface S2c of the HV connector 520 and the end surface E4 of the battery block 10Bd.

The opposite surface S2d of the contactor 102 and the end surface E4 of the battery block 10Bd are spaced a distance D12d apart from each other. Thus, a gap G12d is formed between the opposite surface S2d of the contactor 102 and the end surface E4 of the battery block 10Bd.

In this example, the distance D3, D4 is greater than the distance D1, D6, D11, D12a, D12b, D12c, D12d. More specifically, the distance D3, D4 between one surface 21A of a printed circuit board 21 and an opposed end surface of the casing 550 is greater than the distances D1, D6, and D11, and D12a, D12b, D12c, and D12d between the end surfaces of the battery blocks, to which no printed circuit board 21 is attached, and the opposed end surfaces of the casing 550 and the opposed opposite surfaces of the battery ECU 101, the service plug 530, the HV connector 520, and the contactor 102. Thus, a sufficient air passage is ensured along the one surface 21A of the printed circuit board 21 in the gap G3, G4.

The distance D2, D5 is greater than the distance D1, D6, D11, D12a, D12b, D12c and D12d. More specifically, the distance D2, D5 between the one surface 21A of the printed circuit board 21 and the opposed end surface of the battery block, to which no printed circuit board 21 is attached, is greater than the distances D1, D6, and D11, and D12a, D12b, D12c, and D12d between the end surfaces of the battery blocks, to which no printed circuit board 21 is attached, and the opposed end surfaces of the casing 550 and the opposed opposite surfaces of the battery ECU 101, the service plug 530, the HV connector 520, and the contactor 102. Thus, a sufficient air passage is ensured along the one surface 21A of the printed circuit board 21 in the gap G2, G5.

This enables the detection circuit 20 that generates heat to be sufficiently cooled by the flow of air, thereby enabling a rise in temperature of the battery system 500 to be suppressed. As a result, output limitation, deterioration, and reduction in life of the battery system 500 due to the rise in temperature can be suppressed.

The distances D1, D6, D11, D12a, D12b, D12c and D12d between the end surfaces of the battery blocks, to which no printed circuit board 21 is attached, and the opposed end surfaces of the casing 550 and the opposed opposite surfaces of the battery ECU 101, the service plug 530, the HV connector 520, and the contactor 102 are each smaller than the distance D3, D4 between the one surface 21A of the printed circuit board 21 and the opposed end surface of the casing 550. The distances D1, D6, and D11, and D12a, D12b, D12c, and D12d between the end surfaces of the battery blocks, to which no printed circuit board 21 is attached, and the opposed end surfaces of the casing 550 and the opposed opposite surfaces of the battery ECU 101, the service plug 530; the HV connector 520, and the contactor 102 are each smaller than the distance D2, D5 between the one surface 21A of the printed circuit board 21 and the opposed end surface of the battery block, to which no printed circuit board 21 is attached. This enables a minimum air passage required for the detection circuit 20 to dissipate heat can be efficiently ensured without increasing the capacity of the casing 550. These results enable space saving to be implemented, and improve the performance and the reliability of the battery system 500.

(19-b) Connection of Power Supply Line and Communication Line

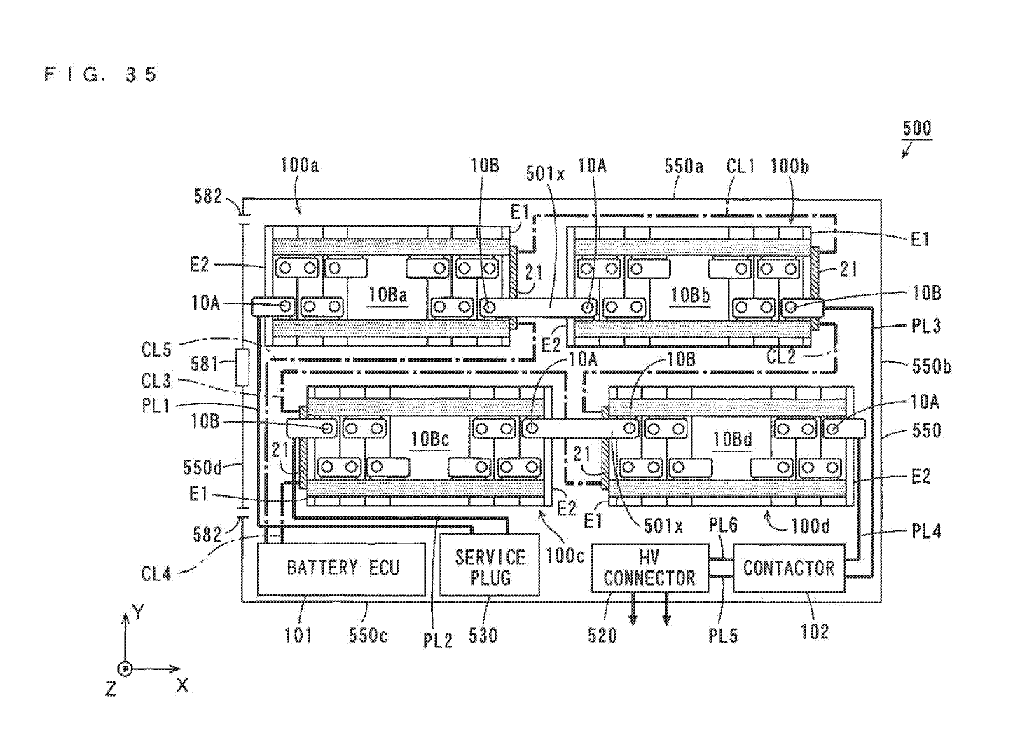

FIG. 35 is a schematic plan view for explaining a state of connection of power supply lines and communication lines in the fourteenth arrangement example illustrated in FIG. 34.

In the following description, a plus electrode 10a having the highest potential in each of the battery modules 100a to 100d is referred to as a high potential electrode 10A, and a minus electrode 10b having the lowest potential in each of the battery modules 100a to 100d is referred to as a low potential electrode 10B.

As illustrated in FIG. 35, in the battery modules 100a to 100d in this example, the low potential electrodes 10B are arranged in close proximity to end surfaces E1 of the battery blocks 10Ba to 10Bd, and the high potential electrodes 10A are arranged in dose proximity to end surfaces E2 of the battery blocks 10Ba to 10Bd, respectively.

The low potential electrode 10B in the battery module 100a and the high potential electrode 10A in the battery module 100b are connected to each other via a strip-shaped bus bar 501x. The high potential electrode 10A in the battery module 100c and the low potential electrode 10B in the battery module 100d are connected to each other via a strip-shaped bus bar 501x. The bus bar 501x corresponds to the power supply line 501 connecting the plurality of battery modules 100 illustrated in FIG. 1. The bus bar 501x may be replaced with, a connection member such as a harness or a lead wire.

The high potential electrode 10A in the battery module 100a is connected to the service plug 530 via a power supply line PL1, and the low potential electrode 10B in the battery module 100c is connected to the service plug 530 via a power supply line PL2. The power supply lines PL1 and PL2 correspond to the power supply line 501 connecting the plurality of battery modules 100 illustrated in FIG. 1. The battery modules 100a, 100b, 100c, and 100d are connected in series with the service plug 530 turned on. In this case, the high potential electrode 10A in the battery module 100d has the highest potential, and the low potential electrode 10B in the battery module 100b has the lowest potential.

The service plug 530 is turned off by a worker when the battery system 500 is maintained, for example. When the service plug 530 is turned off, a series circuit of the battery modules 100a and 100b and a series circuit of the battery modules 100c and 100d are electrically separated from each other. In this case, a current passage among the plurality of battery modules 100a to 100d is blocked. This ensures safety at the time of maintenance.

The low potential electrode 10B in the battery module 100b is connected to the contactor 102 via a power supply line P13, and the high potential electrode 10A in the battery module 100d is connected to the contactor 102 via a power supply line PL4. The contactor 102 is connected to the HV connector 520 via power supply lines PL5 and PL6. The HV connector 520 is connected to a load such as a motor of an electric vehicle.

The power supply lines PL3, PL4, PL5, and PL6 are used as the power supply line 501 illustrated in FIG. 1. In this example, both the power supply line PL3 connected to the minus electrode 10b (FIG. 4) having the lowest potential in each of the plurality of battery modules 100 and the power supply line PL4 connected to the plus electrode 10a (FIG. 4) having the highest potential of each of the plurality of battery modules 100 are connected to the contactor 102, unlike that in the battery modules 100 illustrated in FIG. 1.

With the contactor 102 turned on, the battery module 100b is connected to the HV connector 520 via the power supply lines PL3 and PL5, and the battery module 100d is connected to the HV connector 520 via the power supply lines PL4 and PL6. Thus, power is supplied to the load from the battery modules 100a, 100b, 1000, and 100d. With the contactor 102 turned on, the battery module 100a, 100b, 100c, and 100d are charged.

When the contactor 102 is turned off, connection between the battery module 100b and the HV connector 520 and connection between the battery module 100d and the HV connector 520 are cut off.

When the battery system 500 is maintained, the contactor 102, together with the service plug 530, is turned off by the worker. In this case, the current passage among the plurality of battery modules 100a to 100d is reliably blocked. This ensures safety at the time of maintenance. If voltages of the battery modules 100a, 100b, 100c, and 100d are equal to one another, a total voltage of a series circuit of the battery modules 100a and 100b and a total voltage of the series circuit of the battery modules 100c and 100d are equal to each other. Therefore, a high voltage is prevented from being generated in the battery system 500 at the time of maintenance.

A printed circuit board 21 in the battery module 100a and a printed circuit board 21 in the battery module 100b are connected to each other via a communication line CL1. The printed circuit board 21 in the battery module 100b and a printed circuit board 21 in the battery module 100d are connected to each other via a communication line CL2.

The printed circuit board 21 in the battery module 100d and a printed circuit board 21 in the battery module 100c are connected to each other via a communication line CL3. The printed circuit board 21 in the battery module 100c is connected to the battery ECU 101 via a communication line CL4, and the printed circuit board 21 in the battery module 100a is connected to the battery ECU 101 via a communication line CL5. The communication lines CL1 to CL5 correspond to the harness 560 illustrated in FIG. 1. The communication lines CL1 to CL5 constitute a bus.

Cell information detected by the detection circuit 20 in the battery module 100a is given to the battery ECU 101 via the communication lines CL1, CL2, CL3, and CL4. A predetermined control signal is fed to the printed circuit board 21 in the battery module 100b from the battery ECU 101 via the communication line CL5.

Cell information detected by the detection circuit 20 in the battery module 100b is given to the battery ECU 101 via the communication lines CL2, CL3, and CL4. A predetermined control signal is fed to the printed circuit board 21 in the battery module 100b from the battery ECU 101 via the communication lines CL5 and CL1.

Cell information detected by the detection circuit 20 in the battery module 100c is given to the battery ECU 101 via the communication line CL4. A predetermined control signal is fed to the printed circuit board 21 in the battery module 100c from the battery ECU 101 via the communication lines CL5, CL1, CL2, and CL3.

Cell information detected by the detection circuit 20 in the battery module 100d is given to the battery ECU 101 via the communication lines CL3 and CL4. A predetermined control signal is fed to the printed circuit board 21 in the battery module 100d from the battery ECU 101 via the communication lines CL5, CL1, and CU.

The communication line CL4 need not be provided, and the communication lines CL1, CU, CL3, and CL5 may constitute a bus. In this case, the cell information detected by the detection circuit 20 in the battery module 100a is given to the battery ECU 101 via the communication line CL5. A predetermined control signal is fed to the printed circuit, board 21 in the battery module 100a from the battery ECU 101 via the communication line CL5.

The cell information detected by the detection circuit 20 in the battery module 100b is given to the battery ECU 101 via the communication lines CL1 and CL5. A predetermined control signal is fed to the printed circuit board 21 in the battery module 100b from the battery ECU 101 via the communication lines CL5 and CL1.

The cell information detected by the detection circuit 20 in the battery module 100c is given to the battery ECU 101 via the communication lines CL3, CL2, CL1, and CL5. A predetermined control signal is fed to the printed circuit board 21 in the battery module 100c from the battery ECU 101 via the communication lines CL5, CL1, CL2, and CL3.

The cell information detected by the detection circuit 20 in the battery module 100d is given to the battery ECU 101 via the communication lines CL2, CL1, and CL5. A predetermined control signal is fed to the printed circuit board 21 in the battery module 100d from the battery ECU 101 via the communication lines CL5, CL1, and CL2.

(20) Another Arrangement Example in Casing in First Embodiment

While in the first to fourteenth arrangement examples, the printed circuit board 21 is attached to the end surface E1 of the battery block 10Ba to 10Bd, the printed circuit board 21 may be attached to either one of the end surfaces E3 and E4 of the battery block 10Ba to 10Bd. In this case, the battery blocks 10Ba to 10Bd are also positioned so that a distance between the end surfaces to which the printed circuit boards 21 are attached, is greater than a distance between the end surfaces to which no printed circuit board 21 is attached, so that a similar effect to the above-mentioned effect can be obtained.

### [2] Second Embodiment

A battery system 500 according to a second embodiment will be described while referring to differences from the battery system 500 according to the first embodiment.

(1) Configuration of Battery Module

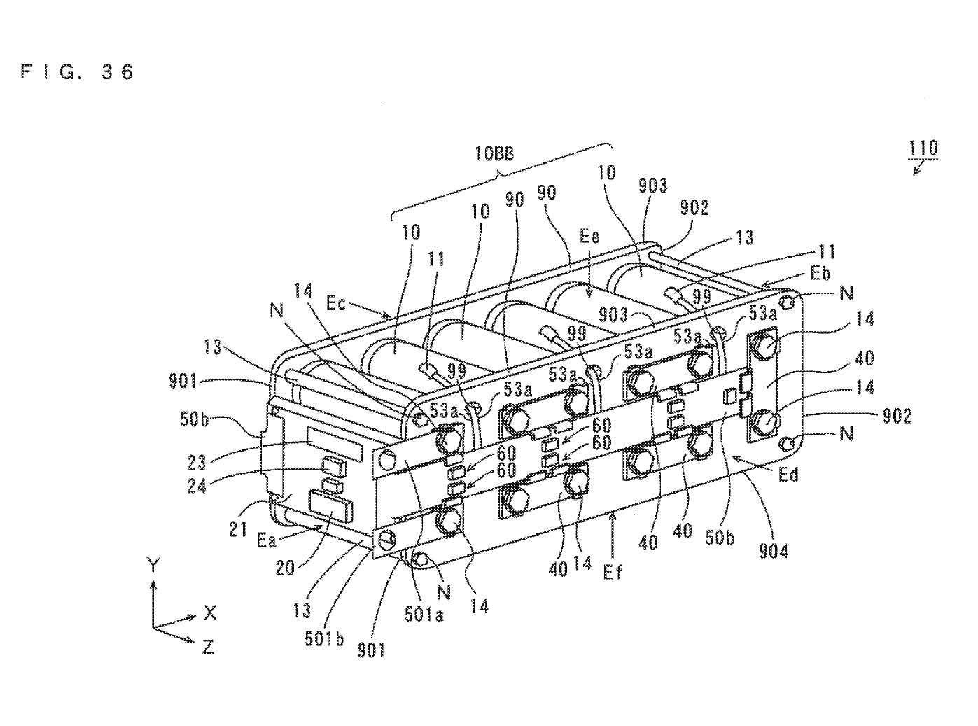

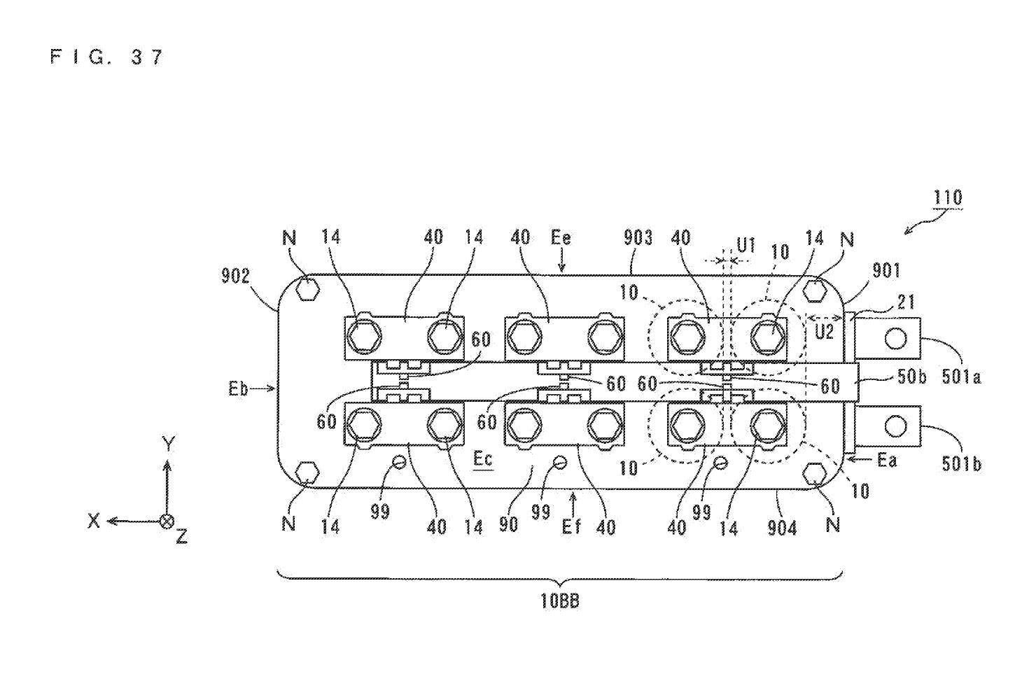

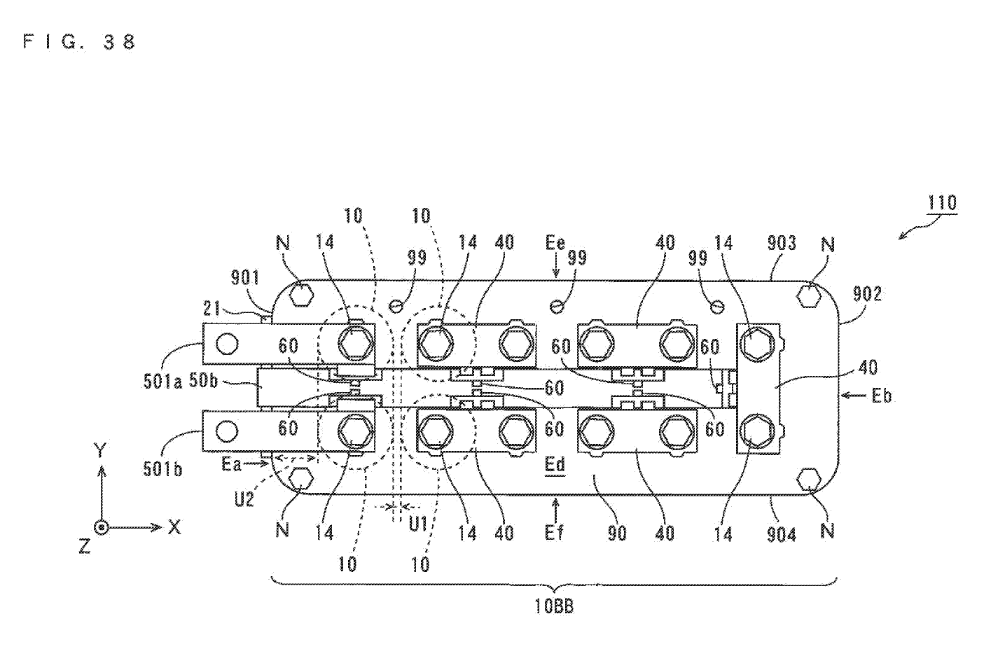

FIG. 36 is an external perspective view, illustrating a battery module 110 according to the second embodiment, FIG. 37 illustrates one side surface of the battery module 110 illustrated in FIG. 36, and FIG. 38 illustrates the other side surface of the battery module 110 illustrated in FIG. 36. In description illustrated in FIGS. 36 to 38, an X-direction and a Z-direction are, parallel to a horizontal plane, and a Y-direction is perpendicular to the horizontal plane.

As illustrated in FIGS. 36 to 38, the battery module 110 includes a battery block 10BB, a printed circuit board 21, thermistors 11, and FPC boards 50b. The printed circuit board 21 is provided with a detection circuit 20, a communication circuit 24, and a connector 23.

The battery block 10BB mainly includes a plurality of cylindrical battery cells 10, and a pair of battery holders 90 that holds the plurality of battery cells 10. Each of the battery cells 10 has a cylindrical outer shape having opposed end surfaces (a so-called columnar shape). A plus electrode is formed on one of the end surfaces of the battery cell 10, and a minus electrode is formed on the other end surface of the battery cell 10.

The plurality of, battery cells 10 are arranged in parallel so that their axial centers are parallel to one another. In the example illustrated in FIGS. 36 to 38, the axial center of each of the battery cells 10 is parallel to the Z-direction. Half (six in this example) of the plurality of battery cells 10 are arranged on an upper stage, and the remaining half (six in this example) of the battery cells 10 are arranged on a lower stage.

The plurality of battery cells 10 are arranged on the upper stage and the lower stage so that a positional relationship between the plus electrode and the minus electrode of each of the battery cells 10 is opposite to that of the adjacent battery cell 10. Thus, the plus electrode and the minus electrode of one of the two adjacent battery cells 10 are respectively adjacent to the minus electrode and the plus electrode of the other battery cell 10.

The battery holder 90 is composed of a substantially rectangular plate-shaped member made of resin, for example. The battery holder 90 has one surface and the other surface. The one surface and the other surface of the battery holder 90 are referred to as an outer surface and an inner surface, respectively. The pair of battery holders 90 is arranged so that the plurality of battery cells 10 are sandwiched therebetween. In this case, the one battery holder 90 is opposed to one end surface of each of the battery cells 10, and the other battery holder 90 is opposed to the other end surface of the battery cell 10.

Holes are formed at four corners of the battery holder 90, and both ends of stick-shaped fastening members 13 are respectively inserted into the holes. Male threads are formed at both ends of each of the fastening members 13. The plurality of battery cells 10 and the pair of battery holders 90 are integrally fixed by attaching nuts N to the ends of the fastening members 13. In the battery holder 99, three holes 99 are equally spaced in its longitudinal direction. Conductor lines 53a, described below, are inserted through the holes 99, respectively. The longitudinal direction of the battery holder 90 is parallel to the X-direction in this example.

Each of the battery holders 90 has a first end surface 901 and a second end surface 902 along its short side, and has a third end surface 9D3 and a fourth end surface 904 along its long side.

Consider a virtual rectangular parallelepiped surrounding the battery block 10BB. Out of six virtual planes of the rectangular parallelepiped, the virtual plane that faces outer peripheral surfaces of the battery cells 10 respectively positioned on the upper stage and the lower stage at its one end in the X-direction and contacts the first end surface 901 of each of the battery holders 90 is referred to as an end surface Ea of the battery block 10BB, and the virtual plane that faces outer peripheral surfaces of the battery cells 10 respectively positioned on the upper stage and the lower stage at the other end in the X-direction and contacts the second end surface 902 of each of the battery holders 90 is referred to as an end surface Eb of the battery block 10BB.

Out of the six virtual planes of the rectangular parallelepiped, the virtual plane that faces one end surfaces in the Z-direction of the plurality of battery cells 10 is referred to as an end surface Ec of the battery block 10BB, and the virtual plane that faces the other end surfaces in the Z-direction of the plurality of battery cells 10 is referred to as an end surface Ed of the battery block 10BB.

Furthermore, out of the six virtual planes of the rectangular parallelepiped, the virtual plane that faces outer peripheral surfaces of the plurality of battery cells 10 on the upper stage and contacts the third end surface 9D3 of each of the battery holders 90 is referred to as an end surface Ee of the battery block 10BB, and the virtual plane that faces outer peripheral surfaces of the plurality of battery cells 10 on the lower stage and contacts the fourth end surface 904 of each of the battery holders 90 is referred to as an end surface Ef of the battery block 10BB.

The end surfaces Ea and Eb of the battery block 10BB are perpendicular to a direction in which the plurality of battery cells 10 on the upper or lower stage are arranged (X-direction). More specifically, the end surfaces Ea and Eb of the battery block 10BB are parallel to a Y-Z plane and opposed to each other. The end surfaces Ec and Ed of the battery block 10BB are perpendicular to an axial direction of each of the battery cells 10 (Z-direction). More specifically, the end surfaces Ec and Ed of the battery block 10BB are parallel to an X-Y plane and opposed to each other. The end surfaces Ee and Ef of the battery block 10BB are parallel to the direction in which the plurality of battery cells 10 on the upper or lower stage are arranged (X-direction) and the axial direction of each of the battery cells 10 (Z-direction). More specifically, the end surfaces Ee and Ef of the battery block 10BB are parallel to an X-Z plane and opposed to each other.

One of the plus electrode and the minus electrode of each of the battery cells 10 is arranged at the end surface Ec of the battery block 10BB, and the other electrode is arranged at the end surface Ed of the battery block 10BB.

In the battery block 10BB, the plurality of battery cells 10 are connected in series with the plurality of bus bars 40 and hexagon head bolts 14. More specifically, a plurality of holes corresponding to the plurality of battery cells 10 on the upper stage and the lower stage are formed in each of the battery holders 90. The plus electrode and the minus electrode of each of the battery cells 10 are fitted in the corresponding holes formed in the pair of battery holders 90. Thus, the plus electrode and the minus electrode of each of the battery cells 10 project from outer surfaces of the pair of battery holders 90.

With the plurality of battery cells 10 fixed by the pair of battery holders 90, a gap U1 is formed in a direction in which they line up (X-direction) between the two adjacent battery cells 10 on the upper stage, and a gap. U1 is also formed in a direction in which they line up (X-direction) between the two adjacent battery cells 10 in the lower stage. In this case, the gap U1 between the two battery cells 10 functions as an air passage in the battery block 10BB. Therefore, cooling air is caused to flow in the gap U1 between the two battery cells 10 so that each of the battery cells 10 can efficiently dissipate heat.

As described above, in the battery block 10BB, the battery cells 10 are arranged so that a positional relationship between the plus electrode and the minus electrode of each of the battery cells 10 is opposite to that of the adjacent battery cell 10. Therefore, in the two adjacent battery cells 10, the plus electrode of one of the battery cells 10 is adjacent to the minus electrode of the other battery cell 10, and the minus electrode of the one battery cell 10 is adjacent to the plus electrode of the other battery cell 10. In this state, a bus bar 40 is attached to the plus electrode and the minus electrode in close proximity to each other so that the plurality of battery cells 10 are connected in series.

In the following description, out of the six battery cells 10 arranged on the upper stage of the battery block 10BB, the closest battery cell 10 to the end surface Ea to the closest battery cell 10 to the end surface Eb are referred to as first to sixth battery cells 10. Out of the six battery cells 10 arranged on the lower stage of the battery block 10BB, the closest battery cell 10 to the end surface Eb to the closest battery cell 10 to the end surface Ea are referred to as seventh to twelfth battery cells 10.

In this case, the common bus bar 40 is attached to the minus electrode of the first battery cell 10 and the plus electrode of the second battery cell 10. The common bus bar 40 is attached to the minus electrode of the second battery cell 10 and the plus electrode of the third battery cell 10. Similarly, the common bus bar 40 is attached to the minus electrode of each of the odd-numbered battery cells 10 and the plus electrode of the even-numbered battery cell 10 adjacent thereto. The common bus bar 40 is attached to the minus electrode of each of the even-numbered battery cells 10 and the plus electrode of the odd-numbered battery cell 10 adjacent thereto.

One end of a bus bar 501a for supplying power to the exterior is attached as the power supply line 501 illustrated in FIG. 1 to the plus electrode of the first battery cell 10. One end of a bus bar 501b for supplying power to the exterior is attached as the power supply line 501 illustrated in FIG. 1 to the minus electrode of the twelfth battery cell 10. The other ends of the bus bars 501a and 501b are pulled out in the direction in which the plurality of battery cells 10 line up (X-direction).

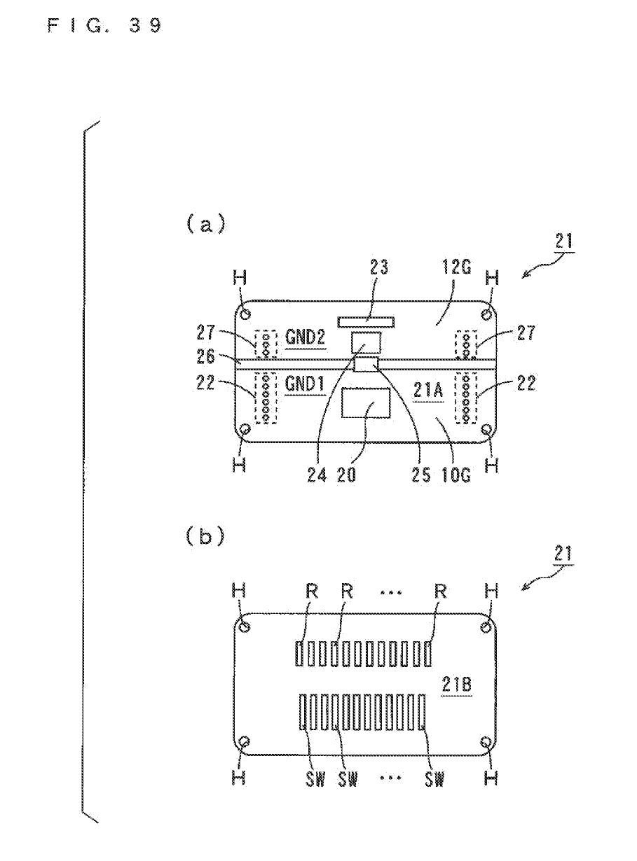

The printed circuit board 21 including the detection circuit 20, the communication circuit 24, and the connector 23 is attached to the end surface Ea of the battery block 10BB. The long FPC board 50b extends from the end surface Ec to the end surface Ea of the battery block 10BB. The long FPC board 50b extends from the end surface Ed to the end surface Ea of the battery block 1088. The FPC boards 50a have a substantially similar configuration to that of the FPC board 50 illustrated in FIG. 9 except that it further includes a conductor fine (not illustrated) for connecting a plurality of thermistors 11 and connection terminals 27 (see FIG. 39, described below) in the printed circuit board 21. On the FPC board 50b, PTC elements 60 are arranged in close proximity to the plurality of bus bars 40, 501a, and 501b, respectively.

As illustrated in FIG. 37, the one FPC board 50b extends in a direction in which the plurality of battery cells 10 line up (X-direction) at the center on the end surface Ec of the battery block 10BB. The FPC board 50b is connected in common to the plurality of bus bars 40. As illustrated in FIG. 38, the other FPC board 50b extends in a direction in which the plurality of battery cells 10 line up (X-direction) at the center on the end surface Ed of the battery block 10BB. The FPC board 50b is connected in common to the plurality of bus bars 40, 501a, and 501b.

The FPC board 50b on the end surface Ec of the battery block 10BB is bent at a right angle at one end of the end surface Ec of the battery block 10BB toward the end surface Ea thereof and connected to the printed circuit board 21. The FPC board 50b on the end surface Ed of the battery block 10BB is bent at a right angle at one end of the end surface Ed of the battery block 10BB toward the end surface Ea thereof and connected to the printed circuit board 21.

The thermistors 11 are connected to conductor lines provided in the FPC boards 50b via the conductor lines 53a, respectively. The bus bars 40, 40a and the thermistors 11 in the battery module 110 are electrically connected to the printed circuit boards 21 via the conductor lines formed in the FPC boards 50b, respectively.

(2) One Configuration Example of Printed Circuit Board

FIG. 39 is a schematic plan view illustrating one configuration example of the printed circuit board 21 in the second embodiment. The printed circuit board 21 has a substantially rectangular shape, and has one surface 21A and the other surface 21B. FIGS. 39 (a) and 39 (b) respectively illustrate one surface 21A and the other surface 21B of the printed circuit board 21, respectively. Holes H are respectively formed at four corners of the printed circuit board 21.

As illustrated in FIG. 39 (a), the printed circuit board 21 includes a first mounting region 10G, a second mounting region 12G, and a strip-shaped insulating region 26 on the one surface 21A.

The second mounting region 12G is formed in an upper part of the printed circuit board 21. The insulating region 26 extends along the second mounting region 12G. The first mounting region 100 is formed in the remaining portion of the printed circuit board 21. The first mounting region 10G and the second mounting region 12G are separated from each other by the insulating region 26. Thus, the first mounting region 10G and the second mounting region 12G are electrically insulated from each other by the insulating region 26.

A detection circuit 20 is mounted on the first mounting region 10G while two sets of connection terminals 22 are formed therein. The detection circuit 20 and the connection terminals 22 are electrically connected to each other by connection lines on the printed circuit board 21. A plurality of battery cells 10 (see FIG. 36) in the battery module 110 are connected to the detection circuit 20 as power to the detection circuit 20. A ground pattern GND1 is formed in the first mounting region 100 excluding a mounting region of the detection circuit 20, a formation region of the connection terminals 22, and a formation region of the connection lines. The ground pattern GND1 is held at a base potential of the battery module 110.

A communication circuit 24 is mounted on the second mounting region 12G while a connector 23 and two sets of connection terminals 27 are formed therein. The communication circuit 24 is electrically connected to the connector 23 and the connection terminals 27 by connection lines on the printed circuit board 21. The harness 560 illustrated in FIG. 1 for performing communication between a plurality of battery cells 110 and the battery ECU 101 illustrated in FIG. 1 is connected to the connector 23. The non-driving battery 12 (see FIG. 1) included in the electric vehicle is connected to the communication circuit 24 as power to the communication circuit 24. A ground pattern GND2 is formed in the second mounting region 12G excluding a mounting region of the communication circuit 24, a formation region of the connector 23, a formation region of the connection terminals 27, and a formation region of the connection lines. The ground pattern GND2 is formed in the second mounting region 12G. The ground pattern GND2 is held at a reference potential of the non-driving battery 12.

An insulating element 25 is mounted to cross the insulating region 26. The insulating element 25 transmits a signal between the detection circuit 20 and the communication circuit 24 while electrically insulating the ground pattern GND1 and the ground pattern GND2.

The two FPC boards 50b (see FIG. 36) are connected to the two sets of connection terminals 22, 27 in the printed circuit board 21. The FPC board 50b is provided with a plurality of conductor lines. The bus bars 40, 501a, and 501b and the connection terminals 22 in the printed circuit board 21 are connected to each other via the plurality of conductor lines provided in the FPC board 50b. Thus, the detection circuit 20 detects respective voltages of the battery cells 10 (see FIG. 36) via the bus bars 40, 501a, and 501b, the conductor lines provided in the FPC board 50b, and the connection terminals 22.

Similarly, the conductor lines 53a connected to the thermistors 11 and the connection terminals 27 in the printed circuit board 21 are connected to each other via the plurality of conductor lines provided in the FPC board 50b. Thus, signals output from the thermistors 11 are fed to the communication circuit 24 via the conductor lines 53a, the conductor lines provided in the FPC board 50b, and the connection terminals 27. Thus, the communication circuit 24 acquires a temperature of each of the battery modules.

As illustrated in FIG. 39 (b), a plurality of registers R and a plurality of switching elements SW are mounted on the other surface 21B of the printed circuit board 21. The plurality of resistors R and the plurality of switching elements SW constitute a plurality of equalization circuits. Thus, heat generated from the resistor R can efficiently dissipate heat. Heat generated from the resistor R can be prevented from being conducted to the detection circuit 20 and the communication circuit 24. The result can prevent malfunction and deterioration due to heat generated from the detection circuit 20 and the communication circuit 24.

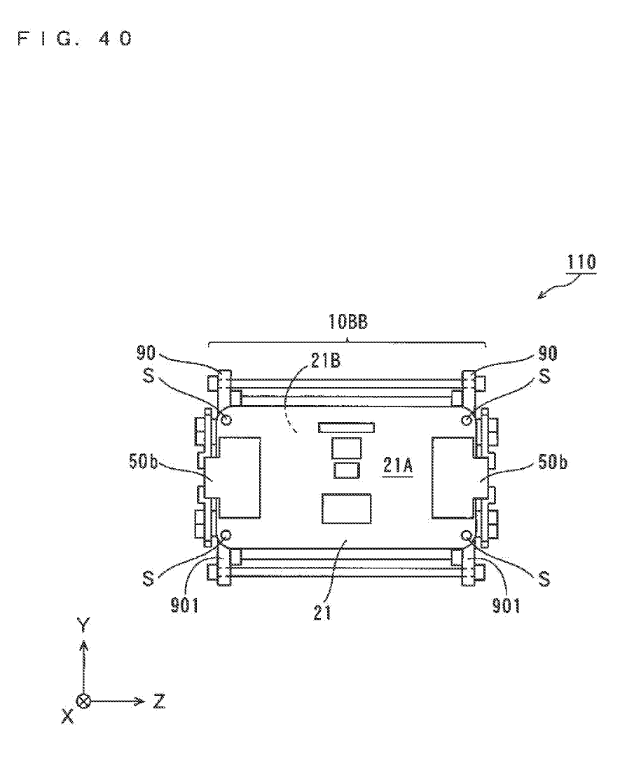

FIG. 40 is a side view illustrating a state where the printed circuit board 21 is attached to the battery block 10BB illustrated in FIG. 36. As illustrated in FIG. 40, screws S are respectively inserted through the holes H (see FIG. 39) in the printed circuit board 21. In this state, the screws S are respectively screwed into threaded holes formed on the first end surfaces 901 of the pair of battery holders 90 so that the printed circuit board 21 is attached to the end surface Ea of the battery block 10BB.

In this state, the other surface 21B of the printed circuit board 21 is opposed to the end surface Ea of the battery block 10BB illustrated in FIGS. 36 and 37, and the one surface 21A of the printed circuit board 21 is positioned on the opposite side to the battery block 10BB. In the present embodiment, the one surface 21A of the printed circuit board 21 also refers to a surface of a region excluding mounting components.

With the printed circuit board 21 attached to the battery block 10BB, as described above, a gap U2 (see FIGS. 37 and 38) is formed between the other surface 21B of the printed circuit board 21 and the outer peripheral surface of the battery cell 10 opposed to the other surface 21B. In this case, in the battery module 110, the gap U2 (see FIGS. 37 and 38) functions as an air passage. Therefore, cooling air is caused to flow in the gap U2 between the printed circuit board 21 and the battery cell 10 so that the printed circuit board 21 can efficiently dissipate heat.

(3) Casing that Houses Battery Module

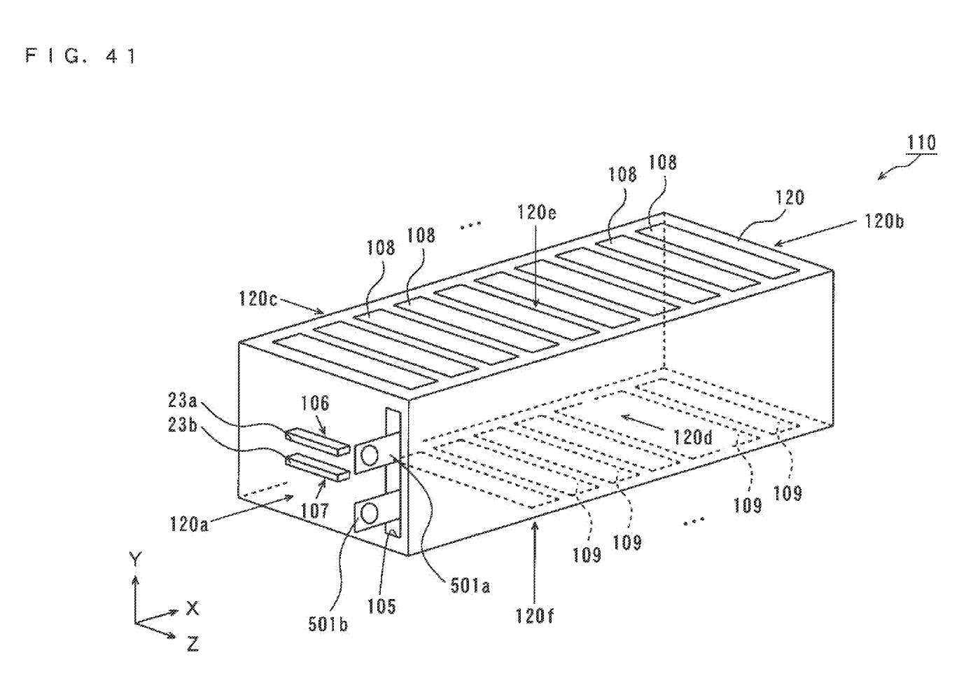

FIG. 41 is an external perspective view of the battery module 110 housed in a casing. In the present embodiment, each of the plurality of battery modules 110 composing the battery system 500 is housed in the casing, as illustrated in FIG. 41. The casing that houses the battery module 110 prevents a short from occurring among the plurality of battery cells 10 when the battery module 110 is conveyed and when connection work is performed. In the following description, the casing that houses each of the battery modules 110 is referred to as a module casing 120.

The module casing 120 has a rectangular parallelepiped shape including six sidewalls 120a, 120b, 120c, 120d, 120e, and 120f. Inner surfaces of the sidewalls 120a to 120f of the module casing 120 are respectively opposed to end surfaces Ea to Ef (see FIG. 36) of the battery block 10BB.

On the sidewall 120a of the module casing 120, an opening 105 in a rectangular shape extending upward and downward is formed in the vicinity of the sidewall 120d. Two bus bars 501a and 501b are pulled out of the module casing 120 via the opening 105.

In a substantial central part of the sidewall 120a of the module casing 120, openings 106 and 107 for connecting the harness 560 (FIG. 1) to the connector 23 in the printed circuit board 21 within the module casing 120.

An input connector 23a having a plurality of input terminals for receiving signals and an output connector 23b having a plurality of output terminals for sending signals may be connected to the connector 23 in the printed circuit board 21 via a harness. In this case, the input connector 23a and the output connector 23b are respectively fitted in the openings 106 and 107 from within the module casing 120. Thus, the input connector 23a and the output connector 23b are fixed in a state of projecting toward the outside of the module casing 120.

On the sidewall 120e of the module casing 120, a plurality of rectangular slits 108 extending in an axial direction (Y-direction) of the plurality of battery cells 10 (see FIG. 36) line up in a direction in which the plurality of battery cells 10 line up (X-direction). On the sidewall 1201 of the module casing 120, a plurality of rectangular slits 109 extending in an axial direction (Z-direction) of the plurality of battery cells 10 line up in the direction in which the plurality of battery cells 10 line up (X-direction). Cooling air can flow into and out of the module casing 120 through the slits 108 and 109.

(4) First Arrangement Example in Casing in Second Embodiment

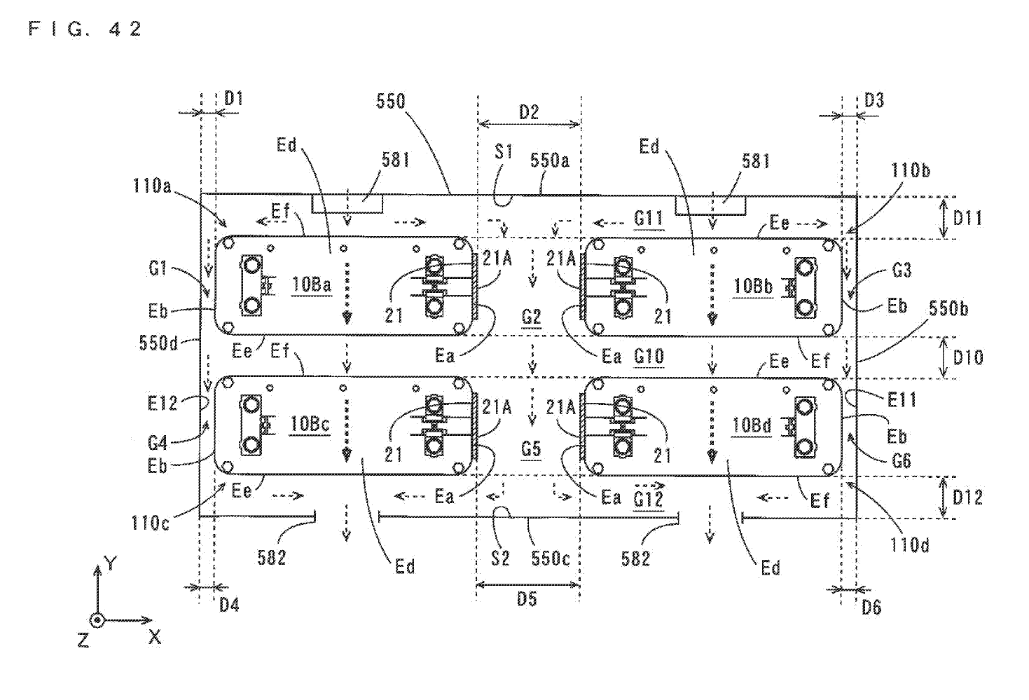

In the present embodiment, a battery system 500 also includes a casing 550 that houses a plurality of battery modules 110. FIG. 42 is a schematic plan view illustrating a first arrangement example of the plurality of battery modules 100 housed in the casing 660 in the second embodiment. As illustrated in FIG. 42, in the battery system 500 in this example, the four battery modules 110 are provided in the casing 550, and a contactor 102 and a battery ECU 101 are not provided in the casing 550, as in the battery system 500 illustrated in FIG. 1.

In the following description, four battery modules 100 included in the battery system 500 are hereinafter referred to as battery modules 100a, 100b, 100c, and 100d, respectively. Battery blocks 10BB included in the battery modules 100a, 100b, 100c, and 100d are referred to as battery blocks 10Ba, 10Bb, 10Bc, and 10Bd, respectively.

In FIG. 42, the illustration of the module casing 120 illustrated in FIG. 41 is omitted. In the present embodiment, when the plurality of battery modules 110a to 110d are provided in the casing 550 in the battery system 500, the module casing 120 need not be provided.

The casing 550 illustrated in FIG. 42 has sidewalls 550a, 550b, 550c, and 550d, simultaneously to the casing 550 (see FIG. 12) in the first embodiment. The sidewalls 550a and 550c are parallel to each other, and the sidewalls 550b and 550d are parallel to each other and perpendicular to the sidewalls 550a and 650c. The sidewall 550b has an end surface E11 on its inner side, and the sidewall 550d has an end surface E12 on its inner side. The end surface E11 of the sidewall 550b and the end surface E12 of the sidewall 550d are opposed to each other. The sidewall 550a has an end surface S1 on its inner side, and the sidewall 550c has an end surface S2 on its inner side. The end surface S1 of the sidewall 550a and the end surface S2 of the sidewall 550c are opposed to each other.

In the casing 550, the four battery modules 100a to 100d are arranged in two rows and two columns at spacings, described below. In this example, end surfaces Ed of the four battery modules 100a to 100d are directed upward.

End surfaces Ea of the battery blocks 10Ba and 10Bc are directed toward the sidewall 550b. End surfaces Ea of the battery blocks 10Bb and 10Bd are directed toward the sidewall 550d. A printed circuit board 21 is provided on each of the end surfaces Ea of the battery blocks 10Ba to 10Bd. Thus, the end surfaces Ea of the battery blocks 10Ba and 10Bb provided with the printed circuit boards 21 are opposed to each other, and the end surfaces Ea of the battery blocks 10Bc and 10Bd provided with the circuit boards 21 are opposed to each other.

In this state, one surface 21A of the printed circuit board 21 provided in the battery block 10Ba and opposed one surface 21A of the printed circuit board 21 provided in the battery block 10Bb are spaced a distance D2 apart from each other. Thus, a gap G2 is formed between the one surface 21A of the printed circuit board 21 provided in the battery block 10Ba and the one surface 21A of the printed circuit board 21 provided in the battery block 10Bb.

One surface 21A of the printed circuit board 21 provided in the battery, block 10Bc and opposed one surface 21A of the printed circuit board 21 provided in the battery block 10Bd are spaced a distance D5 apart from each other. Thus, a gap G5 is formed between the one surface 21A of the printed circuit board 21 provided in the battery block 10Bc and the one surface 21A of the printed circuit board 21 provided in the battery block 10Bd.

The end surface E12 of the casing 660 and an end surface Eb of the battery block 10Ba, which is opposed to the end surface E12, are spaced a distance D1 apart from each other. Thus, a gap G1 is formed between the end surface. E12 of the casing 550 and the end surface Eb of the battery block 10BB.

The end surface E11 of the casing 550 and an end surface Eb of the battery block 10Bb, which is opposed to the end surface E11, are spaced a distance D3 apart from each other. Thus, a gap G3 is formed between the end surface E11 of the casing 550 and the end surface Eb of the battery block 10Bb.

The end surface E12 of the casing 550 and an end surface Eb of the battery block 10Bc, which is opposed to the end surface E12, are spaced a distance D4 apart from each other. Thus, a gap G4 is formed between the end surface E12 of the casing 550 and the end surface Eb of the battery block 10Bc.

The end surface E11 of the casing 550 and an end surface Eb of the battery block 10Bd, which is opposed to the end surface E11, are spaced a distance D6 apart from each other. Thus, a gap G6 is formed between the end surface E11 of the casing 550 and the end surface Eb of the battery block 10Bd.

End, surfaces Ee and Ef of the battery blocks 10Ba and 10Bb and end surfaces Ef and Ee of the battery blocks 10Bc and 10Bd, which are respectively opposed to the end surfaces Ee and Ef, are spaced a distance D10 apart from each other. Thus, a gap G10 is formed between the battery block 10Ba, 10Bb and the battery block 10Bc, 10Bd.

The end surface S1 of the casing 550 and end surfaces Ef and Ee of the battery blocks 10Ba and 10Bb, which are opposed to the end surface S1, are spaced a distance D11 apart from each other. Thus, a gap G11 is formed between the end surface S1 of the casing 550 and the battery block 10Ba, 10Bb.

The end surface S2 of the casing 550 and end surfaces Ee and Ef of the battery blocks 10Bc and 10Bd, which are opposed to the end surface S2, are spaced a distance D12 apart from each other. Thus, a gap G12 is formed between the end surface S2 of the casing 550 and the battery block 10Bc, 10Bd. In this example, the battery blocks 10Ba to 10Bd are positioned so that the gaps G1 to G6 and G10 to G12 are formed in the casing 550.

Two cooling fans 581 are provided on the sidewall 550a. The two cooling fans 581 are respectively opposed to the end surfaces Ef and Ee of the battery blocks 10Ba and 10Bb in the Y-direction. Two exhaust ports 582 are formed on the sidewall 550c. The two exhaust ports 582 are respectively opposed to the end surfaces Ee and Ef of the battery blocks 10Bc and 10Bd in the Y-direction. The gaps G1 to G6 and G10 to G12 function as air passages (see arrows indicated by a dotted line in FIG. 42), as in the first embodiment. When the cooling fans 581 operate, the flow of air is formed in the gaps G1 to G6 and G10 to G12.

In the battery system 500 in this example, the distance D2, D5 between the one surfaces 21A of the two printed circuit boards 21, which are opposed to each other, is greater than the distance D10 between the pair of end surfaces of the battery blocks, to which no printed circuit board 21 is attached. A sufficient air passage is thus ensured along the one surface 21A of the printed circuit board 21 in the gap G2, G5.

This enables the detection circuit 20 that generates heat to be sufficiently cooled by the flow of air, thereby enabling a rise in temperature of the battery system 500 to be suppressed. As a result, output limitation, deterioration, and reduction in life of the battery system 500 due to the rise in temperature can be suppressed.

In this example, the distance D10 between the pair of end surfaces of the battery blocks, to which no printed circuit board 21 is attached, is smaller than the distance D2, D5 between the one surfaces 21A of the two printed circuit board 21, which are opposed to each other. This enables a minimum air passage required for the detection circuit 20 to dissipate heat to be efficiently ensured without increasing the capacity of the casing 550. These results enable space saving to be implemented.

In this example, at least one of the distances D2 to D5 between the one surfaces 21A of the two printed circuit boards 21 may be greater than the distance D10 between the end surfaces to which no printed circuit board 21 is attached. In this case, a portion that satisfies this relationship exists in the casing 550, thereby making space saving as well as improvements in the performance and the reliability of the battery system 500 feasible.

Furthermore, the distances D2 to D5 are each preferably greater than the greatest one of the distances D1, D3, D4, D6, and D10 to D12. In this case, further space saving can be implemented while the performance and the reliability of the battery system 500 are further improved.

As described above, in each of the battery blocks 10Ba to 10Bd, the gap U1 (FIGS. 37 and 38) is formed between the two battery cells 10 that are adjacent to each other in the X-direction. The gap U2 (FIGS. 36 and 37) is formed between the other surface 21B of the printed circuit board 21 and the outer peripheral surface of the battery cell 10, which is opposed to the other surface 21B.

When the cooling fans 581 operate, therefore, the flow of air is also formed in the gap U1 between the adjacent battery cells 10 and the gap U2 between the other surface 21B of the printed circuit board 21 and the outer peripheral surface of the battery, cell 10, which is opposed to the other surface 218, as indicated by a thick dotted line in FIG. 42. Therefore, each of the battery cells 10 that generate heat and the printed circuit board 21 can be cooled by the flow of air in the Y-direction so that the battery system 500 can be inhibited from rising in temperature.

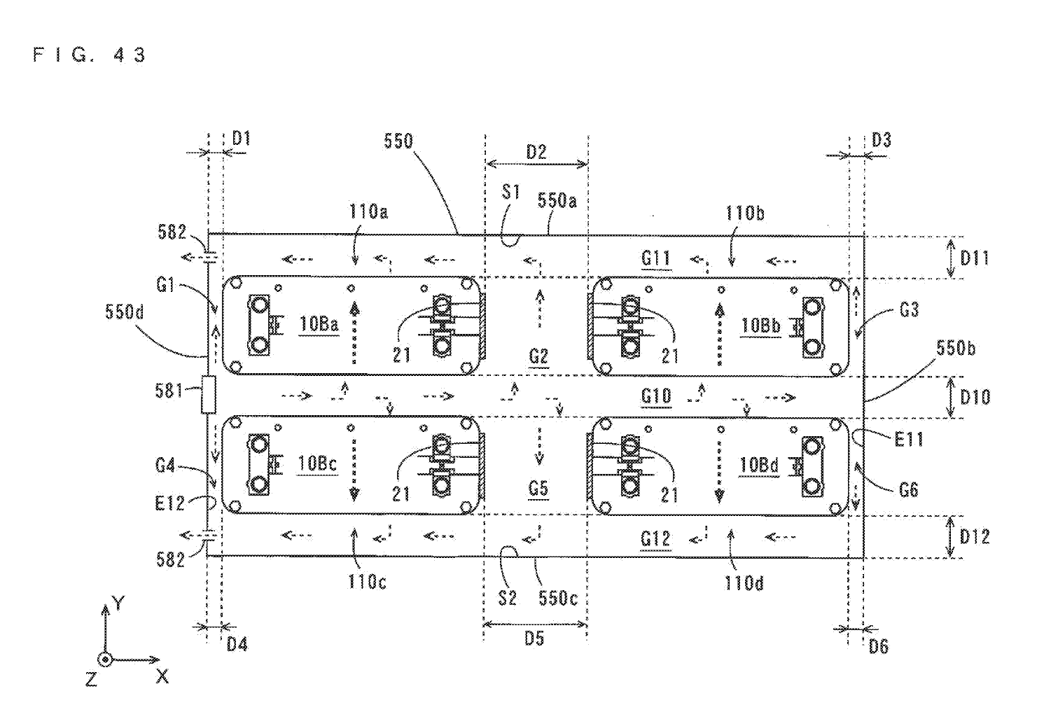

FIG. 43 is a schematic plan view for explaining the flow of air when a cooling fan 581 and exhaust ports 582 are provided on the one sidewall 550d in the first arrangement example in the second embodiment. As illustrated in FIG. 43, the cooling fan 581 may be provided at the center of the sidewall 550d, and the exhaust ports 582 may be respectively formed in the vicinities of both ends of the sidewall 550d instead of providing the two cooling fans 581 on the sidewall 550a and providing the two cooling fans 581 on the sidewall 550c. In this case, the cooling fan 581 also operates so that the flow of air is formed in the gaps G1 to G6 and G10 to G12.

(5) Second Arrangement Example in Casing in Second Embodiment

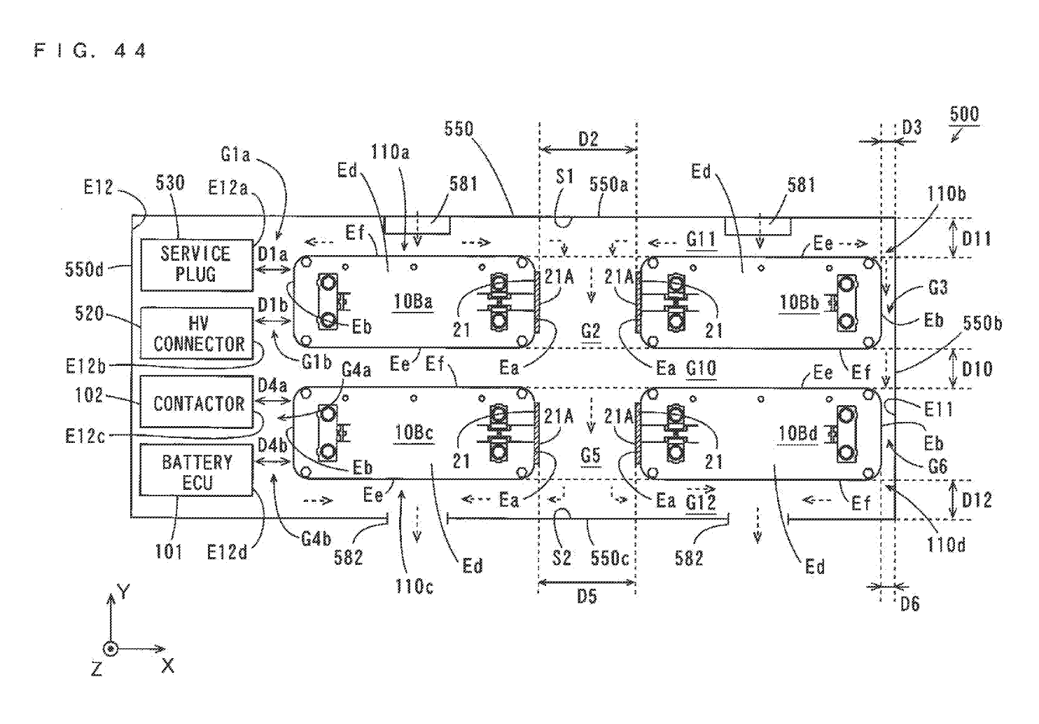

FIG. 44 is a schematic plan view illustrating a second arrangement example of the plurality of battery modules 100 housed in the casing 550 in the second embodiment. The second arrangement example illustrated in FIG. 44 will be described while referring to differences from the first arrangement example illustrated in FIG. 42.

(5-a) Arrangement of Components

As illustrated in FIG. 44, a battery system 500 in this example includes four battery modules 110, a battery ECU 101, a contactor 102, an HV connector 520, and a service plug 530, similarly to the battery system 500 illustrated in FIG. 33. In this example, the battery ECU 101 illustrated in FIG. 1, the contactor 102 illustrated in FIG. 1, an HV connector 520, and a service plug 530, together with the plurality of battery modules 100, are also housed in the casing 550. In this example, the module casing 120 illustrated in FIG. 41 is not provided. In this example, the casing 550 illustrated in FIG. 42 is used as a casing that houses the battery system 500.

The service plug 530, the HV connector 520, the contactor 102, and the battery ECU 101 line up from a sidewall 550a to a sidewall 550c in this order and are in close proximity to an end surface E12 in a region between a battery block 10Ba, 10Bc and a sidewall 550d in the X-direction. The service plug 530 and the HV connector 520 are positioned between the battery block 10Ba and the sidewall 550d, and the contactor 102 and the battery ECU 101 are positioned between the battery block 10Bc and the sidewall 550d.

Consider four virtual planes that respectively contact the service plug 530, the HV connector 520, the contactor 102, and the battery ECU 101 and are parallel to a Y-Z plane.

The virtual plane that contacts a closest portion of the service plug 530 to an end surface Eb of the battery block 10Ba is referred to as an end surface E12a, and the virtual plane that contacts a closest portion of the HV connector 520 to an end surface Eb of the battery block 10Ba is referred to as an opposite surface E12b.

The virtual plane that contacts a closest portion of the contactor 102 to an end surface Eb of the battery block 10Bc is referred to as an opposite surface E12c, and the virtual plane that contacts a closest portion of the battery ECU 101 to the end surface Eb of the battery block 10Bc is referred to as an opposite surface E12d.

In this case, in the casing 550, an opposite surface E12a of the service plug 530 and an end surface Eb of the battery block 10Ba are spaced a distance D1a apart from each other. Thus, a gap G1a is formed between the opposite surface E12a of the service plug 530 and the end surface Eb of the battery block 10Ba.

An opposite surface E12b of the HV connector 520 and the end surface Eb of the battery block 10Ba are spaced a distance D1b apart from each other. Thus, a gap G1b is formed between the opposite surface E12b of the HV connector 520 and the end surface Eb of the battery block 10Ba.

An opposite surface E12c of the contactor 102 and an end surface Eb of the battery block 10Bc are spaced a distance D4a apart from each other. Thus, a gap G4a is formed between the opposite surface E12c of the contactor 102 and the end surface Eb of the battery block 10Bc.

An opposite surface E12d of the battery ECU 101 and the end surface Eb of the battery block 10Bc are spaced a distance D4b apart from each other. Thus, a gap G4b is formed between the opposite surface E12d of the battery ECU 101 and an end surface Eb of the battery block 10Bb.

In this example, the distance D2, D5 between one surfaces 21A of two printed circuit boards 21, which are opposed to each other, is greater than the distance D10 between a pair of end surfaces of the battery blocks, to which no printed circuit board 21 is attached. This makes space saving feasible while suppressing output limitation, deterioration, and reduction in life of the battery system 500 due to a rise in temperature.

At least one of the distances D2 and D5 between the one surfaces 21A of the two printed circuit boards 21 may be greater than the distance D10 between the end surfaces to which no printed circuit board 21 is attached. In this case, a similar effect to the above-mentioned effect can also be obtained.

Furthermore, the distances D2 to D5 are each preferably greater than the greatest one of the distances D1a, D1b, D3, D4a, D4b, D6, and D10 to D12. In this case, further space saving can be implemented while the performance and the reliability of the battery system 500 are further improved.

(5-b) Connection of Power Supply Lines and Communication Lines

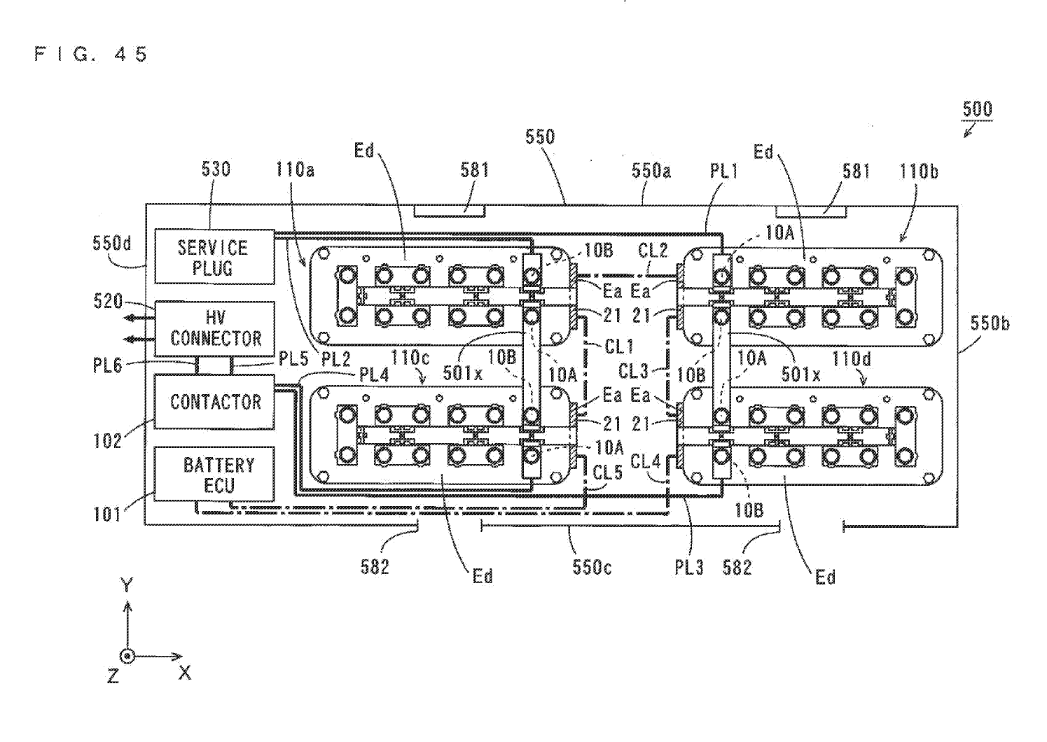

FIG. 45 is a schematic plan view for explaining a state of connection of power supply lines and communication lines in the second arrangement example illustrated in FIG. 44.

In the following description, a plus electrode having the highest potential in each of the battery modules 100a to 100d is referred to as a high potential electrode 10A, and a minus electrode having the lowest potential in each of the battery modules 100a to 100d is referred to as a low potential electrode 10B. As illustrated in FIG. 45, in each of the battery modules 100a to 100d in this example, the high potential electrode 10A and the low potential electrode 10B are arranged in close proximity to the end surface. Ea of each of the battery blocks 10Ba to 10Bd on the end surface Ed thereof.

The high potential electrode 10A in the battery module 100a and the low potential electrode 10B in the battery module 110c are connected to each other via a strip-shaped bus bar 501x. The low potential electrode 10B in the battery module 110b and the high potential electrode 10A in the battery module 110d are connected to each other via a strip-shaped bus bar 501x. The bus bar 501x corresponds to the power supply line 501 connecting the plurality of battery modules 100 illustrated in FIG. 1. The bus bar 501x may be replaced with another connection member such as a harness or a lead wire.

The high potential electrode 10A in the battery module 110b is connected to the service plug 530 via a power supply line PL1, and the low potential electrode 10B in the battery module 110a is connected to the service plug 530 via a power supply line PL2. The battery modules 100a, 100b, 100c, and 100d are connected in series with the service plug 530 turned on. In this case, the high potential electrode 10A in the battery module 110c has the highest potential, and the low potential electrode 10B in the battery module 110d has the lowest potential.

The low potential electrode 10B in the battery module 110d is connected to the contactor 102 via a power supply line PL3, and the high potential electrode 10A in the battery module 110c is connected to the contactor 102 via a power supply line PL4. The contactor 102 is connected to the HV connector 520 via power supply lines PL6 and PL6. The HV connector 520 is connected to a load such as a motor of an electric vehicle. The power supply lines PL1 to PL6 are used as the power supply line 601 illustrated in FIG. 1.

The HV connector 520 and the service plug 530 in this example respectively have similar functions to those of the HV connector 520 and the service plug 530 illustrated in FIG. 35.

A printed circuit board 21 in the battery module 110c and a printed circuit board 21 in the battery module 110a are connected to each other via a communication line CL1. The printed circuit board 21 in the battery module 110a and a printed circuit board 21 in, the battery module 110b are connected to each other via a communication line CU.

The printed circuit board 21 in the battery module 100b and a printed circuit board 21 in the battery module 100d are connected to each other via a communication line CL3. The printed circuit board 21 in the battery module 100d is connected to the battery ECU 101 via a communication line CL4, and the printed circuit board 21 in the battery module 100c is connected to the battery ECU 101 via a communication line CL5. The communication lines CL1 to CL5 correspond to the harness 560 illustrated in FIG. 1. The communication lines CL1 to CL5 constitute a bus.

Cell information detected by each of detection circuits 20 in the battery modules 100a to 110d is given to the battery ECU 101 via any one of the communication lines CL1 to CL5, and a predetermined control signal is fed to the printed circuit board 21 in each of the battery modules 100a to 100d from the battery ECU 101 via any one of the communication lines CL1 to CL5, in a similar manner to that in the battery system 500 illustrated in FIG. 35.

In this example, the communication line CL4 need not be provided, and the communication lines CL1, CL2, CL3, and CL5 may constitute a bus. In this case, the cell information detected by the detection circuit 20 in each of the battery modules 100a to 100d is also given to the battery ECU 101 via any one of the communication lines CL1, CL2, CL3, and CL5. A predetermined control signal is fed to the printed circuit board 21 in each of the battery modules 100a to 110d from the battery ECU 101 via any one of the communication lines CL1, CL2, CL3, and CL5.

(8) Third Arrangement Example in Casing in Second Embodiment

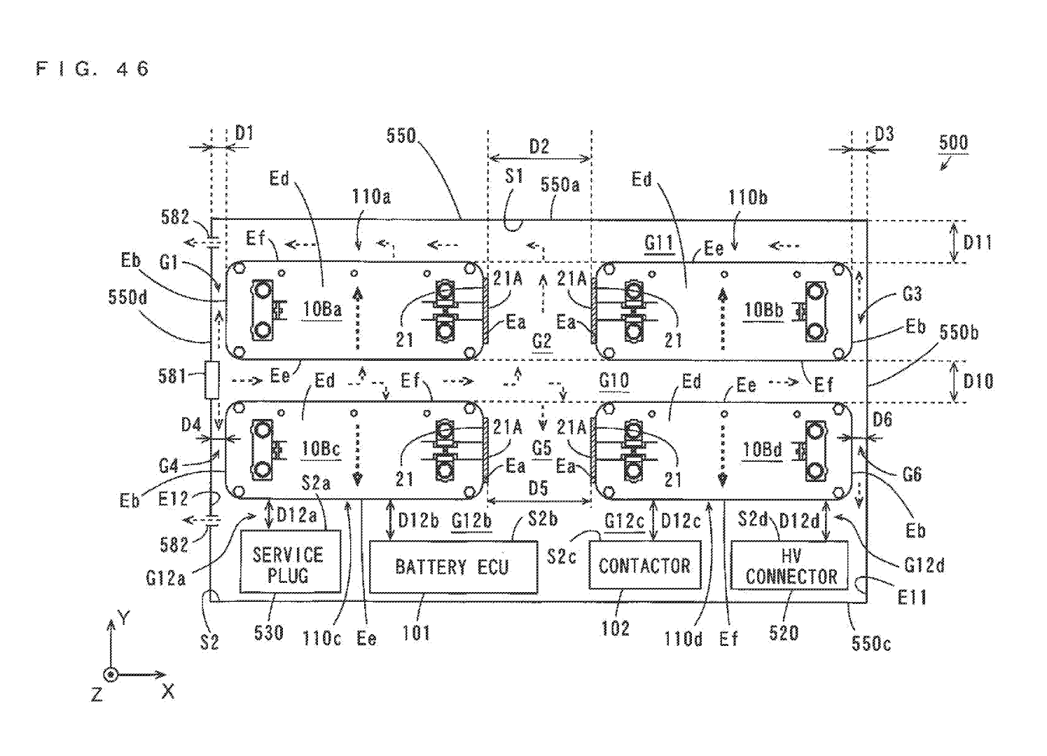

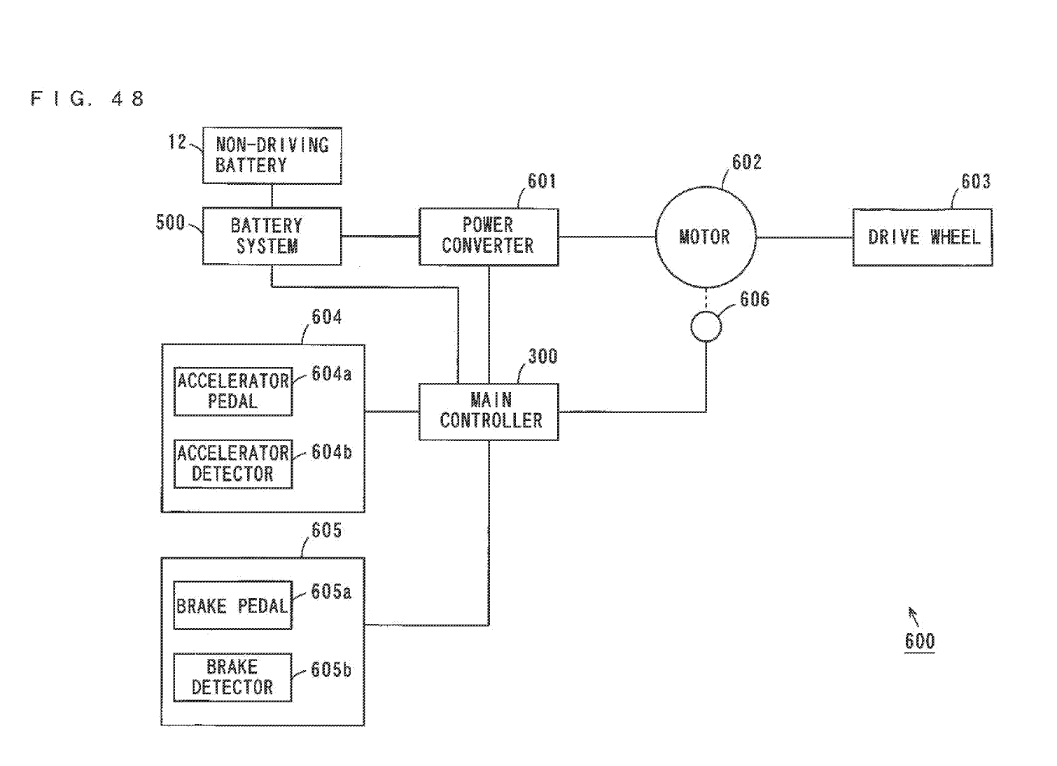

FIG. 48 is a schematic plan view illustrating a third arrangement example of the plurality of battery modules 100 housed in the casing 550 in the second embodiment. The third arrangement example illustrated in FIG. 46 will be described while referring to differences from the first arrangement example illustrated in FIG. 43.

(6-a) Arrangement of Components

As illustrated in FIG. 46, a battery system 500 in this example includes four battery modules 110, a battery ECU 101, a contactor 102, an HV connector 520, and a service plug 530, similarly to the battery system 500 illustrated in FIG. 33. In this example, the battery ECU 101 illustrated in FIG. 1, the contactor 102 illustrated in FIG. 1, an HV connector 520, and a service plug 530, together with a plurality of battery modules 100, are also housed in the casing 550. In this example, the module casing 120 illustrated in FIG. 41 is not provided. In this example, the casing 550 illustrated in FIG. 43 is used as a casing that houses the battery system 500.

The service plug 530, the battery ECU 101, the contactor 102, and the HV connector 520 line up from a sidewall 550d to a sidewall 550b in this order from a sidewall 550d to a sidewall 550b and are in close proximity to an end surface S2 in a region between a battery block 10Bc, 10Bd and a sidewall 550c in the Y-direction. The service plug 530 and the battery ECU 101 are positioned between the battery block 10Bc and the sidewall 550c, and the contactor 102 and the HV connector 520 are positioned between the battery block 10Bd and the sidewall 550c.

Consider four virtual planes that respectively contact the service plug 530, the battery ECU 101, the contactor 102, and the HV connector 520 and are parallel to an X-Z plane.

The virtual plane that contacts a closest portion of the service plug 530 to an end surface Ee of the battery block 10Bc is referred to as an opposite surface S2a, and a virtual plane that contacts a closest portion of the battery ECU 101 to the end surface Ee of the battery block 10Bc is referred to as an opposite surface S2b.

The virtual plane that contacts a closest portion of the contactor 102 to an end surface Ef of the battery block 10Bd is referred to as an opposite surface S2c, and the virtual plane that contacts a closest portion of the HV connector 520 to the end surface Ef of the battery block 10Bd is referred to as an opposite surface Std.

In this case, in the casing 550, the opposite surface S2a of the service plug 530 and the end surface Ee of the battery block 10Bc are spaced a distance D12a apart from each other. Thus, a gap G12a is formed between the opposite surface S2a of the service plug 530 and the end surface Ee of the battery block 10Bc.

The opposite surface S2b of the battery ECU 101 and the end surface Ee of the battery block 10Bc are spaced a distance D12b apart from each other. Thus, a gap G12b is formed between the opposite surface S2b of the battery ECU 101 and the end surface Ee of the battery block 10Bc.

The opposite surface S2c of the contactor 102 and the end surface Ef of the battery block 10Bd are spaced a distance D12c apart from each other. Thus, a gap G12c is formed between the opposite surface S2c of the contactor 102 and the end surface Ef of the battery block 10Bd.

The opposite surface S2d of the HV connector 520 and the end surface Ef of the battery block 10Bd are spaced a distance D12d apart from each other. Thus, a gap G12d is formed between the opposite surface S2d of the HV connector 520 and the end surface Ef of the battery block 10Bd.

In this example, the distance D2, D5 between one surfaces 21A of two printed circuit boards 21, which are opposed to each other, is greater than the distance D10 between a pair of end surfaces of the battery blocks, to which no printed circuit board 21 is attached. This makes space saving feasible while suppressing output limitation, deterioration, and reduction in life of the battery system 500 due to a rise in temperature.

At least one of the distances D2 and D5 between the one surfaces 21A of the two printed circuit boards 21 may be greater than the distance D10 between the end surfaces to which no printed circuit board 21 is attached. In this case, a similar effect to the above-mentioned effect can also be obtained.

Furthermore, the distances D2 to D5 are each preferably greater than the greatest one of the distances D1, D3, D4, D6, D10, D11, D12a, D12b, D12c, and D12d. In this case, further space saving can be implemented while the performance and the reliability of the battery system 500 are further improved.

(6-b) Connection of Power Supply Lines and Communication Lines

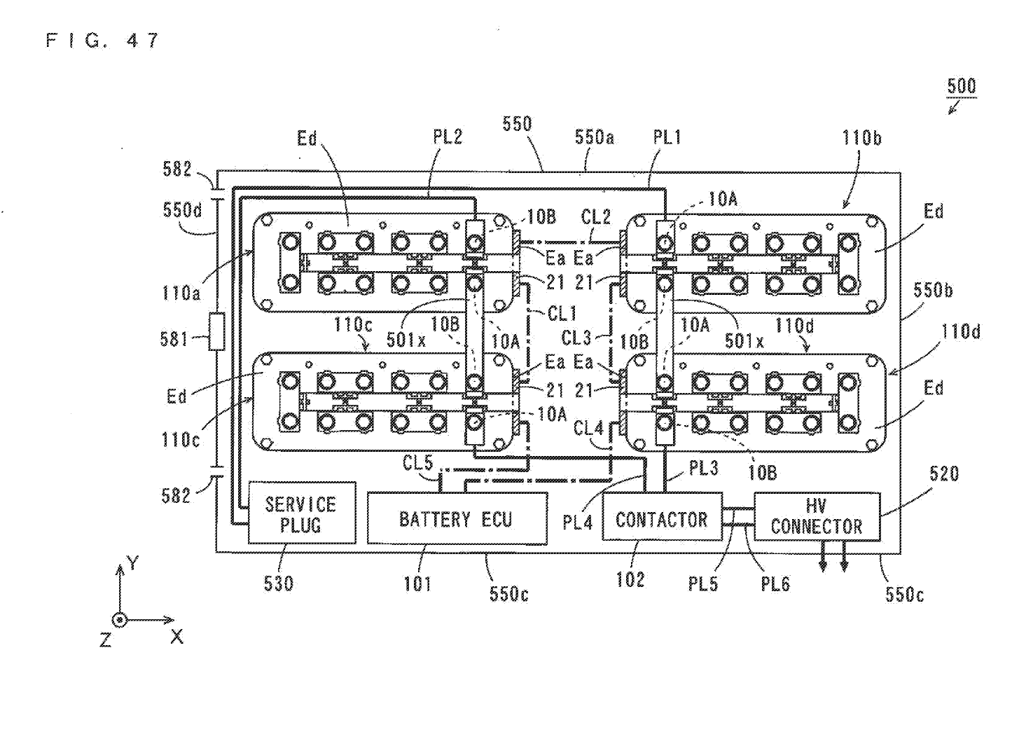

FIG. 47 is a schematic plan view for explaining a state of connection of power supply lines and communication lines in a third arrangement example illustrated in FIG. 46.

In the following description, a plus electrode having the highest potential in each of battery modules 100a to 100d is referred to as a high potential electrode 10A, and a minus electrode having the lowest potential in each of the battery modules 100a to 100d is referred to as a low potential electrode 10B. As illustrated in FIG. 47, a state of connection of power supply lines and communication lines in the third arrangement example is similar to the state of connection of the power supply lines and the communication lines in the second arrangement example illustrated in FIG. 45.

More specifically, the high potential electrode 10A in the battery module 110a and the low potential electrode 10B in the battery module 110c are connected to each other via a strip-shaped bus bar 501x. The low potential electrode 10B in the battery module 110b and the high potential electrode 10A in the battery module 110d are connected to each other via a strip-shaped bus bar 501x.

The high potential electrode 10A in the battery module 110b is connected to the service plug 530 via a power supply line PL1, and the low potential electrode 10B in the battery module 110a is connected to the service plug 530 via a power supply line PL2. The battery modules 100a, 100b, 100c, and 100d are connected in series with the service plug 530 turned on.

The low potential electrode 10B in the battery module 110d is connected to the contactor 102 via a power supply line PL3, and the high potential electrode 10A in the battery module 110c is connected to the contactor 102 via a power supply line PL4. The contactor 102 is connected to the HV connector 520 via power supply lines PL5 and PL6. The HV connector 520 is connected to a toad such as a motor of an electric vehicle.

A printed circuit board 21 in the battery module 110c and a printed circuit board 21 in the battery module 110a are connected to each other via a communication line CL1. The printed circuit board 21 in the battery module 110a and a printed circuit board 21 in the battery module 110b are connected to each other via a communication line CL2.

The printed circuit board 21 in the battery module 100b and a printed circuit board 21 in the battery module 100d are connected to each other via a communication line CL3. The printed circuit board 21 in the battery module 100d is connected to the battery ECU 101 via a communication line CL4, and the printed circuit board 21 in the battery module 100c is connected to the battery ECU 101 via a communication line CL5. The communication lines CL1 to CL5 constitute a bus.

### [3] Third Embodiment

An electric vehicle according to a third embodiment will be described below. The electric vehicle according to the present embodiment includes the battery system 500 according to the first or second embodiment. An electric automobile will be described below as an example of the electric vehicle.

FIG. 48 is a block diagram illustrating a configuration of an electric automobile including a battery system 500. As illustrated in FIG. 48, an electric automobile 600 according to the present embodiment includes a non-driving battery 12, a main controller 300, and the battery system 500, illustrated in FIG. 1, a power converter 601, a motor 602, drive wheels 603, an accelerator system 604, a brake system 605, and a rotational speed sensor 606. When the motor 602 is an alternate current (AC) motor, the power converter 601 includes an inverter circuit.

The non-driving battery 12 is connected to the battery system 500, as described above. The battery system 500 is connected to the motor 602 via the power converter 601 while being connected to the main controller 300.

The main, controller 300 is provided with the charged capacity of the plurality of battery modules 100 (FIG. 1) and the value of a current flowing through the battery modules 100 from the battery ECU 101 (FIG. 1) constituting the battery system 500. The accelerator system 604, the brake system 605 and the rotational speed sensor 606 are connected to the main controller 300. The main controller 300 is composed of a CPU and a memory or a microcomputer, for example.

The accelerator system 604 includes an accelerator pedal 604a included in the electric automobile 600 and an accelerator detector 604b that detects an operation amount (depression amount) of the accelerator pedal 604a. When a driver operates the accelerator pedal 604a, the accelerator detector 604b detects the operation amount of the accelerator pedal 604a with a state of the accelerator pedal 604a not being operated by the driver used as a basis. The detected operation amount of the accelerator pedal 604a is given to the main controller 300.

The brake system 605 includes a brake pedal 605a included in the electric automobile 600, and a brake detector 605b that detects an operation amount (depression amount) of the brake pedal 605a by the driver. When the driver operates the brake pedal 605a, the brake detector 605b detects the operation amount thereof. The detected operation amount of the brake pedal 605a is given to the main controller 300. The rotational speed sensor 606 detects a rotational speed of the motor 602. The detected rotational speed is given to the main controller 300.

As described above, the charged capacity of the battery modules 100, the value of the current flowing through the battery modules 100, the operation amount of the accelerator pedal 604a, the operation amount of the brake pedal 605a, and the rotational speed of the motor 602 are given to the main controller 300. The main controller 300 controls charge/discharge of the battery modules 100 and power conversion by the power converter 601 based on the information. Electric power generated by the battery modules 100 is supplied from the battery system 500 to the power converter 601 when the electric automobile 600 is started and accelerated based on an accelerator operation, for example.

Furthermore, the main controller 300 calculates a torque (commanded torque) to be transmitted to the drive wheels 6D3 based on the given operation amount of the accelerator pedal 604a, and gives a control signal based on the commanded torque to the power converter 601.

The power converter 601 that has received the control signal converts the electric power supplied from the battery system 500 into electric power (driving power) required to drive the drive wheels 603. Accordingly, the driving power obtained by the power converter 601 is supplied to the motor 602, and a torque generated by the motor 602 based on the driving power is transmitted to the drive wheels 603.

On the other hand, the motor 602 functions as a power generation system when the electric automobile 600 is decelerated based on the brake operation. In this case, the power converter 601 converts regenerated electric power generated by the motor 602 to electric power suited to charge the battery modules 100, and supplies the electric power to the battery modules 100. Thus, the battery modules 100 are charged.

As described above, the electric automobile 600 according to the present embodiment is provided with the battery system 500 according to the first embodiment. This enables the electric vehicle 600 to be miniaturized while enabling the performance and the reliability thereof to be increased.

### [4] Other Embodiments of the Present Invention

(1) In the above-mentioned sixth arrangement example in the first embodiment illustrated in FIG. 30, described above, not only an invention relating to the fact that the distance D2 is greater than the distance D5 but also an invention relating to the fact that the distance D2 is greater than at least one of the distance D1 and the distance D3 (hereinafter referred to, as other invention (I)) is carried out.

The contents of a configuration of a battery system according to the other invention (I) will be described below. The battery system according to the other invention (I) includes a plurality of battery blocks each composed of a plurality of battery cells, and the plurality of battery blocks arranged adjacent to one another at a distance, a circuit board corresponding to at least one of the plurality of battery blocks and including a voltage detection circuit that detects a voltage between terminals of each of the battery cells composing the corresponding battery block, and a casing that houses the plurality of battery blocks and the circuit board, in which a plurality of first opposite surfaces opposed to the plurality of battery blocks are formed within the casing, the plurality of battery blocks respectively have a plurality of second opposite surfaces opposed to the plurality of first opposite surfaces, the two battery blocks that are adjacent to each other respectively have third opposite surfaces opposed to each other, at least two of the plurality of circuit boards are attached to the third opposite surfaces so as to be opposed to each other, and a distance between the two circuit boards is greater than a distance between the second opposite surface to which no circuit board is attached and the first opposite surface opposed to the second opposite surface.

In the arrangement example illustrated in FIG. 30, the distance D2 between the one surfaces 21A of the two printed circuit boards 21 is greater than the distance D1 between the end surface E2 of the battery block 10Ba serving as the second opposite surface to which no printed circuit board 21 is attached and the first opposite surface E12 opposed to the end surface E2, or the distance D3 between the end surface E2 of the battery block 10Bb serving as the second opposite surface to which no printed circuit board 21 is attached and the first opposite surface E11 opposed to the end surface E2. More specifically, the distance D2 at which the gap G2 is formed is greater than at least one of the distance D1 at which the gap G1 is formed and the distance D3 at which the gap G3 is formed. The distance D2 is preferably greater than either one of the distances D1 and D3.

The gap G2 wider than at least one of the gaps G1 and G3 is formed so that a sufficient air passage is ensured along the one surfaces 21A of the two printed circuit boards 21 in a space that is limited by the size of the casing 550. Therefore, the detection circuit 20 that generates heat and the communication circuit 24 can be more sufficiently cooled by the flow of air so that a rise in temperature of the battery system 500 can be suppressed. As a result, output limitation, deterioration, and reduction in life of the battery system 500 due to the rise in temperature can be suppressed. Therefore, a minimum air passage required for the voltage detection circuit 20 to dissipate heat can be efficiently ensured while implementing space saving of an arrangement region of a plurality of battery blocks 500. These results enable space saving to be implemented, and improve the performance and the reliability of the battery system 500.

The other invention (I) is applicable to not only the arrangement example illustrated in FIG. 30 but also a configuration in which circuit boards are respectively attached to third opposite surfaces, which are opposed to each other, of two battery blocks, which are adjacent to each other. Therefore, the other invention (I) is also applicable to the arrangement examples illustrated in FIGS. 19, 42, 43, 44, and 46.

(2) Furthermore, in the twelfth arrangement example in the first embodiment illustrated in FIG. 31, described above, not only the invention relating to the fact that the distance D2 is greater than the distance D10a, D10b but also still another invention (hereinafter referred to as other invention (II)) is carried out.

In the battery system 500 illustrated in FIG. 31 according to an embodiment of the other invention (II), the plurality of battery blocks 10Ba, 10Bb, and 10Bc arranged in parallel with their longitudinal direction along the X-direction within the casing 550 are shifted in the X-direction so that the three printed circuit boards 21 alternately attached to end surfaces at one end and end surfaces at the other end in the longitudinal direction of the battery blocks come closer to one another.

The contents of a configuration of the battery system 500 according to the other invention (II) will be described below. The battery system 500 according to the other invention (II) includes a plurality of battery blocks each having one end surface and the other end surface in a first direction (X-direction) and arranged in parallel in a second direction (Y-direction) perpendicular to the first direction, a plurality of circuit boards corresponding to any of the plurality of battery blocks and each including a voltage detection circuit that detects a voltage between terminals of each of battery cells composing the corresponding battery block, and a casing that houses the plurality of battery blocks and the circuit board, in which at least one of the plurality of circuit boards is attached to the one end surface of at least one of the plurality of battery blocks, and the other circuit board is attached to the other end surface of the other battery block, and the battery blocks are arranged at positions shifted from a reference position where a plurality of one end surfaces match one another or a reference position where a plurality of other end surfaces match one another so that the plurality of circuit boards come closer to one another in the first direction within the casing. In this case, the plurality of battery blocks may include the same number of battery cells. However, the present invention is not limited to this.

If the two battery blocks that differ in size are used because the respective numbers of battery cells composing the battery blocks differ from each other, for example, the end surface of either one of the battery blocks can be used as a basis.

More specifically, the battery blocks may be shifted from each other so that the positions of the circuit boards come closer to each other from a position where the one end surfaces of the battery blocks line up with each other. This enables a distance between one surface of the circuit board and an inner surface of the casing to be kept greater.

In the arrangement example illustrated in FIG. 31, the other invention (II) is carried out in a relationship between the two adjacent battery blocks 10Ba and 10Bb and a relationship between, the two adjacent battery blocks 10Bb and 10Bc.

More specifically, the plurality of battery blocks are arranged in parallel, shifted from one another in the X-direction so that the two printed circuit boards 21 alternately arranged on the respective one and other end surfaces in the longitudinal direction of the battery blocks come closer to each other. This enables the distance D2 illustrated in FIG. 31 to be kept great. For example, the distance D2 between the one surface 21A of the printed circuit board 21 attached to the battery block 10Ba and the opposed end surface E11 of the casing 550 can be made greater by a distance that is approximately one-half a distance by which the two battery blocks are shifted, as compared with that when the two battery blocks 10Ba and 10Bb are arranged in parallel so that their respective end surfaces match each other in the X-direction. The distances D3 and D6 illustrated in FIG. 31 can be similarly kept great. As a result, a sufficient air passage can be ensured along the one surface 21A of the printed circuit board 21.

On the other hand, the printed circuit board 21 does not exist in the gap G1, G4, G5 in FIG. 31. When the sizes of the gaps G1, G4, and G5 are set, therefore, heat dissipation in the printed circuit board 21 need not be considered. Therefore, the distance D1, D4, D5 may decrease as the distance D2, D3, D6 increases. This can inhibit the casing 500 from increasing in size.

An embodiment of the other invention (II) has been described above based on the arrangement example illustrated in FIG. 31 in which the three battery blocks 10Ba, 10Bb, and 10Bc are arranged in parallel.

The other invention (II) is applicable to not only the arrangement example illustrated in FIG. 31 but also a configuration in which a plurality of battery blocks are arranged in parallel within a casing. Therefore, the other invention (II) is also applicable to the arrangement examples illustrated in FIGS. 12, 13, 16, 18 to 20, 22, 23 to 28, 30, and 34.

More specifically, the arrangement example including the four battery blocks 10Ba to 108d, illustrated in FIG. 12, includes a pair of battery blocks 10Ba and 10Bc arranged in parallel and a pair of battery blacks 10Bb and 10Bd arranged in parallel. Thus, the arrangement example illustrated in FIG. 12 includes the two pairs of battery blocks arranged in parallel. Therefore, the other invention (II) is applicable to at least one of the pairs.

(3) In the first embodiment, the battery cells 10 composing the battery module 100 are battery cells 10 each having a flat and substantially rectangular parallelepiped shape. In the second embodiment, the battery cells 10 composing the battery module 100 are battery cells 10 each having a so-called columnar shape. The battery cells 10 composing the battery module 100, 110 are not limited to these. For example, the battery cells composing the battery module 100, 110 may be laminate-type battery cells.

The laminate-type battery cell is produced as follows, for example. First, a cell element in which a plus electrode and a minus electrode are arranged with a separator sandwiched therebetween is housed in a bag made of a resin film. Then, the bag that houses the cell element is seated, and a formed enclosed space is filled with an electrolytic solution. Thus, the laminate-type battery cell is completed.

In the columnar-shaped battery cells 10 used in the second embodiment, a plus electrode and a minus electrode are respectively formed on its one end surface and the other end surface, as described above. The battery cells 10 composing the battery module 100 may be battery cells each having a substantially columnar shape and formed so that a plus electrode and a minus electrode project toward its one end surface in place of the battery cells 10 in the second embodiment.

(4) In the battery system 500 according to the first embodiment, the plurality of bus bars 40, 40a are attached to the plus electrodes 10a and the minus electrodes 10b of the plurality of battery cells 10 using nuts. The present invention is not limited to this. The plurality of bus bars 40, 40a may be attached to the plus electrodes 10a and the minus electrodes 10b of the plurality of battery cells 10, respectively, by laser welding, or other types of welding or caulking, for example.

(5) In the battery system 500 according to the first embodiment, the plurality of bus bars 40, 40a are connected to a lateral side close to the inside of each of the two FPC boards 50 extending in the X-direction (the direction in which the plurality of battery cells 10 line up) so as to line up at predetermined spacings on the upper surface of the battery module 100.

The present invention is not limited to this. For example, the plurality of bus bars 40, 40a may be connected to a lateral side close to the outside of each of the two FPC boards 50 so as to tine up at predetermined spacings if the plus electrode 10a and the minus electrode 10b of each of the battery cells 10 are arranged in close proximity to the end surfaces E3 and E4, which extend in the X-direction, of the battery block 10BB.

### [5] Correspondences Between Elements in the Claims and Parts in Embodiments

In the following paragraphs, non-limiting examples of correspondences between various elements recited in the claims below and those described above with respect to various preferred embodiments of the present invention are explained.

In the foregoing embodiments, the detection circuit 20 is an example of a voltage detection circuit, and the printed circuit board is an example of a circuit board. The end surfaces Ell, E12, S1, and S2 of the casing 550, the opposite surfaces E14 and E13 of the circuit board BX, and the opposite surface E15 of the circuit board BY, the opposite surface S2a of the battery ECU 101, the opposite surface S2b of the service plug 630, the opposite surface S2c of the HV connector 520, and the opposite surface S2d of the contactor 102 are examples of a first opposite surface.

Furthermore, the end surfaces E1 to E4 of the battery blocks 10BB, and 10Ba to 10Bd are examples of a second opposite surface, and the end surfaces E1 to E4, which are opposed to each other, of the plurality of battery blocks 10Ba to 10Bd adjacent to each other are examples of a third opposite surface. The gaps U1 and U2 are examples of a predetermined gap.

As each of various elements recited in the claims, various other elements having configurations or functions described in the claims can also be used.

While preferred embodiments of the present invention have been described above, it is to be understood that variations and modifications will be apparent to those skilled in the art without departing the scope and spirit of the present invention. The scope of the present invention, therefore, is to be determined solely by the following claims.

I/we claim:

1. A battery system comprising:
one or a plurality of battery blocks each including a plurality of battery cells;
a circuit board corresponding to at least one of said one or plurality of battery blocks and including a voltage detection circuit that detects a voltage between terminals of each of the battery cells in the corresponding battery block; and
a casing that houses said one or plurality of battery blocks and said circuit board,
wherein a plurality of first opposite surfaces opposed to said one or plurality of battery blocks are formed within said casing,
said one or plurality of battery blocks each have a plurality of second opposite surfaces respectively opposed to said plurality of first opposite surfaces,
said circuit board is attached to the second opposite surface of the corresponding battery block, and
a distance between said circuit board and the first opposite surface opposed to said circuit board is greater than a distance between the second opposite surface to which no circuit board is attached and the first opposite surface opposed to the second opposite surface.

2. The battery system according to claim 1, wherein a predetermined gap is provided between said circuit board and said second opposite surface to which the circuit board is attached.

3. The battery system according to claim 1, wherein said circuit board includes an equalization circuit that equalizes the voltages between terminals of said plurality of battery cells in the corresponding battery block.

4. An electric vehicle comprising:
the battery system according to claim 1;
a motor that is driven by electric power from said battery system; and
a drive wheel that rotates by a torque generated by said motor.

5. A battery system comprising:
three or more battery blocks each including a plurality of battery cells, and said three or more battery blocks arranged adjacent to one another at a distance; and
a circuit board corresponding to at least one of said battery blocks and including a voltage detection circuit that detects a voltage between terminals of each of the battery cells in the corresponding battery block,
wherein the two battery blocks adjacent to each other respectively have opposite surfaces opposed to each other,
said circuit board is attached to the opposite surface of the corresponding battery block, and
a distance between said circuit board and the opposite surface opposed to the circuit board is greater than a distance between said opposite surfaces to which no circuit board is attached.

6. The battery system according to claim 5, wherein a predetermined gap is provided between said circuit board and said opposite surface to which the circuit board is attached.

7. The battery system according to claim 5, wherein said circuit board includes an equalization circuit that equalizes the voltages between terminals of said plurality of battery cells in the corresponding battery block.

8. An electric vehicle comprising:
the battery system according to claim 5;
a motor that is driven by electric power from said battery system; and
a drive wheel that rotates by a torque generated by said motor.

9. The battery system according to claim 5, wherein at least two of said plurality of circuit boards are respectively attached to the opposite surfaces of the corresponding battery blocks so as to be opposed to each other, and no circuit board is attached to the at least two other opposite surfaces opposed to each other, and
a distance between said at least two circuit boards is greater than a distance between said other opposite surfaces to which no circuit board is attached.

10. A battery system comprising:
a plurality of battery blocks each including a plurality of battery cells, and said plurality of battery blocks arranged adjacent to one another at a distance;
a circuit board corresponding to at least one of said plurality of battery blocks and including a voltage detection circuit that detect a voltage between terminals of each of the battery cells in the corresponding battery block; and
a casing that houses said plurality of battery blocks and said circuit board,
wherein a plurality of first opposite surfaces respectively opposed to said plurality of battery blocks are formed within said casing,
said plurality of battery blocks have a plurality of second opposite surfaces opposed to said plurality of first opposite surfaces,
the two battery blocks adjacent to each other respectively have third opposite surfaces opposed to each other,
said circuit board is attached to the third opposite surface of the corresponding battery block, and
a distance between said circuit board and the third opposite surface opposed to the circuit board is greater than a distance between the second opposite surface to which no circuit board is attached and the first opposite surface opposed to the second opposite surface.

11. The battery system according to claim 10, wherein a predetermined gap is provided between said circuit board and said third opposite surface to which the circuit board is attached.

12. The battery system according to claim 10, wherein said circuit board includes an equalization circuit that equalizes the voltages between terminals of said plurality of battery cells in the corresponding battery block.

13. An electric vehicle comprising:
the battery system according to claim 10;
a motor that is driven by electric power from said battery system; and
a drive wheel that rotates by a torque generated by said motor.
